(19) United States
(12) Patent Application Publication
(10) Pub. No.: US 2026/0352296 A1
(43) Pub. Date: Nov. 5, 2026

(54) METHOD AND APPARATUS FOR DETERMINING PROCESS NUMBER IN A WIRELESS COMMUNICATION SYSTEM

(71) Applicant: ASUS Technology Licensing Inc., Taipei City (TW)

(72) Inventors: Chun-Wei Huang, Taipei City (TW); Li-Chih Tseng, Taipei City (TW)

(21) Appl. No.: 19/648,934

(22) Filed: Apr. 15, 2026

Related U.S. Application Data
(60) Provisional application No. 63/793,428, filed on Apr. 23, 2025.

(51) Int. Cl. H04B 7/06; H04L 1/1812; H04W 16/28; H04W 72/21; H04W 72/231

(52) U.S. Cl. CPC H04B 7/0626; H04L 1/1812; H04W 16/28; H04W 72/21; H04W 72/231

(57) ABSTRACT

Methods, systems, and apparatuses are provided for determining process numbers in a wireless communication system, wherein a method of a User Equipment (UE) comprises receiving one or more Channel State Information (CSI) report configurations, wherein at least one CSI report configuration is used for a UE-Initiated (UEI) beam report, receiving at least one ConfiguredGrantConfig comprising a first ConfiguredGrantConfig, and ignoring a first parameter in the first ConfiguredGrantConfig if the first ConfiguredGrantConfig is associated with or configured as an Uplink (UL) resource for transmitting the UEI beam report.

### CROSS-REFERENCE TO RELATED APPLICATIONS

The present application claims priority to and the benefit of U.S. Provisional patent application Ser. No. 63/793,428, filed Apr. 23, 2025, which is hereby fully incorporated herein by reference.

### FIELD

This disclosure generally relates to wireless communication networks and, more particularly, to a method and apparatus for determining process numbers in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for determining process numbers in a wireless communication system.

In various embodiments, a method of a User Equipment (UE) comprises receiving one or more Channel State Information (CSI) report configurations, wherein at least one CSI report configuration is used for a UE-Initiated (UEI) beam report, receiving at least one ConfiguredGrantConfig comprising a first ConfiguredGrantConfig, and ignoring a first parameter in the first ConfiguredGrantConfig if the first ConfiguredGrantConfig is associated with or configured as an Uplink (UL) resource for transmitting the UEI beam report, in accordance with embodiments of the present invention.

In various embodiments, a method of a UE comprises receiving one or more CSI report configurations, wherein at least one CSI report configuration is used for a UEI report, receiving at least one configured grant configuration comprising a first configured grant configuration, and determining whether the first configured grant configuration is associated with zero or one or more Hybrid Automatic Repeat Request (HARQ) process numbers based on whether a parameter is present or a parameter indicates a value other than zero, in accordance with embodiments of the present invention.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 6.1.3.47-1: Unified TCI state activation/deactivation MAC CE, from 3GPP TS 38.321 i00.

FIG. 6 is a flow diagram of a method of a UE in a wireless communication system comprising receiving one or more CSI report configurations (e.g., CSI-ReportConfig), receiving one or more ConfiguredGrantConfig comprising a first ConfiguredGrantConfig, and ignoring a first parameter in the first ConfiguredGrantConfig if the first ConfiguredGrantConfig is associated with or configured as a UL resource for transmitting the UEI beam report, in accordance with embodiments of the present invention.

FIG. 7 is a flow diagram of a method of a network node in a wireless communication system comprising receiving one or more CSI report configurations, receiving one or more ConfiguredGrantConfig comprising a first ConfiguredGrantConfig, and ignoring a first parameter in the first ConfiguredGrantConfig if the first ConfiguredGrantConfig is associated with or configured as a UL resource for transmitting the UEI beam report, in accordance with embodiments of the present invention.

FIG. 8 is a flow diagram of a method of a UE in a wireless communication system comprising receiving one or more CSI report configurations, receiving one or more ConfiguredGrantConfig comprising a first ConfiguredGrantConfig, and ignoring a first parameter in the first ConfiguredGrantConfig if the first ConfiguredGrantConfig is associated with or configured as a third parameter, in accordance with embodiments of the present invention.

FIG. 9 is a flow diagram of a method of a network node in a wireless communication system comprising receiving one or more CSI report configurations, receiving one or more ConfiguredGrantConfig comprising a first ConfiguredGrantConfig, and setting a first parameter in the first ConfiguredGrantConfig to a value one if the first ConfiguredGrantConfig is associated with or configured as a UL resource for transmitting the UEI beam report, in accordance with embodiments of the present invention.

FIG. 10 is a flow diagram of a method of a UE in a wireless communication system comprising receiving one or more CSI report configurations (e.g., CSI-ReportConfig), receiving at least one ConfiguredGrantConfig comprising a first ConfiguredGrantConfig, and ignoring a first parameter in the first ConfiguredGrantConfig if the first ConfiguredGrantConfig is associated with or configured as a UL resource for transmitting the UEI beam report, in accordance with embodiments of the present invention.

FIG. 11 is a flow diagram of a method of a UE in a wireless communication system comprising receiving one or more CSI report configurations, receiving at least one configured grant configuration comprising a first configured grant configuration, and determining whether the first configured grant configuration is associated with zero or one or more HARQ process numbers based on whether a parameter is present or a parameter indicates a value other than zero, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-234007, New WID: NR MIMO Phase 5; [2] 3GPP TS 38.214 i50; [3] 3GPP TS 38.212 i00; [4] 3GPP TS 38.331 i40; [5] 3GPP TS 38.321 100; [6] R2-2502545; [7] RAN1 116 meeting report; [8] RAN1 116bis meeting report; [9] RAN1 117 meeting report; RAN1 118 meeting report; RAN1 118bis meeting report; RAN1 119 meeting report; RAN1 120 chairman's note; RAN1 120bis chairman's note; R1-2501669; R2-2502666; and R2-2502393. The standards and documents listed above are hereby expressly and fully incorporated herein by reference in their entirety.

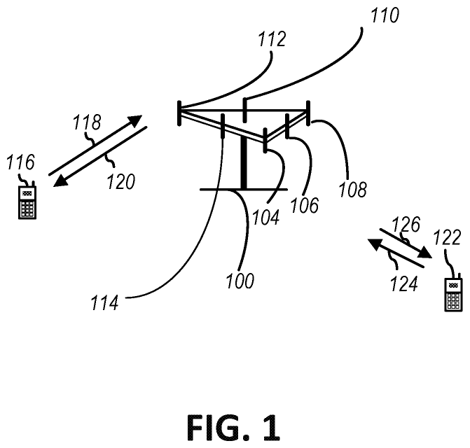

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

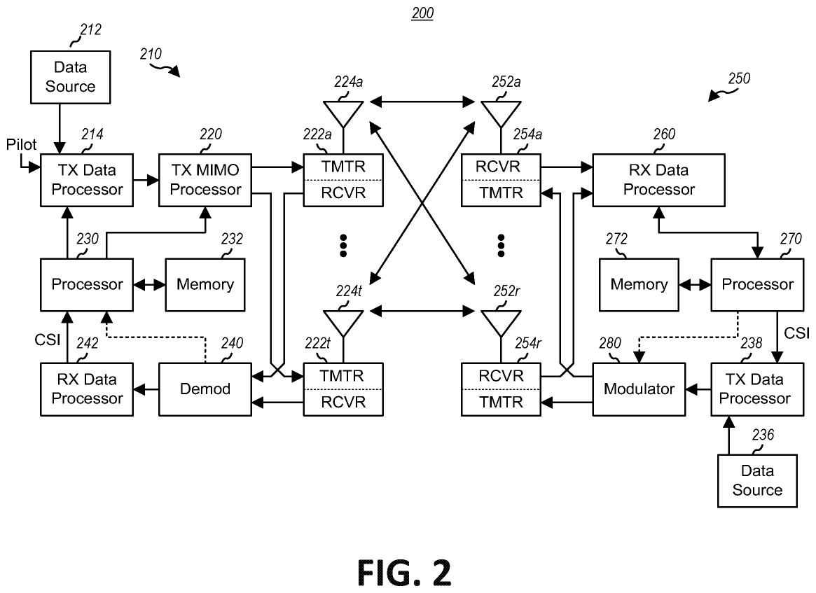

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

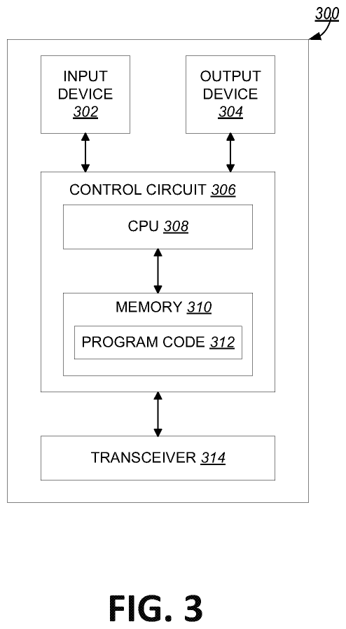

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

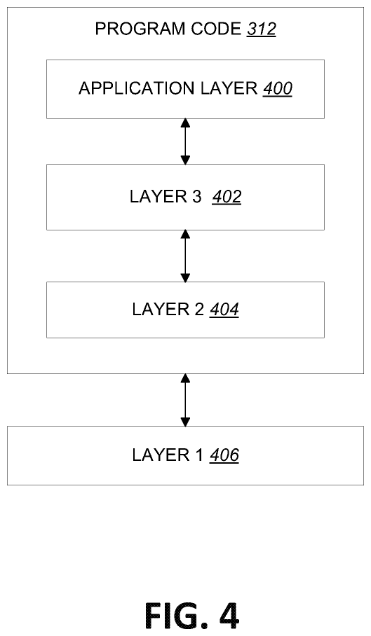

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-) bullets, points, actions, or claims described in each invention paragraph or section may be combined logically, reasonably, and properly to form a specific method.

Any sentence, paragraph, (sub-) bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In [1] RP-234007, New WID: NR MIMO Phase 5, justification and objective for MIMO phase are quoted below:

### 3 Justification

Heterogeneous Network can be deployed to improve UL throughput. Since the macro gNB and micro nodes differ in power rating, a UE may receive DL transmission from the macro gNB, but transmit UL to either the macro gNB or non-co-located micro nodes in order to maximize UL throughput. As an option to further reduce energy consumption, the micro nodes can, for instance, reduce or even turn off DL transmissions. To support such deployment scenario, enhancements on UL power control (PC) are needed at least. First, when pathloss RS is transmitted from the macro gNB and the UE transmits UL to the micro nodes, the pathloss measured from the pathloss RS from the macro gNB is not accurate. Therefore, it is necessary to configure the UE with pathloss offset to facilitate accurate calculation of the pathloss associated with the micro nodes. Second, an additional SRS closed-loop PC for DL CSI acquisition to the macro gNB (for DL transmission), separate from that for the SRS to the micro nodes (for UL mTRP reception) should be introduced. Therefore, there is a need for supporting two closed-loop PC adjustment states for SRS, both separate from PUSCH.

### 4 Objective

### 4.1 Objective of SI or Core Part WI or Testing Part WI

The detailed objectives are as follows:

### RAN1:

1. Specify enhancement to facilitate UE-initiated/event-driven beam management for reducing overhead and/or latency, assuming the unified TCI while leveraging (as much as possible) legacy CSI measurement and reporting configuration frameworks, targeting FR2 and sTRP with intra- and inter-cell beam management
   a. UL signaling content(s)(and procedure(s) as required) for UE-initiated/event-driven beam reporting facilitating fast beam switching
   b. UL signaling medium/container considering the UE-initiated/event-driven nature of the UL transmission, designed primarily for the purpose of beam reporting

In [2] 3GPP TS 38.214 i50, the following is provided:

### 5.1.5 Antenna Ports Quasi Co-Location

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type 1 for the first DL RS, and qcl-Type 2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE can be configured with a list of up to 128 TCI-State configurations, within the higher layer parameter dl-OrJointTCI-StateList in PDSCH-Config for providing a reference signal for the quasi co-location for DM-RS of PDSCH and DM-RS of PDCCH in a BWP/CC, for CSI-RS, and to provide a reference signal with qcl-Type set to ‘typeD’, if applicable, for determining UL TX spatial filter for dynamic-grant and configured-grant based PUSCH and PUCCH resource in a BWP/CC, and SRS.

If the TCI-State or TCI-UL-State configurations are absent in a BWP of the CC, the UE can apply the TCI-State or TCI-UL-State configurations from a reference BWP of a reference CC configured by unifiedTCI-StateRef. The UE is not expected to be configured with tci-StatesToAddModList, SpatialRelationInfo or PUCCH-SpatialRelationInfo, except SpatialRelationInfoPos in a CC in a band, if the UE is configured with dl-OrJointTCI-StateList or ul-TCI-StateList in any CC in the same band.

The UE receives an activation command, as described in clause 6.1.3.14 of [10, TS 38.321], or 6.1.3.47 of [10, TS 38.321], used to map up to 8 TCI states and/or pairs of TCI states, with one TCI state for DL channels/signals and/or one TCI state for UL channels/signals to the codepoints of the DCI field ‘Transmission Configuration Indication’ for one or for a set of CCs/DL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied as described in [11, TS 38.133].

When the bwp-id or cell for QCL-TypeA/D source RS in a QCL-Info of the TCI state is not configured, the UE assumes that QCL-TypeA/D source RS is configured in the CC/DL BWP where TCI state applies.

When tci-PresentInDCI is set as ‘enabled’ or tci-PresentDCI-1-2 is configured for the CORESET, a UE configured with dl-OrJointTCI-StateList with activated TCI-State or ul-TCI-StateList with activated TCI-UL-State receives DCI format 1_1/1_2/1_3 providing indicated TCI-State(s) and/or TCI-UL-State(s) for a CC or all CCs in the same CC list configured by simultaneousU-TCI-UpdateList1-r17, simultaneousU-TCI-UpdateList2-r17, simultaneousU-TCI-UpdateList3-r17, simultaneousU-TCI-UpdateList4-r17 . . . .

If a UE receives a higher layer configuration of dl-OrJointTCI-StateList where only one TCI-State can be used as an indicated TCI state, the UE obtains the QCL assumptions from that TCI state for DM-RS of PDSCH and DM-RS of PDCCH, and the CSI-RS applying the indicated TCI state.

If a UE receives a higher layer configuration of dl-OrJointTCI-StateList where only one TCI-State can be used as an indicated TCI state or a higher layer configuration of ul-TCI-StateList where only one TCI-UL-State can be used as an indicated TCI state, the UE determines an UL TX spatial filter, if applicable, from that TCI state for dynamic-grant and configured-grant based PUSCH and PUCCH, and SRS applying the indicated TCI state.

When a UE configured with dl-OrJointTCI-StateList would transmit a PUCCH with positive HARQ-ACK or a PUSCH with positive HARQ-ACK corresponding to the DCI carrying the TCI State indication and without DL assignment, or corresponding to one or more PDSCH(s) scheduled by the DCI carrying the TCI State indication, and if the indicated TCI State(s) is/are different from the previously indicated one(s), the indicated TCI-State(s) and/or TCI-UL-State(s) should be applied starting from the first slot that is at least beamAppTime symbols after the last symbol of the PUCCH or the PUSCH, and if the UE receives more than one indicated TCI state for a CC/BWP to be applied starting from the first slot that is at least beamAppTime symbols after the last symbol of the PUCCH or the PUSCH, the indicated TCI state carried in the latest DCI, for the corresponding coresetPoolIndex value when applicable, in time corresponding to positive HARQ-ACK value is applied. The first slot and the beamAppTime symbols are both determined on the active BWP with the smallest SCS among the BWP(s) from the CCs applying the indicated TCI-State(s) or TCI-UL-State(s) that are active at the end of the PUCCH or the PUSCH carrying the positive HARQ-ACK. The indicated TCI-State(s) or TCI-UL-State(s) is/are based on the activated TCI states in each slot where the UE applies the indicated TCI-State(s) or TCI-UL-State(s) to DL channel(s)/signal(s) or UL channel(s)/signal(s).

When a UE is configured with dl-OrJointTCI-StateList and is having one indicated TCI-state, and if the UE is configured with unifiedTCI-StateType that is set as ‘separate’, and if the UE receives a TCI codepoint mapped with either of {TCI-State, TCI-UL-State}, the UE shall update the one indicated {TCI-State, TCI-UL-State} and maintain the other {TCI-State, TCI-UL-State} that is not updated by the received TCI codepoint.

When a UE is configured with dl-OrJointTCI-StateList and is having two indicated TCI-states, if the UE receives a TCI codepoint mapped with a sub-set of first and second TCI-State(s) and/or a sub-set of first and second TCI-UL-State(s), the UE shall update the first/second TCI-State(s) and/or first/second TCI-UL-State(s) mapped to the TCI codepoint, when applicable, and keep the previously indicated first/second TCI-State(s) and/or first/second TCI-UL-State(s) that is/are not updated by the TCI codepoint.

If the UE is configured with PDCCH-Config that contains two different values of coresetPoolIndex in ControlResourceSet, the UE receives an activation command associated with each coresetPoolIndex, as described in clause 6.1.3.14 of [10, TS 38.321] or 6.1.3.47 of [10, TS 38.321], used to map up to 8 TCI states and/or pairs of TCI states, with one TCI state for DL channels/signals and/or one TCI state for UL channels/signals to the codepoints of the DCI field ‘Transmission Configuration Indication’ in one CC/DL BWP. When a set of TCI state IDs are activated for a coresetPoolIndex, the activated TCI states corresponding to one coresetPoolIndex is associated with the serving cell physical cell ID and activated TCI states corresponding to another coresetPoolIndex can be associated with another physical cell ID, if the UE is further configured with SSB-MTC-AddtionalPCI.

When a UE supports two TCI states in a codepoint of the DCI field ‘Transmission Configuration Indication’ the UE may receive an activation command, as described in clause 6.1.3.24 of [10, TS 38.321], the activation command is used to map up to 8 combinations of one or two TCI states to the codepoints of the DCI field ‘Transmission Configuration Indication’. The UE is not expected to receive more than 8 TCI states in the activation command.

When a UE configured with dl-OrJointTCI-StateList supports tci-JointTCI-UpdateMultiActiveTCI-PerCC-r18, the UE may receive an activation command, as described in clause 6.1.3.70 of [10, TS 38.321], the activation command is used to map up to 8 sets of TCI states to the codepoints of the DCI field ‘Transmission Configuration Indication’ for one or for a set of CCs/DL BWPs, and if applicable, for one or for a set of CCs/UL BWPs, where each set is comprised of up to two TCI state(s) for DL and UL signals/channels.

When a UE configured with dl-OrJointTCI-StateList supports tci-SeparateTCI-UpdateMultiActiveTCI-PerCC-r18, the UE may receive an activation command, as described in clause 6.1.3.71 of [10, TS 38.321], the activation command is used to map up to 8 sets of TCI states to the codepoints of the DCI field ‘Transmission Configuration Indication’ for one or for a set of CCs/DL BWPs, and if applicable, for one or for a set of CCs/UL BWPs, where each set is comprised of up to two TCI state(s) for DL channels/signals and up to two TCI state(s) for UL channels/signals.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot

$$n + 3 {N}_{slot}^{s u b f r a m e , μ} + \frac{{2}^{μ}}{{2}^{{}^{μ} {K}_{mac}}} \cdot {k}_{m a c}$$

where μ is the SCS configuration for the PUCCH and μ_{K}_{_{mac}} is the subcarrier spacing configuration for k_{mac} with a value of 0 for frequency range 1 and for FR2-NTN, and k_{mac} is provided by K-Mac or k_{mac}=0 if K-Mac is not provided. If tci-PresentInDCI is set to ‘enabled’ or tci-PresentDCI-1-2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command,
the UE assumes that DM-RS of ports of PDSCH of a serving cell are quasi co-located with the reference signal(s) in the CandidateTCI-State indicated in the LTM Cell Switch Command MAC CE [10, 38.321], except during RACH procedure for RACH-based LTM, if applicable, otherwise
the UE may assume that the DM-RS ports of PDSCH of a serving cell are quasi co-located with the SS/PBCH block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling a PDSCH, the UE assumes that the TCI field is present in the DCI format 1_1 or format 1_3 of the PDCCH transmitted on the CORESET . . . . If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability [13, TS 38.306], for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

Independent of the configuration of tci-PresentInDCI and tci-PresentDCI-1-2 in RRC connected mode, if the UE is provided dl-OrJointTCI-StateList-r17, and if the offset between the reception of the DL DCI and the corresponding PDSCH is less than the threshold timeDurationForQCL and at least one configured TCI state for the serving cell of scheduled PDSCH contains qcl-Type set to ‘typeD’, regardless of configuration of follow UnifiedTCI-State,
if the indicated TCI state is associated with the PCI of the serving cell, the indicated TCI state is applied to PDSCH reception.
if the indicated TCI state is associated with a PCI different from the serving cell, the UE may assume that the DM-RS ports of PDSCH(s) of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In the CA case, if the ‘QCL-TypeD’ of the PDSCH DM-RSs from respective CCs in a band are different in a slot, the QCL-TypeD assumption of the PDSCH DM-RS in the CC with lowest CC ID in the band is applied to all the PDSCH DM-RSs in the CCs in the band. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).

Independent of the configuration of tci-PresentInDCI and tci-PresentDCI-1-2 in RRC connected mode, for a UE that is provided dl-OrJointTCI-StateList-r17, if a PDSCH of a serving cell is scheduled by a CORESET that does not follow the indicated TCI state, and if the time offset between the reception of the DL DCI and the corresponding PDSCH is equal to or greater than a threshold timeDurationForQCL, the indicated TCI state is applied to the PDSCH of the serving cell.

### 5.1.2 Resource Allocation

### 5.1.2.1 Resource Allocation in Time Domain

When the UE is scheduled to receive PDSCH by a DCI, the Time domain resource assignment field value m for the scheduled PDSCH on the serving cell provides a row index m+1 to a resource allocation table. The determination of the used resource allocation table is defined in Clause 5.1.2.1.1. The indexed row defines the slot offset K₀, the start and length indicator SLIV, or directly the start symbol S and the allocation length L, and the PDSCH mapping type to be assumed in the PDSCH reception.

Given the parameter values of the indexed row:
The slot allocated for the PDSCH is Kₛ, where

$${K}_{S} = ⌊ n \cdot \frac{{2}^{{μ}_{PDSCH}}}{{2}^{{μ}_{P D C C H}}} ⌋ + {K}_{0} + ⌊ ( \frac{{N}_{s lot , offset , PDCCH}^{C A}}{{2}^{{μ}_{offset , PDCCH}}} - \frac{{N}_{s lot , offset , PDSCH}^{C A}}{{2}^{{μ}_{offset , PDSCH}}} ) \cdot {2}^{{μ}_{P D S C H}} ⌋ ,$$

if UE is configure with ca-SlotOffset
for at least one of the scheduled and scheduling cell, and

$${K}_{s} = ⌊ n \cdot \frac{{2}^{{μ}_{P D S C H}}}{{2}^{{μ}_{P D C C H}}} ⌋ + {K}_{0} ,$$

otherwise, and where n is the slot with the scheduling DCI, and K₀ is based on the numerology of PDSCH, and μ_{PDSCH} and μ_{PDCCH} are the subcarrier spacing configurations for PDSCH and PDCCH, respectively, and

$${N}_{slot , offset , PDCCH}^{CA}$$

and μ_{offset,PDCCH} are the

$${N}_{slot , offset}^{CA}$$

and the μ_{offset}, respectively, which are determined by higher-layer configured ca-SlotOffset, for the cell receiving the PDCCH respectively,

$${N}_{slot , offset , PDSCH}^{CA}$$

and μ_{offset,PDSCH} are the

$${N}_{slot , offset}^{CA}$$

and the μ_{offset}, respectively, which are determined by higher-layer configured ca-SlotOffset for the cell receiving the PDSCH, as defined in clause 4.5 of [4, TS 38.211].
The reference point S₀ for starting symbol S is defined as:
   if configured with referenceOfSLIVDCI-1-2, and when receiving PDSCH scheduled by DCI format 1_2 with CRC scrambled by C-RNTI, MCS-C-RNTI, CS-RNTI with K₀=0, and PDSCH mapping Type B, the starting symbol S is relative to the starting symbol S₀ of the PDCCH monitoring occasion where DCI format 1_2 is detected; when the PDCCH reception includes two PDCCH candidates from two respective search space sets, as described in clause 10.1 of [6, TS 38.213], the PDCCH candidate that starts later in time is used for the purpose of determining the starting symbol S₀;
   otherwise, the starting symbol S is relative to the start of the slot using S₀=0.
The number of consecutive symbols Z counting from the starting symbol S allocated for the PDSCH are determined from the start and length indicator SLIV:

```
if (L−1)≤7 then
  SLIV=14·(L−1)+S
else
  SLIV=14·(14−L+1)+(14−1−S)
where0<L≤14−S ,
```

and
the PDSCH mapping type is set to Type A or Type B as defined in Clause 7.4.1.1.2 of [4, TS 38.211].

### 6 Physical Uplink Shared Channel Related Procedure

### 6.1 UE Procedure for Transmitting the Physical Uplink Shared Channel

PUSCH transmission(s) can be dynamically scheduled by an UL grant in a DCI, or the transmission can correspond to a configured grant Type 1 or Type 2. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI according to clause 10.2 of [6, TS 38.213] after the reception of higher layer parameter configuredGrantConfig not including rrc-ConfiguredUplinkGrant. If configuredGrantConfigToAddModList is configured, more than one configured grant configuration of configured grant Type 1 and/or configured grant Type 2 may be active at the same time on an active BWP of a serving cell.

The UE can be configured with a list of up to 64 TCI-UL-State configurations within the higher layer parameter BWP-UplinkDedicated. Each TCI-UL-State configuration contains a parameter for configuring one reference signal, if applicable, for determining UL TX spatial filter for dynamic-grant and configured-grant based PUSCH and PUCCH resource in a CC, and SRS.

If a UE is configured by higher layer parameter PDCCH-Config that contains ControlResourceSets with two different values of coresetPoolIndex for the active BWP of a serving cell, or if a UE is configured with SSB-MTC-AddtionalPCI and with PDCCH-Config that contains two different values of coresetPoolIndex in ControlResourceSet, and if the UE is configured with tag2-Id and is configured with dl-OrJointTCI-StateList or TCI-UL-State for a serving cell, each TCI-State or TCI-UL-State is associated with a tag-Id-ptr for determining timing adjustment for a corresponding UL transmission as described in Clause 4.2 of [6, TS 38.213]. The UE does not expect that TCI-states or TCI-UL-States associated with one coresetPoolIndex to correspond to two TAGs.

For the PUSCH transmission corresponding to a Type 1 configured grant or a Type 2 configured grant activated by DCI format 0_0 or 0_1, the parameters applied for the transmission are provided by configuredGrantConfig except for dataScramblingIdentityPUSCH, txConfig, codebookSubset, maxRank, scaling of UCI-OnPUSCH, which are provided by pusch-Config. A configured grant PUSCH can be transmitted with at most 4 layers. For the PUSCH transmission corresponding to a Type 2 configured grant activated by DCI format 0_2, the parameters applied for the transmission are provided by configuredGrantConfig except for dataScramblingIdentityPUSCH, txConfig, codebookSubsetDCI-0-2, maxRankDCI-0-2, scaling of UCI-OnPUSCH, resourceAllocationType1GranularityDCI-0-2 provided by pusch-Config.

When the UE is configured dl-OrJointTCI-StateList or ul-TCI-StateList, the UE shall perform PUSCH transmission corresponding to a Type 1 configured grant or a Type 2 configured grant or a dynamic grant according to the spatial relation, if applicable, with a reference to the RS for determining UL Tx spatial filter. The RS is determined based on an RS configured with qcl-Type set to ‘typeD’ of the indicated TCI-State or an RS in the indicated TCI-UL-State. The reference RS in the indicated TCI-State can be a CSI-RS resource in a NZP-CSI-RS-ResourceSet configured with higher layer parameter repetition, or a CSI-RS resource in an NZP-CSI-RS-ResourceSet configured with higher layer parameter trs-Info. The reference RS in the indicated TCI-UL-State can be a CSI-RS resource in a NZP-CSI-RS-ResourceSet configured with higher layer parameter repetition, a CSI-RS resource in an NZP-CSI-RS-ResourceSet configured with higher layer parameter trs-Info, an SRS resource in an SRS resource set with the higher layer parameter usage set to ‘beamManagement’, or SS/PBCH block associated with the same or different PCI from the PCI of the serving cell. When nrofSlotsInCG-Period is configured for Type 1 configured grant or Type 2 configured grant, HARQ process ID for the first configured PUSCH grant and each subsequent valid configured PUSCH grant within a periodicity of the configuration is determined as in clause 5.4.1 of [10, TS 38.321], where a valid configured PUSCH grant is the one not colliding with the DL symbol(s) indicated by tdd-UL-DL-ConfigurationCommon or tdd-UL-DL-ConfigurationDedicated if provided, and not colliding with a symbol(s) of an SS/PBCH block with index provided by ssb-PositionsInBurst as described in clause 11.1 of [6, TS 38.213].

For the PUSCH retransmission scheduled by a PDCCH with CRC scrambled by CS-RNTI with NDI=1, the parameters in pusch-Config are applied for the PUSCH transmission except for p0-NominalWithoutGrant, p0-PUSCH-Alpha, powerControlLoopToUse, pathlossReferenceIndex described in clause 7.1 of [6, TS 38.213], mcs-Table, mcs-TableTransformPrecoder described in clause 6.1.4.1 and transformPrecoder described in clause 6.1.3.

For a UE configured with two uplinks in a serving cell, PUSCH retransmission for a TB on the serving cell is not expected to be on a different uplink than the uplink used for the PUSCH initial transmission of that TB.

A UE shall upon detection of a PDCCH with a configured DCI format 0_0, 0_1, 0_2 or 0_3 transmit the corresponding PUSCH as indicated by that DCI unless the UE does not generate a transport block as described in [10, TS 38.321]. Upon detection of a DCI format 0_1 or 0_2 with ‘UL-SCH indicator’ set to ‘0’ and with a non-zero ‘CSI request’ where the associated reportQuantity in CSI-ReportConfig set to ‘none’ for all CSI report(s) triggered by ‘CSI request’ in this DCI format 0_1 or 0_2, the UE ignores all fields in this DCI except the ‘CSI request’ and the UE shall not transmit the corresponding PUSCH as indicated by this DCI format 0_1 or 0_2. Upon detection of a DCI format 0_3 with ‘UL-SCH indicator’ set to ‘0’ and with a non-zero ‘CSI request’ where the associated reportQuantity in CSI-ReportConfig set to ‘none’ for all CSI report(s) triggered by ‘CSI request’ in this DCI format 0_3, the UE ignores all fields for the scheduled cell with the smallest serving cell index in this DCI except the ‘CSI request’ and the UE shall not transmit the corresponding PUSCH on the serving cell with the smallest serving cell index as indicated by this DCI format 0_3.

### 6.1.1 Transmission Schemes

Two transmission schemes are supported for PUSCH: codebook based transmission and non-codebook based transmission. The UE is configured with codebook based transmission when the higher layer parameter txConfig in pusch-Config is set to ‘codebook’, the UE is configured non-codebook based transmission when the higher layer parameter txConfig is set to ‘nonCodebook’. If the higher layer parameter txConfig is not configured, the UE is not expected to be scheduled by DCI format 0_1, 0_2 or 0_3. If PUSCH is scheduled by DCI format 0_0, the PUSCH transmission is based on a single antenna port. Except if the higher layer parameter enableDefaultBeamPL-ForPUSCH0-0 is set ‘enabled’, the UE shall not expect PUSCH scheduled by DCI format 0_0 in a BWP without configured PUCCH resource with PUCCH-SpatialRelationInfo in frequency range 2 in RRC connected mode.

### 6.1.1.1 Codebook Based UL Transmission

For codebook based transmission, PUSCH can be scheduled by DCI format 0_0, DCI format 0_1, DCI format 0_2, DCI format 0_3 or semi-statically configured to operate according to Clause 6.1.2.3. If this PUSCH is scheduled by DCI format 0_1, DCI format 0_2, or semi-statically configured to operate according to Clause 6.1.2.3, the UE determines its PUSCH transmission precoder(s) based on SRI(s), TPMI(s) and the transmission rank, where the SRI(s), TPMI(s) and the transmission rank are given by DCI fields of one or two SRS resource indicators and one or two Precoding information and number of layers in clause 7.3.1.1.2 and 7.3.1.1.3 of [5, TS 38.212] for DCI format 0_1 and 0_2 or given by srs-ResourceIndicator and precodingAndNumberOfLayers according to clause 6.1.2.3 or given by srs-ResourceIndicator, srs-ResourceIndicator2, precodingAndNumberOfLayers, and precodingAndNumberOfLayers2 according to clause 6.1.2.3. If this PUSCH is scheduled by DCI format 0_3, the UE determines its PUSCH transmission precoder based on SRI, TPMI and the transmission rank, where the SRI, TPMI and the transmission rank are given by DCI fields of one SRS resource indicator and one Precoding information and number of layers in clause 7.3.1.1.4 of [5, TS 38.212] for DCI format 0_3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Only one or two SRS resource sets can be configured in srs-ResourceSetToAddModList with higher layer parameter usage in SRS-ResourceSet set to ‘codebook’, and only one or two SRS resource sets can be configured in srs-ResourceSetToAddModListDCI-0-2 with higher layer parameter usage in SRS-ResourceSet set to ‘codebook’.

When only one SRS resource set is configured in srs-ResourceSetToAddModList or srs-ResourceSetToAddModListDCI-0-2 with higher layer parameter usage in SRS-ResourceSet set to ‘codebook’, SRI and TPMI are given by the DCI fields of one SRS resource indicator and one Precoding information and number of layers in clauses 7.3.1.1.2, 7.3.1.1.3 and 7.3.1.1.4 of [5, TS 38.212] for DCI format 0_1, 0_2 and 0_3 or given by srs-ResourceIndicator and precodingAndNumberOfLayers according to clause 6.1.2.3. A UE does not expect two SRS resource sets are configured in srs-ResourceSetToAddModList with higher layer parameter usage in SRS-ResourceSet set to ‘codebook’ for a serving cell, when the serving cell is included in schedulingCellListDCI-0-3-r18 for a set of serving cells provided by mc-DCI-SetOfCellsToAddModList-r18. The TPMI is used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder is selected from the uplink codebook that has a number of antenna ports equal to higher layer parameter nrofSRS-Ports or nrofSRS-Ports-n8 in SRS-Config, as defined in Clause 6.3.1.5 of [4, TS 38.211]. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the PDCCH carrying the SRI.

### 6.1.1.2 Non-Codebook Based UL Transmission

For non-codebook based transmission, PUSCH can be scheduled by DCI format 0_0, DCI format 0_1, DCI format 0_2, DCI format 0_3 or semi-statically configured to operate according to Clause 6.1.2.3. If this PUSCH is scheduled by DCI format 0_1, DCI format 0_2, DCI format 0_3 or semi-statically configured to operate according to Clause 6.1.2.3, the UE can determine its PUSCH precoder(s) and transmission rank based on the SRI(s) when multiple SRS resources are configured, where the SRI(s) is given by one or two SRS resource indicator(s) in DCI according to clause 7.3.1.1.2 and 7.3.1.1.3 of [5, 38.212] for DCI format 0_1 and DCI format 0_2, or the SRI is given by one SRS resource indicator in DCI according to clause 7.3.1.1.4 of [5, 38.212] for DCI format 0_3, or the SRI is given by srs-ResourceIndicator according to clause 6.1.2.3, or SRIs given by srs-ResourceIndicator and srs-ResourceIndicator2 according to clause 6.1.2.3 . . . . The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. The UE shall use one or multiple SRS resources for SRS transmission, where, in one or two SRS resource set(s), the maximum number of SRS resources which can be configured to the UE for simultaneous transmission in the same symbol and the maximum number of SRS resources are UE capabilities. The SRS resources transmitted simultaneously occupy the same RBs. For a given CC, multiple SRS resources in a set with usage “nonCodebook” are not expected to be partially overlapped in time. Only one SRS port for each SRS resource is configured. Only one or two SRS resource sets can be configured in srs-ResourceSetToAddModList with higher layer parameter usage in SRS-ResourceSet set to ‘nonCodebook’, and only one or two SRS resource sets can be configured in srs-ResourceSetToAddModListDCI-0-2 with higher layer parameter usage in SRS-ResourceSet set to ‘nonCodebook’. When neither multipanelSchemeSDM nor multipanelSchemeSFN is configured and two SRS resource sets are configured in srs-ResourceSetToAddModList or srs-ResourceSetToAddModListDCI-0-2 with higher layer parameter usage in SRS-ResourceSet set to ‘nonCodebook’, SRIs are given by the DCI fields of two SRS resource indicators in clauses 7.3.1.1.2 and 7.3.1.1.3 of [5, TS 38.212] for DCI format 0_1 and 0_2 and the UE applies the indicated SRI(s) to one or more PUSCH repetitions according to the associated SRS resource set of a PUSCH repetition according to clause 6.1.2.1. A UE does not expect two SRS resource sets are configured in srs-ResourceSetToAddModList with higher layer parameter usage in SRS-ResourceSet set to ‘nonCodebook’ for a serving cell, when the serving cell is included in schedulingCellListDCI-0-3-r18 for a set of serving cells provided by mc-DCI-SetOfCellsToAddModList-r18. The maximum number of SRS resources per SRS resource set that can be configured for non-codebook based uplink transmission is 1, 2, 4 or 8 depending on UE capability. Each of the indicated SRIs in slot n is associated with the most recent transmission of SRS resource(s) of associated SRS resource set identified by the SRI, where the SRS transmission is prior to the PDCCH carrying the SRI. When two SRS resource sets are configured in srs-ResourceSetToAddModList or srs-ResourceSetToAddModListDCI-0-2 with higher layer parameter usage in SRS-ResourceSet set to ‘nonCodebook’, the UE is not expected to be configured with different number of SRS resources in the two SRS resource sets.

When the UE is configured with the higher layer parameter txConfig set to ‘nonCodebook’, the UE is configured with at least one SRS resource. Each of the indicated one or two SRI(s) in slot n is associated with the most recent transmission of SRS resource of associated SRS resource set identified by the SRI, where the SRS resource is prior to the PDCCH carrying the SRI. When two SRS resource sets are configured in srs-ResourceSetToAddModList or srs-ResourceSetToAddModListDCI-0-2 with higher layer parameter usage in SRS-ResourceSet set to ‘nonCodebook’, the UE is not expected to be configured with different number of SRS resources in the two SRS resource sets.

6.1.2.3 Resource Allocation for Uplink Transmission with Configured Grant

When PUSCH resource allocation is semi-statically configured by higher layer parameter configuredGrantConfig in BWP-UplinkDedicated information element, and the PUSCH transmission corresponding to a configured grant, the following higher layer parameters are applied in the transmission:
For Type 1 PUSCH transmissions with a configured grant, the following parameters are given in configuredGrantConfig unless mentioned otherwise:
   For the determination of the PUSCH repetition type, if the higher layer parameter pusch-RepTypeIndicator in rrc-ConfiguredUplinkGrant is configured and set to ‘pusch-RepTypeB’, PUSCH repetition type B is applied; otherwise, PUSCH repetition type A is applied;
   The higher layer parameter timeDomainAllocation value m provides a row index m+1 pointing to the determined time domain resource allocation table, where the start symbol and length are determined following the procedure defined in Clause 6.1.2.1;
   Frequency domain resource allocation is determined by the N LSB bits in the higher layer parameter frequency DomainAllocation, forming a bit sequence f₁₇, . . . , f₁, f₀, where f₀ is the LSB, according to the procedure in Clause 6.1.2.2 and N is determined as the size of frequency domain resource assignment field in DCI format 0_1 for a given resource allocation type indicated by resourceAllocation, except if useInterlacePUCCH-PUSCH in BWP-UplinkDedicated is configured, in which case uplink type 2 resource allocation is used wherein the UE interprets the LSB bits in the higher layer parameter frequencyDomainAllocation as for the frequency domain resource assignment field of DCI 0_1 according to the procedure in Clause 6.1.2.2.3;
For Type 2 PUSCH transmissions with a configured grant: the resource allocation follows the higher layer configuration according to [10, TS 38.321], and UL grant received on the DCI.
   The PUSCH repetition type and the time domain resource allocation table are determined by the PUSCH repetition type and the time domain resource allocation table associated with the UL grant received on the DCI, respectively, as defined in Clause 6.1.2.1. The value of Koffset, if configured, is applied when determining the first transmission opportunity.

For PUSCH transmissions with a Type 1 configured grant, when neither multipanelSchemeSDM nor multipanelSchemeSFN is configured and two SRS resource sets are configured in srs-ResourceSetToAddModList or srs-ResourceSetToAddModListDCI-0-2, if configuredGrantConfig contains only one pathlossReferenceIndex, p0-PUSCH-Alpha, powerControlLoopToUse, srs-ResourceIndicator and precodingAndNumberOfLayers (applicable when higher layer parameter usage in SRS-ResourceSet set to ‘codebook’), PUSCH repetitions are associated only with the first SRS resource set.

If neither multipanelSchemeSDM nor multipanelSchemeSFN is configured and the UE is provided two SRS resource sets in srs-ResourceSetToAddModList or srs-ResourceSetToAddModListDCI-0-2 with usage set to ‘codebook’ or ‘nonCodebook’, and the UE is not provided p0-PUSCH-Alpha2 and powerControlLoopToUse2, for a retransmission of a configured grant Type 1 PUSCH, or for activation or retransmission of a configured grant Type 2 PUSCH, scheduled by a DCI format that includes an SRS resource set indicator field, the UE expects the value of the SRS resource set indicator field to be set to ‘00’, and PUSCH repetitions are associated only with the first SRS resource set.

The UE shall not transmit anything on the resources configured by configuredGrantConfig if the higher layers did not deliver a transport block to transmit on the resources allocated for uplink transmission without grant.

A set of allowed periodicities P are defined in [12, TS 38.331]. The higher layer parameter cg-nrofSlots, provides the number of consecutive slots allocated within a configured grant period. The higher layer parameter cg-nrofPUSCH-InSlot provides the number of consecutive PUSCH allocations within a slot, where the first PUSCH allocation follows the higher layer parameter timeDomainAllocation for Type 1 PUSCH transmission or the higher layer configuration according to [10, TS 38.321], and UL grant received on the DCI for Type 2 PUSCH transmissions, and the remaining PUSCH allocations have the same length and PUSCH mapping type, and are appended following the previous allocations without any gaps. The higher layer parameter nrofSlotsInCG-Period provides the number of consecutive slots allocated within a configured grant period. The same combination of start symbol and length and PUSCH mapping type repeats over the consecutively allocated slots if cg-nrofSlots or nrofSlotsInCG-Period is configured. If nrofSlotsInCG-Period is configured, the PUSCH allocation in each consecutive slot follows the higher layer parameter timeDomainAllocation for Type 1 PUSCH transmission or the higher layer configuration according to [10, TS 38.321], and UL grant received in the DCI for Type 2 PUSCH transmissions. If a UE is configured with higher layer parameter nrofSlotsInCG-Period in a configuredGrantConfig, the UE does not expect to be configured with cg-nrofSlots and cg-nrofPUSCH-InSlot in the configuredGrantConfig.

In [3] 3GPP TS 38.212 i00, relevant paragraphs are quoted below:

### 7.3.1.1.2 Format 0_1

DCI format 0_1 is used for the scheduling of one or multiple PUSCH in one cell, or indicating CG downlink feedback information (CG-DFI) to a UE.

The following information is transmitted by means of the DCI format 0_1 with CRC scrambled by C-RNTI or CS-RNTI or SP-CSI-RNTI or MCS-C-RNTI:
Identifier for DCI formats-1 bit
   The value of this bit field is always set to 0, indicating an UL DCI format
Carrier indicator-0 or 3 bits, as defined in Clause 10.1 of [5, TS38.213]. This field is reserved when this format is carried by PDCCH on the primary cell and the UE is configured for scheduling on the primary cell from an SCell, with the same number of bits as that in this format carried by PDCCH on the SCell for scheduling on the primary cell.
Bandwidth part indicator—0, 1 or 2 bits as determined by the number of UL BWPS n_{BWP,RRC} configured by higher layers, excluding the initial UL bandwidth part. The bitwidth for this field is determined as [log ₂ (npwp)] bits, where
Frequency domain resource assignment-number of bits determined by the following, where N_{RB}^{UL,BWP} is the size of the active UL bandwidth part:
Time domain resource assignment—0, 1, 2, 3, 4, 5, or 6 bits
HARQ process number-5 bits if higher layer parameter harq-ProcessNumberSizeDCI-0-1 is configured; otherwise 4 bits

### 7.3.1.2.2 Format 1 1

DCI format 1_1 is used for the scheduling of one or multiple PDSCH in one cell.

The following information is transmitted by means of the DCI format 1_1 with CRC scrambled by C-RNTI or CS-RNTI or MCS-C-RNTI:
Identifier for DCI formats-1 bits
   The value of this bit field is always set to 1, indicating a DL DCI format
Carrier indicator—0 or 3 bits as defined in Clause 10.1 of [5, TS 38.213]. This field is reserved when this format is carried by PDCCH on the primary cell and the UE is configured for scheduling on the primary cell from an SCell, with the same number of bits as that in this format carried by PDCCH on the SCell for scheduling on the primary cell.
Bandwidth part indicator-0, 1 or 2 bits as determined by the number of DL BWPS n_{BWP,RRC} configured by higher layers, excluding the initial DL bandwidth part. The bitwidth for this field is determined as [log ₂ (n_{BWP})] bits, where
Frequency domain resource assignment-number of bits determined by the following, where N_{RB}^{DL,BWP} is the size of the active DL bandwidth part:
Time domain resource assignment—0, 1, 2, 3, 4, 5 or 6 bits
Transmission configuration indication—0 bit if higher layer parameter tci-PresentInDCI is not enabled; otherwise 3 bits as defined in Clause 5.1.5 of [6, TS38.214].

If “Bandwidth part indicator” field indicates a bandwidth part other than the active bandwidth part,
if the higher layer parameter tci-PresentInDCI is not enabled for the CORESET used for the PDCCH carrying the DCI format 1_1,
   the UE assumes tci-PresentInDCI is not enabled for all CORESETs in the indicated bandwidth part;
otherwise,
   the UE assumes tci-PresentInDCI is enabled for all CORESETs in the indicated bandwidth part.
Transmission configuration indication—0 bit if higher layer parameter tci-PresentInDCI is not enabled; otherwise 3 bits as defined in Clause 5.1.5 of [6, TS38.214].

In [4] 3GPP TS 38.331 i40, relevant information element (IE) and parameter are quoted below:
BWP-UplinkDedicated

The IE BWP-UplinkDedicated is used to configure the dedicated (UE specific) parameters of an uplink BWP.

### BWP-UplinkDedicated Information Element

-- ASN1START
-- TAG-BWP-UPLINKDEDICATED-START

| | |
|---|---|
| BWP-UplinkDedicated ::= | SEQUENCE { |
| pucch-Config | SetupRelease { PUCCH-Config } |

OPTIONAL, -- Need M

| | |
|---|---|
| pusch-Config | SetupRelease { PUSCH-Config } |

OPTIONAL, -- Need M

| | |
|---|---|
| configuredGrantConfig | SetupRelease { ConfiguredGrantConfig } |

```
OPTIONAL, -- Need M
  [[
  configuredGrantConfigToAddModList-r16 ConfiguredGrantConfigToAddModList-r16
OPTIONAL, -- Need N
  configuredGrantConfigToReleaseList-r16 ConfiguredGrantConfigToReleaseList-r16
OPTIONAL, -- Need N
  configuredGrantConfigType2DeactivationStateList-r16
ConfiguredGrantConfigType2DeactivationStateList-r16 OPTIONAL -- Need R
  ]],
  [[
```

| | |
|---|---|
| ul-TCI-StateList-r17 | CHOICE { |
| explicitlist | SEQUENCE { |
| ul-TCI-ToAddModList-r17 | SEQUENCE (SIZE (1..maxUL-TCI-r17)) OF TCI-UL-State- |

r17 OPTIONAL, -- Need N

| | |
|---|---|
| ul-TCI-ToReleaseList-r17 | SEQUENCE (SIZE (1..maxUL-TCI-r17)) OF TCI-UL-StateId- |

r17 OPTIONAL -- Need N
},

| | |
|---|---|
| unifiedTCI-StateRef-r17 | ServingCellAndBWP-Id-r17 |

}
OPTIONAL, -- Need R

| | |
|---|---|
| ul-powerControl-r17 | Uplink-powerControlId-r17 |

OPTIONAL, -- Cond NoTCI-PC
}
ConfiguredGrantConfigToAddModList-r16 ::= SEQUENCE (SIZE (1..maxNrofConfiguredGrantConfig-r16)) OF
ConfiguredGrantConfig
ConfiguredGrantConfigToReleaseList-r16 ::= SEQUENCE (SIZE (1..maxNrofConfiguredGrantConfig-r16)) OF
ConfiguredGrantConfigIndex-r16
ConfiguredGrantConfigType2DeactivationState-r16 ::= SEQUENCE (SIZE (1..maxNrofConfiguredGrantConfig-
r16)) OF ConfiguredGrantConfigIndex-r16
ConfiguredGrantConfigType2DeactivationStateList-r16 ::=
SEQUENCE (SIZE (1..maxNrofCG-Type2DeactivationState)) OF
ConfiguredGrantConfigType2DeactivationState-r16
-- TAG-BWP-UPLINKDEDICATED-STOP
-- ASN1STOP

BWP-UplinkDedicated field descriptions

configuredGrantConfig
A Configured-Grant of type1 or type2. It may be configured for UL or SUL but in case of type1 not for both at a time.
Except for reconfiguration with sync, the NW does not reconfigure configuredGrantConfig when there is an active
configured uplink grant Type 2 (see TS 38.321 [3]). However, the NW may release the configuredGrantConfig at any
time. Network can only configure configured grant in one BWP using either this field or
configuredGrantConfigToAddModList.
configuredGrantConfigToAddModList
Indicates a list of one or more configured grant configurations to be added or modified for one BWP. Except for
reconfiguration with sync, the NW does not reconfigure a Type 2 configured grant configuration when it is active (see
TS 38.321 [3]). The network configures multiple CG configurations for one BWP with either all configurations or no
configuration configured with cg-RetransmissionTimer-r16.
configuredGrantConfigToReleaseList
Indicates a list of one or more UL Configured Grant configurations to be released. The NW may release a configured
grant configuration at any time.
ul-powerControl
Configures power control parameters for PUCCH, PUSCH and SRS when UE is configured with unifiedTCI-StateType
for this serving cell. For each serving cell, ul-powerControl is either configured in all BWP-UplinkDedicated or it is not
configured in any BWP-UplinkDedicated. When unifiedTCI-StateRef in the BWP-UplinkDedicated or in the PDSCH-
Config if the unifiedTCI-State Type is set to joint, of a serving cell refers to another serving cell, ul-powerControl is either
configured in all BWP-UplinkDedicated of these two serving cells or it is not configured in any BWP-UplinkDedicated of
these two serving cells.
ul-TCI-StateList
Indicates the applicable UL TCI states for PUCCH, PUSCH and SRS.
ul-TCI-ToAddModList
Indicates a list of UL TCI states.
unifiedTCI-StateRef
Provides the serving cell and UL BWP where UL TCI states applicable to this UL BWP are defined. The value of
unifiedTCI-StateType of current serving cell is the same in the serving cell indicated by unifiedTCI-StateRef.

CSI-ReportConfig

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214 [19], clause 5.2.1.

### CSI-ReportConfig Information Element

-- ASN1START
-- TAG-CSI-REPORTCONFIG-START

| | |
|---|---|
| CSI-ReportConfig ::= | SEQUENCE { |
| reportConfigId | CSI-ReportConfigId, |
| carrier | ServCellIndex OPTIONAL, -- Need S |
| resourcesForChannelMeasurement | CSI-ResourceConfigId, |
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, |

sl320},

| | |
|---|---|
| reportSlotOffsetList | SEQUENCE (SIZE (1.. maxNrofUL-Allocations)) OF |

INTEGER(0..32),
p0alpha

| | |
|---|---|
| }, | P0-PUSCH-AlphaSetId |
| aperiodic | SEQUENCE { |
| reportSlotOffsetList | SEQUENCE (SIZE (1..maxNrofUL-Allocations )) OF |

```
INTEGER(0..32)
    }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},
}
CSI-ReportPeriodicityAndOffset ::= CHOICE {

| | |
|---|---|
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}
-- TAG-CSI-REPORTCONFIG-STOP
-- ASN1STOP

CSI-ReportConfig field descriptions

carrier
Indicates in which serving cell the CSI-ResourceConfig indicated below are to be found. If the field is absent, the
resources are on the same serving cell as this report configuration.
p0alpha
Index of the p0-alpha set determining the power control for this CSI report transmission (see TS 38.214 [19], clause
6.2.1.2).
reportConfigType
Time domain behavior of reporting configuration.
reportQuantity
The CSI related quantities to report. see TS 38.214 [19], clause 5.2.1. If the field reportQuantity-r16, reportQuantity-r17
or reportQuantity-r18 is present, UE shall ignore reportQuantity (without suffix). Network does not configure
reportQuantity-r17 or reportQuantity-r18 together with reportQuantity-r16.
reportSlotConfig
Periodicity and slot offset (see TS 38.214 [19], clause 5.2.1.4). If the field reportSlotConfig-v1530 is present, the UE
shall ignore the value provided in reportSlotConfig (without suffix).
reportSlotOffsetList, reportSlotOffsetListDCI-0-1, reportSlotOffsetListDCI-0-2
Timing offset Y for semi persistent reporting using PUSCH. This field lists the allowed offset values. This list must have
the same number of entries as the pusch-TimeDomainAllocationList in PUSCH-Config. A particular value is indicated in
DCI. The network indicates in the DCI field of the UL grant, which of the configured report slot offsets the UE shall
apply. The DCI value 0 corresponds to the first report slot offset in this list, the DCI value 1 corresponds to the second
report slot offset in this list, and so on. The first report is transmitted in slot n + Y, second report in n + Y + P, where P is the
configured periodicity.
Timing offset Y for aperiodic reporting using PUSCH. This field lists the allowed offset values. This list must have the
same number of entries as the pusch-TimeDomainAllocationList in PUSCH-Config. A particular value is indicated in
DCI. The network indicates in the DCI field of the UL grant, which of the configured report slot offsets the UE shall
apply. The DCI value 0 corresponds to the first report slot offset in this list, the DCI value 1 corresponds to the second
report slot offset in this list, and so on (see TS 38.214 [19], clause 6.1.2.1).
The field reportSlotOffsetListDCI-0-1 applies to DCI format 0_1 and the field reportSlotOffsetListDCI-0-2 applies to DCI
format 0_2 (see TS 38.214 [19], clause 6.1.2.1).
The fields reportSlotOffsetList-r17, reportSlotOffsetListDCI-0-1-r17 and reportSlotOffsetListDCI-0-2-r17 are only
applicable for SCS 480 kHz and 960 kHz and if they are configured, the UE shall ignore the fields reportSlotOffsetList
(without suffix), reportSlotOffsetListDCI-0-1 (without suffix) and reportSlotOffsetListDCI-0-2 (without suffix) for SCS 480
kHz and 960 kHz.
resourcesForChannelMeasurement
Resources for channel measurement. csi-ResourceConfigId of a CSI-ResourceConfig included in the configuration of
the serving cell indicated with the field “carrier” above. The CSI-ResourceConfig indicated here contains only NZP-CSI-
RS resources and/or SSB resources. This CSI-ReportConfig is associated with the DL BWP indicated by bwp-Id in that
CSI-ResourceConfig.

CSI-ResourceConfig

The IE CSI-ResourceConfig defines a group of one or more NZP-CSI-RS-ResourceSet, CSI-IM-ResourceSet and/or CSI-SSB-ResourceSet.

### CSI-ResourceConfig Information Element

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

```
      nzp-CSI-RS-ResourceSetList SEQUENCE (SIZE (1..maxNrofNZP-CSI-RS-ResourceSetsPerConfig))
OF NZP-CSI-RS-ResourceSetId
OPTIONAL, -- Need R
      csi-SSB-ResourceSetList SEQUENCE (SIZE (1..maxNrofCSI-SSB-ResourceSetsPerConfig)) OF
CSI-SSB-ResourceSetId OPTIONAL -- Need R
    },
    csi-IM-ResourceSetList SEQUENCE (SIZE (1..maxNrofCSI-IM-ResourceSetsPerConfig)) OF CSI-
IM-ResourceSetId
  },
```

| | |
|---|---|
| bwp-Id | BWP-Id, |
| resourceType | ENUMERATED { aperiodic, semiPersistent, periodic }, |

```
  ...,
  [[
  csi-SSB-ResourceSetListExt-r17 CSI-SSB-ResourceSetId
OPTIONAL -- Need R
  ]]
}
-- TAG-CSI-RESOURCECONFIG-STOP
-- ASN1STOP
```

CSI-ResourceConfig field descriptions

bwp-Id
The DL BWP which the CSI-RS associated with this CSI-ResourceConfig are located in (see TS 38.214 [19], clause
5.2.1.2.
csi-ResourceConfigId
Used in CSI-ReportConfig to refer to an instance of CSI-ResourceConfig.
csi-SSB-ResourceSetList, csi-SSB-ResourceSetListExt
List of references to SSB resources used for CSI measurement and reporting in a CSI-RS resource set (see TS 38.214
[19], clause 5.2.1.2). The csi-SSB-ResourceSetListExt provides additional references and can only be configured if csi-
SSB-ResourceSetList is configured and groupBasedBeamReporting-v1710 is configured in the CSI-ReportConfig that
indicates this CSI-ResourceConfig as resourcesForChannelMeasurement. If groupBasedBeamReporting-v1710 is
configured in the IE CSI-ReportConfig that indicates this CSI-ResourceConfig as resourcesForChannelMeasurement,
the network configures 2 resource sets, which may be two CSI SSB resource sets (see TS 38.214 [19], clause 5.2.1.2
and 5.2.1.4.2). In this case, in TS 38.212 [17] Table 6.3.1.1.2-8B, the first resource set is indicated by a resource set
indicator set to 0 and the second resource set by a resource set indicator set to 1.
nzp-CSI-RS-ResourceSetList
List of references to NZP CSI-RS resources used for beam measurement and reporting in a CSI-RS resource set.
If resource Type is set to ‘aperiodic’, the network configures up to maxNrofNZP-CSI-RS-ResourceSetsPerConfig
resource sets. If resourceType is is set to ‘periodic’ or ‘semiPersistent’ and groupBasedBeamReporting-v1710 is not
configured in IE CSI-ReportConfig, the network configures 1 resource set. If resourceType is set to ‘periodic’ or
‘semiPersistent’ and groupBasedBeamReporting-v1710 is configured, the network configures 2 resource sets, which
may be two NZP CSI-RS resource sets (see TS 38.214 [19], clause 5.2.1.2 and 5.2.1.4.2). In this case, in TS 38.212
[17] Table 6.3.1.1.2-8B, the first resource set is indicated by a resource set indicator set to 0 and the second resource
set by a resource set indicator set to 1. If resourceType is set to ‘periodic’ and reportQuantity is set to ‘TDCP’, the
network configures up to 3 resource sets, see TS 38.214 [19] clause 5.2.1.2.
resourceType
Time domain behavior of resource configuration (see TS 38.214 [19], clause 5.2.1.2). It does not apply to resources
provided in the csi-SSB-ResourceSetList.

ConfiguredGrantConfigIndex

The IE ConfiguredGrantConfigIndex is used to indicate the index of one of multiple UL Configured Grant configurations in one BWP.

### ConfiguredGrantConfigIndex Information Element

-- ASN1START
-- TAG-CONFIGUREDGRANTCONFIGINDEX-START
ConfiguredGrantConfigIndex-r16 ::= INTEGER (0..
maxNrofConfiguredGrantConfig-1-r16)
-- TAG-CONFIGUREDGRANTCONFIGINDEX-STOP
-- ASN1STOP

ConfiguredGrantConfigIndexMAC

The IE ConfiguredGrantConfigIndexMAC is used to indicate the unique Configured Grant configurations index per MAC entity.

### ConfiguredGrantConfigIndexMAC Information Element

-- ASN1START
-- TAG-CONFIGUREDGRANTCONFIGINDEXMAC-START
ConfiguredGrantConfigIndexMAC-r16 ::= INTEGER (0..
maxNrofConfiguredGrantConfigMAC-1-r16)
-- TAG-CONFIGUREDGRANTCONFIGINDEXMAC-STOP
-- ASN1STOP

ConfiguredGrantConfig

The IE ConfiguredGrantConfig is used to configure uplink transmission without dynamic grant according to two possible schemes. The actual uplink grant may either be configured via RRC (type1) or provided via the PDCCH (addressed to CS-RNTI)(type 2). Multiple Configured Grant configurations may be configured in one BWP of a serving cell.

### ConfiguredGrantConfig Information Element

-- ASN1START
-- TAG-CONFIGUREDGRANTCONFIG-START

| | |
|---|---|
| ConfiguredGrantConfig ::= | SEQUENCE { |
| frequencyHopping | ENUMERATED {intraSlot, interSlot} |

OPTIONAL, -- Need S

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, |

sym8x14, sym10x14, sym16x14, sym20x14,

sym32x14, sym40x14, sym64x14, sym80x14, sym128x14,

sym160x14, sym256x14, sym320x14, sym512x14,

sym640x14, sym1024x14, sym1280x14, sym2560x14,

sym5120x14,

sym6, sym1x12, sym2x12, sym4x12, sym5x12, sym8x12,

sym10x12, sym16x12, sym20x12, sym32x12,

sym40x12, sym64x12, sym80x12, sym128x12, sym160x12,

sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs-1), |

```
    ...,
    [[
```

| | |
|---|---|
| pusch-RepTypeIndicator-r16 | ENUMERATED {pusch-RepTypeA,pusch-RepTypeB} |

OPTIONAL, -- Need M
frequencyHoppingPUSCH-RepTypeB-r16 ENUMERATED {interRepetition, interSlot}
OPTIONAL, -- Cond RepTypeB

| | |
|---|---|
| timeReferenceSFN-r16 | ENUMERATED {sfn512} |

```
OPTIONAL -- Need S
    ]],
    [[
```

| | |
|---|---|
| pathlossReferenceIndex2-r17 | INTEGER (0..maxNrofPUSCH-PathlossReferenceRSs-1) |

OPTIONAL, -- Need R

| | |
|---|---|
| srs-ResourceIndicator2-r17 | INTEGER (0..15) |

OPTIONAL, -- Need R

| | |
|---|---|
| precodingAndNumberOfLayers2-r17 | INTEGER (0..63) |

OPTIONAL, -- Need R

| | |
|---|---|
| timeDomainAllocation-v1710 | INTEGER (16..63) |

OPTIONAL, -- Need M

| | |
|---|---|
| timeDomainOffset-r17 | INTEGER (0..40959) |

OPTIONAL, -- Need R

| | |
|---|---|
| cg-SDT-Configuration-r17 | CG-SDT-Configuration-r17 |

```
OPTIONAL -- Need M
    ]],
    [[
```

| | |
|---|---|
| srs-ResourceSetId-r18 | SRS-ResourceSetId |

OPTIONAL, -- Need R

| | |
|---|---|
| cg-LTM-Configuration-r18 | CG-RRC-Configuration-r18 |

OPTIONAL, -- Cond LTM

| | |
|---|---|
| cg-SDT-PeriodicityExt-r18 | ENUMERATED { |
| | sym1x14x1280, sym2x14x1280, sym4x14x1280 , |

sym8x14x1280, sym16x14x1280,

sym32x14x1280, sym48x14x1280, sym64x14x1280,

sym96x14x1280, sym128x14x1280,

sym192x14x1280, sym240x14x1280, sym256x14x1280,

sym384x14x1280, sym472x14x1280,

sym480x14x1280, sym512x14x1280, sym768x14x1280,

sym944x14x1280, sym960x14x1280,

sym1408x14x1280, sym1536x14x1280, sym1888x14x1280,

sym1920x14x1280,

sym2816x14x1280, sym3072x14x1280, sym3776x14x1280,

sym5632x14x1280,

sym6144x14x1280, sym7552x14x1280, sym7680x14x1280,

sym11264x14x1280,

sym15104x14x1280, sym15360x14x1280, sym22528x14x1280,

sym30208x14x1280,

sym45056x14x1280, sym60416x14x1280, sym90112x14x1280,

sym180224x14x1280,

sym4x12x1280, sym8x12x1280, sym16x12x1280,

sym32x12x1280, sym192x12x1280,

sym384x12x1280, sym960x12x1280, sym1888x12x1280,

sym3776x12x1280,

sym5632x12x1280, sym11264x12x1280, spare13, spare12,

spare11, spare10, spare9,

spare8, spare7, spare6, spare5, spare4, spare3,

spare2, spare1

}

OPTIONAL, -- Cond CG-SDT1

| | |
|---|---|
| timeReferenceHyperSFN-r18 | INTEGER (0..1023) |

OPTIONAL, -- Cond CG-SDT2

| | |
|---|---|
| cg-RRC-Configuration-r18 | CG-RRC-Configuration-r18 |

OPTIONAL, -- Cond RACH-LessHO

| | |
|---|---|
| applyIndicatedTCI-State-r18 | ENUMERATED { first, second, both, spare1} |

```
OPTIONAL -- Need R
    ]]
  }
OPTIONAL, -- Need R
  ...,
  [[
```

| | |
|---|---|
| cg-RetransmissionTimer-r16 | INTEGER (1..64) |

OPTIONAL, -- Need R

| | |
|---|---|
| cg-minDFI-Delay-r16 | ENUMERATED |
| | {sym7, sym1x14, sym2x14, sym3x14, sym4x14, |

sym5x14, sym6x14, sym7x14, sym8x14,

sym9x14, sym10x14, sym11x14, sym12x14, sym13x14,

sym14x14, sym15x14, sym16x14

}

OPTIONAL, -- Need R

| | |
|---|---|
| cg-nrofPUSCH-InSlot-r16 | INTEGER (1..7) |

OPTIONAL, -- Need R

| | |
|---|---|
| cg-nrofSlots-r16 | INTEGER (1..40) |

OPTIONAL, -- Need R

| | |
|---|---|
| cg-StartingOffsets-r16 | CG-StartingOffsets-r16 |

OPTIONAL, -- Need R

| | |
|---|---|
| cg-UCI-Multiplexing-r16 | ENUMERATED {enabled} |

OPTIONAL, -- Need R

| | |
|---|---|
| cg-COT-SharingOffset-r16 | INTEGER (1..39) |

OPTIONAL, -- Need R

| | |
|---|---|
| betaOffsetCG-UCI-r16 | INTEGER (0..31) |

OPTIONAL, -- Need R

| | |
|---|---|
| cg-COT-SharingList-r16 | SEQUENCE (SIZE (1..1709)) OF CG-COT-Sharing-r16 |

OPTIONAL, -- Need R

| | |
|---|---|
| harq-ProcID-Offset-r16 | INTEGER (0..15) |

OPTIONAL, -- Need M

| | |
|---|---|
| harq-ProcID-Offset2-r16 | INTEGER (0..15) |

OPTIONAL, -- Need M

| | |
|---|---|
| configuredGrantConfigIndex-r16 | ConfiguredGrantConfigIndex-r16 |

OPTIONAL, -- Cond CG-List

| | |
|---|---|
| configuredGrantConfigIndexMAC-r16 | ConfiguredGrantConfigIndexMAC-r16 |

OPTIONAL, -- Cond CG-IndexMAC

| | |
|---|---|
| periodicityExt-r16 | INTEGER (1..5120) |

OPTIONAL, -- Need R

| | |
|---|---|
| startingFromRV0-r16 | ENUMERATED {on, off} |

OPTIONAL, -- Need R

| | |
|---|---|
| phy-PriorityIndex-r16 | ENUMERATED {p0, p1} |

OPTIONAL, -- Need R

| | |
|---|---|
| autonomousTx-r16 | ENUMERATED {enabled} OPTIONAL |

```
-- Cond LCH-BasedPrioritization
  ]],
  [[
```

| | |
|---|---|
| cg-betaOffsetsCrossPri0-r17 | SetupRelease { BetaOffsetsCrossPriSelCG-r17 } |

OPTIONAL, -- Need M

| | |
|---|---|
| cg-betaOffsetsCrossPri1-r17 | SetupRelease { BetaOffsetsCrossPriSelCG-r17 } |

OPTIONAL, -- Need M

| | |
|---|---|
| mappingPattern-r17 | ENUMERATED {cyclicMapping, sequentialMapping} |

OPTIONAL, -- Cond SRSsets

| | |
|---|---|
| sequenceOffsetForRV-r17 | INTEGER (0..3) |

OPTIONAL, -- Need R

| | |
|---|---|
| p0-PUSCH-Alpha2-r17 | P0-PUSCH-AlphaSetId |

OPTIONAL, -- Need R

| | |
|---|---|
| powerControlLoopToUse2-r17 | ENUMERATED {n0, n1} |

OPTIONAL, -- Need R

| | |
|---|---|
| cg-COT-SharingList-r17 | SEQUENCE (SIZE (1..50722)) OF CG-COT-Sharing-r17 |

OPTIONAL, -- Need R

| | |
|---|---|
| periodicityExt-r17 | INTEGER (1..40960) |

OPTIONAL, -- Need R

| | |
|---|---|
| repK-v1710 | ENUMERATED {n12, n16, n24, n32} |

OPTIONAL, -- Need R

| | |
|---|---|
| nrofHARQ-Processes-v1700 | INTEGER(17..32) |

OPTIONAL, -- Need M

| | |
|---|---|
| harq-ProcID-Offset2-v1700 | INTEGER (16..31) |

OPTIONAL, -- Need R

| | |
|---|---|
| configuredGrantTimer-v1700 | INTEGER(33..288) |

OPTIONAL, -- Need R

| | |
|---|---|
| cg-minDFI-Delay-v1710 | INTEGER (238..3584) |

```
OPTIONAL -- Need R
  ]],
  [[
```

| | |
|---|---|
| harq-ProcID-Offset-v1730 | INTEGER (16..31) |

OPTIONAL, -- Need R

| | |
|---|---|
| cg-nrofSlots-r17 | INTEGER (1..320) |

```
OPTIONAL -- Need R
  ]],
  [[
  disableCG-RetransmissionMonitoring-r18 ENUMERATED {true}
OPTIONAL, -- Need R
```

| | |
|---|---|
| nrofSlotsInCG-Period-r18 | INTEGER (2..32) |

OPTIONAL, -- Need R

| | |
|---|---|
| uto-UCI-Config-r18 | SEQUENCE { |
| nrofBitsInUTO-UCI-r18 | INTEGER (3..8), |
| betaOffsetUTO-UCI-r18 | INTEGER (0..31), |

```
      ...
  }
OPTIONAL -- Need R
  ]]
}
CG-UCI-OnPUSCH ::= CHOICE {
```

| | |
|---|---|
| dynamic | SEQUENCE (SIZE (1..4)) OF BetaOffsets, |
| semiStatic | BetaOffsets |

```
}
BetaOffsetsCrossPriSelCG-r17 ::= CHOICE {
  dynamic-r17 SEQUENCE (SIZE (1..4)) OF BetaOffsetsCrossPri-r17,
  semiStatic-r17 BetaOffsetsCrossPri-r17
}
-- TAG-CONFIGUREDGRANTCONFIG-STOP
-- ASN1STOP
```

ConfiguredGrantConfig field descriptions

antennaPort
Indicates the antenna port(s) to be used for this configuration, and the maximum bitwidth is 5. See TS 38.214 [19],
clause 6.1.2, and TS 38.212 [17], clause 7.3.1. The UE ignores this field in case of CG-SDT or if cg-RRC-Configuration
is configured.
applyIndicatedTCI-State
This field indicates, for PUSCH transmission(s) corresponding a Type1-CG configuration, if UE applies the first, the
second or both “indicated” UL only TCI or joint TCI as specified in TS 38.214 [19], clause 6.1. Network does not
configure this field if cg-RRC-Configuration is configured.
autonomousTx
If this field is present, the Configured Grant configuration is configured with autonomous transmission, see TS 38.321
[3].
betaOffsetCG-UCI
Beta offset for CG-UCI in CG-PUSCH, see TS 38.213 [13], clause 9.3
betaOffsetUTO-UCI
Beta offset value for UTO-UCI multiplexing on CG PUSCH, see TS 38.213 [13], clause 9.3.
cg-DMRS-Configuration
DMRS configuration (see TS 38.214 [19], clause 6.1.2.3).
cg-nrofPUSCH-InSlot
Indicates the number of consecutive PUSCH configured to CG within a slot where the SLIV indicating the first PUSCH
and additional PUSCH appended with the same length (see TS 38.214 [19], clause 6.1.2.3). The network can only
configure this field if cg-RetransmissionTimer is configured.
cg-nrofSlots
Indicates the number of allocated slots in a configured grant periodicity following the time instance of configured grant
offset (see TS 38.214 [19], clause 6.1.2.3). cg-nrofSlots-r17 is only applicable for operation with shared spectrum
channel access in FR2-2. When cg-nrofSlots-r17 is configured, the UE shall ignore cg-nrofSlots-r16. The network can
only configure this field if cg-Retransmission Timer is configured.
cg-StartingOffsets
This field is not applicable for a UE which is allowed to operate as an initiating device in semi-static channel access
mode, i.e., not applicable for a UE configured with UE FFP parameters (e.g. period, offset) regardless whether the UE
would initiate its own COT or would share gNB's COT.
cg-UCI-Multiplexing
If present, this field indicates that in the case of PUCCH overlapping with CG-PUSCH(s) including CG-UCI within a
PUCCH group, HARQ-ACK is multiplexed on the CG-PUSCH including CG-UCI (see TS 38.213 [13], clause 9).
configuredGrantConfigIndex
Indicates the index of the Configured Grant configurations within the BWP.
configuredGrantConfigIndexMAC
Indicates the index of the Configured Grant configurations within the MAC entity.
configuredGrantTimer
Indicates the initial value of the configured grant timer (see TS 38.321 [3]) in multiples of periodicity. When cg-
RetransmissonTimer is configured, if HARQ processes are shared among different configured grants on the same
BWP, configuredGrantTimer * periodicity is set to the same value for the configurations that share HARQ processes on
this BWP. The value of the extension configuredGrantTimer is 2 times the configured value.
dmrs-SeqInitialization
The network configures this field if transformPrecoder is disabled or when the value of sdt-NrofDMRS-Sequences is set
to 1. Otherwise, the field is absent.
frequencyDomainAllocation
Indicates the frequency domain resource allocation, see TS 38.214 [19], clause 6.1.2, and TS 38.212 [17], clause
7.3.1).
frequencyHopping
The value intraSlot enables ‘Intra-slot frequency hopping’ and the value interSlot enables ‘Inter-slot frequency hopping’.
If the field is absent, frequency hopping is not configured. The field frequencyHopping applies to configured grant for
‘pusch-RepTypeA’ (see TS 38.214 [19], clause 6.3.1).
frequencyHoppingOffset
Frequency hopping offset used when frequency hopping is enabled (see TS 38.214 [19], clause 6.1.2 and clause 6.3).
harq-ProcID-Offset
For operation with shared spectrum channel access configured with cg-RetransmissionTimer-r16, this configures the
range of HARQ process IDs which can be used for this configured grant where the UE can select a HARQ process ID
within [harq-procID-offset, . . ., (harq-procID-offset + nrofHARQ-Processes − 1)]. harq-ProcID-Offset-v1730 is only
applicable for operation with shared spectrum channel access in FR2-2. If the field harq-ProcID-Offset-v1730 is present,
the UE shall ignore the harq-ProcID-Offset-r16. The network does not configure this field for CG-SDT.
harq-ProcID-Offset2
Indicates the offset used in deriving the HARQ process IDs, see TS 38.321 [3], clause 5.4.1. This field is not configured
together with cg-Retransmission Timer-r16. If the field harq-ProcID-Offset2-v1700 is present, the UE shall ignore the
harq-ProcID-Offset2-r16.
nrofHARQ-Processes
The number of HARQ processes configured. It applies for both Type 1 and Type 2. See TS 38.321 [3], clause 5.4.1. If
the UE is configured with nrofHARQ-Processes-v1700, the UE shall ignore nrofHARQ-Processes (without suffix). The
network sets the value of this field to 1 when cg-LTM-Configuration is configured.
nrofSlotsInCG-Period
Number of consecutive slots for CG PUSCH transmission occasions in a period of a single CG PUSCH configuration,
see TS 38.214 [19], clause 6.1. The network does not configure this field for operation on shared spectrum.
pathlossReferenceIndex
Indicates the reference signal index used as PUSCH pathloss reference (see TS 38.213 [13], clause 7.1.1). In case of
CG-SDT or if cg-RRC-Configuration is configured, the UE does not use this field.
pathlossReferenceIndex2
Indicates the reference signal used as PUSCH pathloss reference for the second SRS resource set. When this field is
present, pathlossReferenceIndex indicates the reference signal used as PUSCH pathloss reference for the first SRS
resource set. Network does not configure this field if cg-RRC-Configuration is configured.
p0-PUSCH-Alpha
Index of the P0-PUSCH-AlphaSet to be used for this configuration.
p0-PUSCH-Alpha2
Index of the P0-PUSCH-AlphaSet to be used for second SRS resource set. If this field is present, the p0-PUSCH-Alpha
provides index for the P0-PUSCH-AlphaSet to be used for first SRS resource set.
periodicity
Periodicity for UL transmission without UL grant for type 1 and type 2 (see TS 38.321 [3], clause 5.8.2).
The following periodicities are supported depending on the configured subcarrier spacing [symbols]:

| 15 kHz: | 2, 7, n*14, where n = {1, 2, 4, 5, 8, 10, 16, 20, 32, 40, 64, 80, 128, 160, 320, 640} |
|---|---|
| 30 kHz: | 2, 7, n*14, where n = {1, 2, 4, 5, 8, 10, 16, 20, 32, 40, 64, 80, 128, 160, 256, 320, 640, 1280} |
| 60 kHz with normal CP | 2, 7, n*14, where n = {1, 2, 4, 5, 8, 10, 16, 20, 32, 40, 64, 80, 128, 160, 256, 320, 512, 640, |
| | 1280, 2560} |
| 60 kHz with ECP: | 2, 6, n*12, where n = {1, 2, 4, 5, 8, 10, 16, 20, 32, 40, 64, 80, 128, 160, 256, 320, 512, 640, |
| | 1280, 2560} |
| 120 kHz: | 2, 7, n*14, where n = {1, 2, 4, 5, 8, 10, 16, 20, 32, 40, 64, 80, 128, 160, 256, 320, 512, 640, |
| | 1024, 1280, 2560, 5120} |
| 480 and 960 kHz: | n*14, where n = {1, 2, 4, 5, 8, 10, 16, 20, 32, 40, 64, 80, 128, 160, 256, 320, 512, 640, 1024, |
| | 1280, 2560, 5120} |

In case of SDT, the network does not configure periodicity values less than 5 ms.
resourceAllocation
Configuration of resource allocation type 0 and resource allocation type 1. For Type 1 UL data transmission without
grant, resourceAllocation should be resourceAllocationType0 or resourceAllocationType1.
rrc-ConfiguredUplinkGrant
Configuration for “configured grant” transmission with fully RRC-configured UL grant (Type1). If this field is absent the
UE uses UL grant configured by DCI addressed to CS-RNTI (Type2).
srs-ResourceSetId
Indicates the associated SRS resource set for PUSCH + PUSCH simultaneous uplink transmsision for CG-type 1
PUSCH. Network does not configure this field if cg-RRC-Configuration is configured.
srs-ResourceIndicator
Indicates the SRS resource to be used. The network does not configure this for CG-SDT or if cg-RRC-Configuration is
configured.
srs-ResourceIndicator2
Indicates the SRS resource to be used for the second SRS resource set. When this field is present, the srs-
ResourceIndicator is used for the first SRS resource set. Network does not configure this field if cg-RRC-Configuration
is configured.
timeDomainAllocation, timeDomainAllocation-v1710
Indicates a combination of start symbol and length and PUSCH mapping type, see TS 38.214 [19], clause 6.1.2 and TS
38.212 [17], clause 7.3.1.
If the field timeDomainAllocation-v1710 is present, the UE shall ignore timeDomainAllocation field (without suffix).
timeDomainOffset
Offset related to the reference SFN indicated by timeReferenceSFN, see TS 38.321 [3], clause 5.8.2.
timeDomainOffset-r17 is only applicable to 480 kHz and 960 kHz. If timeDomainOffset-r17 is present, the UE shall
ignore timeDomainOffset (without suffix).

| Conditional Presence | Explanation |
|---|---|
| LCH-BasedPrioritization | This field is optionally present, Need R, if lch-BasedPrioritization is configured in the |
| | MAC entity. It is absent otherwise. |
| RACH-LessHO | The field is optionally present, Need N, if rach-LessHO is present in |
| | reconfigurationWithSync. It is absent otherwise. |
| RepTypeB | The field is optionally present if pusch-RepTypeIndicator is set to pusch-RepTypeB, |
| | Need S, and absent otherwise. |
| CG-List | The field is mandatory present when included in |
| | configuredGrantConfigToAddModList-r16, otherwise the field is absent. |
| CG-IndexMAC | The field is mandatory present if at least one configured grant is configured by |
| | configuredGrantConfigToAddModList-r16 in any BWP of this MAC entity, otherwise it |
| | is optionally present, need R. |
| CG-SDT1 | This field is optionally present, Need R, if cg-SDT-Configuration is configured, |
| | otherwise it is absent. |
| CG-SDT2 | This field is optionally present, Need S, if cg-SDT-PeriodicityExt is configured, |
| | otherwise it is absent. |
| LTM | The field is optionally present, Need R, in an RRCReconfiguration message within |
| | the LTM-Config IE. Otherwise, the field is absent. |
| SRSsets | This field is mandatory present when UE is configured with two SRS sets configured |
| | in either srs-ResourceSetToAddModList or srs-ResourceSetToAddModListDCI-0-2 |
| | with usage codebook or non-codebook and none of multipanelSchemeSDM or |
| | multipanelSchemeSFN or sTx-2Panel is configured. Otherwise it is absent, Need R |

NZP-CSI-RS-ResourceSet

The IE NZP-CSI-RS-ResourceSet is a set of Non-Zero-Power (NZP) CSI-RS resources (their IDs) and set-specific parameters.

### NZP-CSI-RS-ResourceSet Information Element

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS-ResourcesPerSet)) OF |

NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED { true} |

```
OPTIONAL, -- Need R
  ...,
  [[
```

| | |
|---|---|
| aperiodicTriggeringOffset-r16 | INTEGER(0..31) |

```
OPTIONAL -- Need S
  ]],
  [[
```

| | |
|---|---|
| pdc-Info-r17 | ENUMERATED {true} |

OPTIONAL, -- Need R

| | |
|---|---|
| cmrGroupingAndPairing-r17 | CMRGroupingAndPairing-r17 |

OPTIONAL, -- Need R

| | |
|---|---|
| aperiodicTriggeringOffset-r17 | INTEGER (0..124) |

OPTIONAL, -- Need S

| | |
|---|---|
| aperiodicTriggeringOffsetL2-r17 | INTEGER(0..31) |

```
OPTIONAL -- Need R
  ]],
  [[
```

| | |
|---|---|
| resourceType-r18 | ENUMERATED {periodic} |

OPTIONAL -- Cond LTM
]]
}

| | |
|---|---|
| CMRGroupingAndPairing-r17 ::= | SEQUENCE { |
| nrofResourcesGroup1-r17 | INTEGER (1..7) |
| pair1OfNZP-CSI-RS-r17 | NZP-CSI-RS-Pairing-r17 |

OPTIONAL, -- Need R

| | |
|---|---|
| pair2OfNZP-CSI-RS-r17 | NZP-CSI-RS-Pairing-r17 |

OPTIONAL -- Need R
}

| | |
|---|---|
| NZP-CSI-RS-Pairing-r17 ::= | SEQUENCE { |
| nzp-CSI-RS-ResourceId1-r17 | INTEGER (1..7), |
| nzp-CSI-RS-ResourceId2-r17 | INTEGER (1..7) |

}
-- TAG-NZP-CSI-RS-RESOURCESET-STOP
-- ASN1STOP

NZP-CSI-RS-ResourceSet field descriptions

aperiodicTriggeringOffset, aperiodicTriggeringOffset-r16, aperiodicTriggeringOffset-r17
Offset X between the slot containing the DCI that triggers a set of aperiodic NZP CSI-RS resources and the slot in
which the CSI-RS resource set is transmitted. For aperiodic TriggeringOffset, the value 0 corresponds to 0 slots, value 1
corresponds to 1 slot, value 2 corresponds to 2 slots, value 3 corresponds to 3 slots, value 4 corresponds to 4 slots,
value 5 corresponds to 16 slots, value 6 corresponds to 24 slots. For aperiodicTriggeringOffset-r16 and
aperiodicTriggeringOffset-r17, the value indicates the number of slots. aperiodicTriggeringOffset-r17 is applicable to
SCS 480 kHz and 960 kHz, and only the values of integer multiples of 4 are valid, i.e. 0, 4, 8, and so on. The network
configures only one of the fields. When neither field is included, the UE applies the value 0. This field is not present in
case NZP-CSI-RS-ResourcesSet is received as part of an LTM-Candidate IE.
aperiodicTriggeringOffsetL2
Indicates triggering offset of aperiodic NZP CSI-RS resources used for fast activation of the SCell (see clause 5.2.1.5.3
of TS 38.214 [19]), when the NZP CSI-RS resources are activated by the MAC CE (see clause 5.9 of TS 38.321 [3]).
The value indicates the number of slots. This field is not present in case NZP-CSI-RS-ResourcesSet is received as part
of an LTM-Candidate IE.
pair1OfNZP-CSI-RS, pair2OfNZP-CSI-RS
A pair of NZP CSI-RS resources. In one pair, one resource shall belong to group 1 and the other resource shall belong
to group 2 (see TS 38.214 [19], clause 5.2.1.4.1).
nzp-CSI-RS-Resources
NZP-CSI-RS-Resources associated with this NZP-CSI-RS resource set (see TS 38.214 [19], clause 5.2). For CSI, there
are at most 8 NZP CSI RS resources per resource set. If the NZP-CSI-RS-ResourceSet is indicated in a CSI-
ResourceConfig indicated by resourcesForChannelMeasurement in a CSI-ReportConfig, if the codebookType in the
codebookConfig in the CSI-ReportConfig is typeII-Doppler-r18 or typeII-DopplerPortSelection-r18, there are at most 1
periodic or semi-persistent NZP CSI-RS resource and 4, 8 or 12 aperiodic NZP CSI-RS resources and if the
codebookType is typeII-CJT-r18 or typeII-CJT-PortSelection-r18, there are 1, 2, 3, or 4 aperiodic, periodic or semi-
persistent NZP-CSI-RS resources, see TS 38.214 5.2.1.4.
nzp-CSI-RS-ResourceId1, nzp-CSI-RS-ResourceId2
The nzp-CSI-RS-ResourceId1-r17 represents the index of the NZP CSI-RS resource in Resource Group 1, and nzp-
CSI-RS-ResourceId2-r17 represents the index of the NZP CSI-RS resource in Resource Group 2.
repetition
Indicates whether repetition is on/off. If the field is set to off or if the field is absent, the UE may not assume that the
NZP-CSI-RS resources within the resource set are transmitted with the same downlink spatial domain transmission filter
(see TS 38.214 [19], clauses 5.2.2.3.1 and 5.1.6.1.2). It can only be configured for CSI-RS resource sets which are
associated with CSI-ReportConfig with report of L1 RSRP, L1 SINR or “no report”. This field is not present in case NZP-
CSI-RS-ResourcesSet is received as part of an LTM-Candidate IE.
resourceType
Time domain behavior of resource configuration (see TS 38.214 [19], clause 5.2.1.2).
trs-Info
Indicates that the antenna port for all NZP-CSI-RS resources in the CSI-RS resource set is same. If the field is absent
or released the UE applies the value false (see TS 38.214 [19], clause 5.2.2.3.1).

| Conditional Presence | Explanation |
|---|---|
| LTM | The field is optionally present, Need R, in an LTM-Candidate IE. Otherwise, the field |
| | is absent. |

NZP-CSI-RS-Resource

The IE NZP-CSI-RS-Resource is used to configure Non-Zero-Power (NZP) CSI-RS transmitted in the cell where the IE is included, which the UE may be configured to measure on (see TS 38.214 [19], clause 5.2.2.3.1). A change of configuration between periodic, semi-persistent or aperiodic for an NZP-CSI-RS-Resource is not supported without a release and add.

### NZP-CSI-RS-Resource Information Element

-- ASN1START
-- TAG-NZP-CSI-RS-RESOURCE-START

| NZP-CSI-RS-Resource ::= | SEQUENCE { | |
|---|---|---|
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED{db−3, db0, db3, db6} | OPTIONAL, - |

- Need R

| scramblingID | ScramblingId, | |
|---|---|---|
| periodicityAndOffset | CSI-ResourcePeriodicityAndOffset | OPTIONAL, - |

- Cond PeriodicOrSemiPersistent

| | | |
|---|---|---|
| qcl-InfoPeriodicCSI-RS | TCI-StateId | OPTIONAL, - |

```
- Cond Periodic
  ...,
  [[
```

| | | |
|---|---|---|
| subcarrierSpacing-r18 | SubcarrierSpacing | OPTIONAL, - |

- Cond LTM

| | | |
|---|---|---|
| absoluteFrequencyPointA-r18 | ARFCN-ValueNR | OPTIONAL, - |

- Cond LTM

| | | |
|---|---|---|
| cyclicPrefix-r18 | ENUMERATED {extended} | OPTIONAL - |

- Cond LTM
]]
}
-- TAG-NZP-CSI-RS-RESOURCE-STOP
-- ASN1STOP

NZP-CSI-RS-Resource field descriptions

periodicityAndOffset
Periodicity and slot offset sl1 corresponds to a periodicity of 1 slot, sl2 to a periodicity of two slots, and so on. The
corresponding offset is also given in number of slots (see TS 38.214 [19], clause 5.2.2.3.1). Network always configures
the UE with a value for this field for periodic and semi-persistent NZP-CSI-RS-Resource (as indicated in CSI-
ResourceConfig).
powerControlOffset
Power offset of PDSCH EPRE to NZP CSI-RS EPRE. Value in dB (see TS 38.214 [19], clauses 5.2.2.3.1 and 4.1). The
UE shall ignore this field in case NZP-CSI-RS-Resources is received as part of an LTM-Candidate IE.
powerControlOffsetSS
Power offset of NZP CSI-RS EPRE to SS/PBCH block EPRE. Value in dB (see TS 38.214 [19], clause 5.2.2.3.1).
qcl-InfoPeriodicCSI-RS
For a target periodic CSI-RS, contains a reference to one TCI-State in TCI-States for providing the QCL source and
QCL type. For periodic CSI-RS, the source can be SSB or another periodic-CSI-RS. Refers to the TCI-State or dl-
OrJoint-TCI-State which has this value for tci-StateId and is defined in tci-States ToAddModList or in dl-OrJointTCI-
StateList in the PDSCH-Config included in the BWP-Downlink corresponding to the serving cell and to the DL BWP to
which the resource belongs to (see TS 38.214 [19], clause 5.2.2.3.1). In case NZP-CSI-RS-Resources is received as
part of an LTM-Candidate IE, it refers to the TCI state identifier in Candidate TCI-State and is defined in ltm-DL-
OrJointTCI-State ToAddModList within the LTM-Candidate IE.
resourceMapping
OFDM symbol location(s) in a slot and subcarrier occupancy in a PRB of the CSI-RS resource.
scramblingID
Scrambling ID (see TS 38.214 [19], clause 5.2.2.3.1).

| Conditional Presence | Explanation |
|---|---|
| LTM | The field is optionally present in an LTM-Candidate IE. Otherwise, the field is absent. |
| Periodic | The field is optionally present, Need M, for periodic NZP-CSI-RS-Resources (as |
| | indicated in CSI-ResourceConfig). The field is absent otherwise. |
| PeriodicOrSemiPersistent | The field is optionally present, Need M, for periodic and semi-persistent NZP-CSI- |
| | RS-Resources (as indicated in CSI-ResourceConfig). The field is absent otherwise. |

TCI-State

The IE TCI-State associates one or two DL reference signals with a corresponding quasi-colocation (QCL) type.

### TCI-State Information Element

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

```
OPTIONAL, -- Need R
  ...,
  [[
```

| | |
|---|---|
| additionalPCI-r17 | AdditionalPCIIndex-r17 |

OPTIONAL, -- Need R

| | |
|---|---|
| pathlossReferenceRS-Id-r17 | PathlossReferenceRS-Id-r17 |

OPTIONAL, -- Cond JointTCI1

| | |
|---|---|
| ul-powerControl-r17 | Uplink-powerControlId-r17 |

```
OPTIONAL -- Cond JointTCI
  ]],
  [[
```

| | |
|---|---|
| tag-Id-ptr-r18 | ENUMERATED {n0,n1} |

OPTIONAL -- Cond 2TA
]]
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, |
| | typeC, typeD}, |

...
}
-- TAG-TCI-STATE-STOP
-- ASN1STOP

QCL-Info field descriptions

bwp-Id
The DL BWP which the RS is located in. If the field is absent, the RS is located in the DL BWP in which the TCI-State is
applied by the UE.
cell
The UE's serving cell in which the referenceSignal is configured. If the field is absent, the referenceSignal is configured
in the serving cell in which the TCI-State is applied by the UE. The RS can be located on a serving cell other than the
serving cell for which the TCI-State is applied by the UE only if the qcl-Type is configured as typeC or typeD. If the
referenceSignal is set to csi-rs and unifiedTCI-StateType is configured, either both cell and bwp-Id are present or both
cell and bwp-Id are absent. See TS 38.214 [19] clause 5.1.5.
referenceSignal
Reference signal with which quasi-collocation information is provided as specified in TS 38.214 [19] clause 5.1.5.
qcl-Type
QCL type as specified in TS 38.214 [19] clause 5.1.5.

TCI-State field descriptions

additionalPCI
Indicates the physical cell IDs (PCI) of the SSBs when referenceSignal is configured as SSB for both QCL-Type1 and
QCL-Type2. In case the cell is present, the additionalPCI refers to a PCI value configured in the list configured using
additionalPCI-ToAddModList in the serving cell indicated by the field cell. Otherwise, it refers to a PCI value configured
in a list additionalPCI-ToAddModList configured in the serving cell where the TCI-State is applied by the UE. When this
field is present the cell for qcl-Type1 and qcl-Type2 is configured with same value, if present.
pathlossReferenceRS-Id
The ID of the reference signal (e.g. a CSI-RS or an SS block) used for PUSCH, PUCCH and SRS path loss estimation.
This field refers to an element in the list configured using pathlossReferenceRSToAddModList in the serving cell and UL
BWP where the TCI State is applied by the UE.
qcl-Type1, qcl-Type2
QCL information for the TCI state as specified in TS 38.214 [19] clause 5.1.5.
tag-Id-ptr
It indicates the TAG that is associated with this TCI state, value n0 means the TCI state associate with the TAG
indicated by tag-Id, value n1 means this TCI state associated with the TAG indicated by tag2-Id. The tag-Id-ptr refers to
the TAG of the serving cell where the TCI state is applied.
tci-StateId
ID number of the TCI state.
ul-PowerControl
Configures power control parameters for PUCCH, PUSCH and SRS for this TCI state. The field is present here only if
ul-powerControl is not configured in any BWP-Uplink-Dedicated of this serving cell. This field refers to an element in the
list configured using uplink-PowerControlToAddModList in the serving cell where the dl-OrJointTCI-StateToAddModList
is configured.

| Conditional Presence | Explanation |
|---|---|
| 2TA | This field is mandatory present if tag2 is present for the serving cell and the serving |
| | cell is configured with unifiedTCI-StateType set to joint. It is absent, Need R, |
| | otherwise. |
| CSI-RS-Indicated | This field is mandatory present if csi-rs is included and unifiedTCI-StateType is not |
| | configured. This field is optionally present, Need R, if csi-rs is included and |
| | unifiedTCI-StateType is configured. Otherwise, it is absent, Need R. |
| JointTCI | This field is optionally present, Need R, if this serving cell is configured with |
| | unifiedTCI-StateType set to ‘joint’. It is absent, Need R, otherwise. |
| JointTCI1 | This field is mandatory present, if this serving cell is configured with unifiedTCI- |
| | StateType set to ‘joint’. It is absent, Need R, otherwise. |

TCI-UL-State

The IE TCI-UL-State indicates the TCI state information for UL transmission.

### TCI-UL-State Information Element

-- ASN1START
-- TAG-TCI-UL-STATE-START

| TCI-UL-State-r17 ::= | SEQUENCE { | |
|---|---|---|
| tci-UL-StateId-r17 | TCI-UL-StateId-r17, | |
| servingCellId-r17 | ServCellIndex | OPTIONAL, |

-- Need R

| | | |
|---|---|---|
| bwp-Id-r17 | BWP-Id | OPTIONAL, |

-- Cond CSI-RSorSRS-Indicated

| | |
|---|---|
| referenceSignal-r17 | CHOICE { |
| ssb-Index-r17 | SSB-Index, |
| csi-RS-Index-r17 | NZP-CSI-RS-ResourceId, |
| srs-r17 | SRS-ResourceId |

},

| | | |
|---|---|---|
| additionalPCI-r17 | AdditionalPCIIndex-r17 | OPTIONAL, |

-- Need R

| | | |
|---|---|---|
| ul-powerControl-r17 | Uplink-powerControlId-r17 | OPTIONAL, |

-- Need R

| | | |
|---|---|---|
| pathlossReferenceRS-Id-r17 | PathlossReferenceRS-Id-r17 | OPTIONAL, |

```
-- Cond Mandatory
  ...,
  [[
```

| | | |
|---|---|---|
| tag-Id-ptr-r18 | ENUMERATED {n0,n1} | OPTIONAL |

-- Cond 2TA
]]
}
-- TAG-TCI-UL-STATE-STOP
-- ASN1STOP

TCI-UL-State field descriptions

additionalPCI
Indicates the physical cell IDs (PCI) of the SSBs when referenceSignal is configured as SSB. In case the servingCellId
is present, the additionalPCI refers to a PCI value configured in the list configured using additionalPCI-ToAddModList in
the serving cell indicated by the field servingCellId. Otherwise, it refers to a PCI value configured in the list configured
using additionalPCI-ToAddModList in the serving cell where the ul-TCI-StateList is applied by the UE.
bwp-Id
The DL BWP which the CSI-RS is located in or UL BWP where the SRS is located in.
servingCellId
The UE's serving cell in which the referenceSignal is configured. If the field is absent, the referenceSignal is configured
in the serving cell in which the TCI-UL-State is applied by the UE.
pathlossReferenceRS-Id
The ID of the reference Signal (e.g. a CSI-RS or a SS block) used for PUSCH, PUCCH and SRS path loss estimation.
This field refers to an element in the list configured using pathlossReferenceRSToAddModList in the serving cell and UL
BWP where the UL TCI State is applied by the UE.
tag-Id-ptr
It indicates the TAG that is associated with this TCI state, value n0 means the TCI state associate with the TAG
indicated by tag-Id, value n1 means this TCI state associated with the TAG indicated by tag2-Id. The tag-Id-ptr refers to
the TAG of the serving cell where the TCI state is applied.
ul-powerControl
Configures power control parameters for PUCCH, PUSCH and SRS for this TCI state. The field is present here only if
ul-powerControl is not configured in any BWP-Uplink-Dedicated of this serving cell. This field refers to an element in the
list configured using uplink-PowerControlToAddModList in the serving cell where the ul-TCI-ToAddModList is
configured.

| Conditional Presence | Explanation |
|---|---|
| 2TA | This field is mandatory present if tag2 is present for the serving cell. It is absent, |
| | Need R, otherwise. |
| CSI-RSorSRS-Indicated | This field is mandatory present if referenceSignal is set to csi-RS-index or to srs, |
| | absent otherwise |
| Mandatory | The field is mandatory present. |

In [5] 3GPP TS 38.321 i00, relevant MAC CE and procedures are quoted below:

### 6.1.3.47 Unified TCI States Activation/Deactivation MAC CE

The Unified TCI States Activation/Deactivation MAC CE is identified by a MAC subheader with eLCID as specified in Table 6.2.1-1b. It has a variable size consisting of following fields:
Serving Cell ID: This field indicates the identity of the Serving Cell for which the MAC CE applies. The length of the field is 5 bits. If the indicated Serving Cell is configured as part of a simultaneousU-TCI-UpdateList1, simultaneousU-TCI-UpdateList2, simultaneousU-TCI-UpdateList3 or simultaneousU-TCI-UpdateList4 as specified in TS 38.331 [5], this MAC CE applies to all theServing Cells in the set simultaneousU-TCI-UpdateList1, simultaneousU-TCI-UpdateList2, simultaneousU-TCI-UpdateList3 or simultaneousU-TCI-UpdateList4, respectively;
DL BWP ID: This field indicates a DL BWP for which the MAC CE applies as the codepoint of the DCI bandwidth part indicator field as specified in TS 38.212 [9]. The length of the BWP ID field is 2 bits;
UL BWP ID: This field indicates a UL BWP for which the MAC CE applies as the codepoint of the DCI bandwidth part indicator field as specified in TS 38.212 [9]. If value of unifiedTCI-StateType in the Serving Cell indicated by Serving Cell ID is joint, this field is considered as the reserved bits. The length of the BWP ID field is 2 bits;
Pᵢ: This field indicates whether each TCI codepoint has multiple TCI states or single TCI state. If Pᵢ field is set to 1, it indicates that i^{th} TCI codepoint includes the DL TCI state and the UL TCI state. If Pᵢ field is set to 0, it indicates that i^{th} TCI codepoint includes only the DL/joint TCI state or the UL TCI state. The codepoint to which a TCI state is mapped is determined by its ordinal position among all the TCI state ID fields;
D/U: This field indicate whether the TCI state ID in the same octet is for joint/downlink or uplink TCI state. If this field is set to 1, the TCI state ID in the same octet is for joint/downlink. If this field is set to 0, the TCI state ID in the same octet is for uplink;
TCI state ID: This field indicates the TCI state identified by TCI-StateId as specified in TS 38.331 [5]. If D/U is set to 1, 7-bits length TCI state ID i.e. TCI-StateId as specified in TS 38.331 [5] is used. If D/U is set to 0, the most significant bit of TCI state ID is considered as the reserved bit and remainder 6 bits indicate the TCI-UL-State-Id as specified in TS 38.331 [5]. The maximum number of activated TCI states is 16;
R: Reserved bit, set to 0.

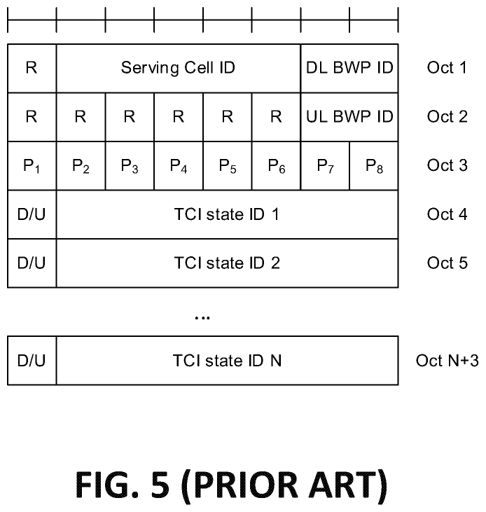

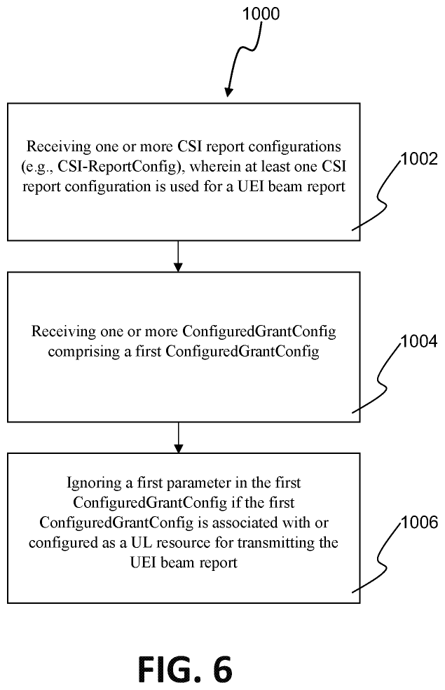

FIG. 5 is a reproduction of FIG. 6.1.3.47-1: Unified TCI state activation/deactivation MAC CE, from 3GPP TS 38.321 i00.

### 5.4.1 UL Grant Reception

Uplink grant is either received dynamically on the PDCCH, in a Random Access Response, configured semi-persistently by RRC or determined to be associated with the PUSCH resource of MSGA as specified in clause 5.1.2a. The MAC entity shall have an uplink grant to transmit on the UL-SCH. To perform the requested transmissions, the MAC layer receives HARQ information from lower layers. An uplink grant addressed to CS-RNTI with NDI=0 is considered as a configured uplink grant. An uplink grant addressed to CS-RNTI with NDI=1 is considered as a dynamic uplink grant.

If the MAC entity has a C-RNTI, a Temporary C-RNTI, or CS-RNTI, the MAC entity shall for each PDCCH occasion and for each Serving Cell belonging to a TAG that has a running timeAlignmentTimer or a running cg-SDT-TimeAlignmentTimer and for each grant received for this PDCCH occasion:
1> if an uplink grant for this Serving Cell has been received on the PDCCH for the MAC entity's C-RNTI or Temporary C-RNTI; or
1> if an uplink grant has been received in a Random Access Response:
   2> if the uplink grant is for MAC entity's C-RNTI and if the previous uplink grant delivered to the HARQ entity for the same HARQ process was either an uplink grant received for the MAC entity's CS-RNTI or a configured uplink grant:
      3> consider the NDI to have been toggled for the corresponding HARQ process regardless of the value of the NDI.
   2> if the uplink grant is for MAC entity's C-RNTI, and the identified HARQ process is configured for a configured uplink grant:
      3> start or restart the configuredGrantTimer for the corresponding HARQ process, if configured;
      3> stop the cg-RetransmissionTimer for the corresponding HARQ process, if running.
   2> stop the cg-SDT-RetransmissionTimer for the corresponding HARQ process, if running.
   2> stop the cg-RRC-RetransmissionTimer for the corresponding HARQ process, if running.
   2> if the uplink grant has been received on the PDCCH for the MAC entity's C-RNTI after the first PUSCH transmission to the Serving Cell; and
   2> if the uplink grant is for a new transmission on the same HARQ process used for the first PUSCH transmission to the Serving Cell:
      3> if there is an ongoing RACH-less handover procedure:
         4> consider the RACH-less handover to be successfully completed and indicate to upper layers.
      3> else if there is an ongoing RACH-less LTM cell switch: 4> consider the LTM cell switch to be successfully completed and indicate it to upper layers.
   2> deliver the uplink grant and the associated HARQ information to the HARQ entity.
1> else if an uplink grant for this PDCCH occasion has been received for this Serving Cell on the PDCCH for the MAC entity's CS-RNTI:
   2> if the NDI in the received HARQ information is 1:
      3> consider the NDI for the corresponding HARQ process not to have been toggled;
      3> start or restart the configuredGrantTimer for the corresponding HARQ process, if configured;
      3> stop the cg-RetransmissionTimer for the corresponding HARQ process, if running;
      3> stop the cg-SDT-RetransmissionTimer for the corresponding HARQ process, if running;
      3> stop the cg-RRC-RetransmissionTimer for the corresponding HARQ process, if running;
      3> deliver the uplink grant and the associated HARQ information to the HARQ entity;
      3> if a logical channel associated with a DRB configured with survivalTimeStateSupport is multiplexed in the MAC PDU stored in the HARQ buffer for the corresponding HARQ process:
         4> trigger activation of PDCP duplication for all configured RLC entities of the DRB.
   2> else if the NDI in the received HARQ information is 0:
      3> if PDCCH contents indicate configured grant Type 2 deactivation:
         4> trigger configured uplink grant confirmation.
      3> else if PDCCH contents indicate configured grant Type 2 activation:
         4> trigger configured uplink grant confirmation;
         4> store the uplink grant for this Serving Cell and the associated HARQ information as configured uplink grant;
         4> initialise or re-initialise the configured uplink grant for this Serving Cell to start in the associated PUSCH duration and to recur according to rules in clause 5.8.2;
         4> stop the configuredGrantTimer for the corresponding HARQ process, if running;
         4> stop the cg-RetransmissionTimer for the corresponding HARQ process, if running.

For each Serving Cell and each configured uplink grant, if configured and activated and available for use as specified in clause 5.8.2, the MAC entity shall:
1> if the MAC entity is configured with Ich-basedPrioritization, and the PUSCH duration of the configured uplink grant does not overlap with the PUSCH duration of an uplink grant received in a Random Access Response or with the PUSCH duration of an uplink grant addressed to Temporary C-RNTI or the PUSCH duration of a MSGA payload for this Serving Cell; or
1> if the MAC entity is not configured with Ich-basedPrioritization, and the PUSCH duration of the configured uplink grant does not overlap with the PUSCH duration of an uplink grant received on the PDCCH or in a Random Access Response or the PUSCH duration of a MSGA payload for this Serving Cell:
   2> set the HARQ Process ID to the HARQ Process ID associated with this PUSCH duration;
   2> if, for the corresponding HARQ process, the configuredGrantTimer is not running and cg-RetransmissionTimer is not configured and cg-SDT-RetransmissionTimer is not configured, and cg-RRC-RetransmissionTimer is not configured (i.e. new transmission):
      3> if the configured uplink grant is for the initial transmission for the CG-SDT with CCCH message; or
      3> if there is an ongoing CG-SDT procedure and PDCCH addressed to the MAC entity's C-RNTI has been received; or
      3> if the configured uplink grant is for the first PUSCH transmission during an ongoing RACH-less LTM cell switch; or
      3> if the configured uplink grant is for the first PUSCH transmission during an ongoing RACH-less handover procedure; or
      3> if there is no ongoing CG-SDT nor ongoing RACH-less LTM cell switch nor ongoing RACH-less handover procedure:
         4> consider the NDI bit for the corresponding HARQ process to have been toggled;
         4> deliver the configured uplink grant and the associated HARQ information to the HARQ entity.
   2> else if the cg-RetransmissionTimer for the corresponding HARQ process is configured and not running, then for the corresponding HARQ process:
      3> if the configuredGrantTimer is not running, and the HARQ process is not pending (i.e. new transmission):
         4> consider the NDI bit to have been toggled;
         4> deliver the configured uplink grant and the associated HARQ information to the HARQ entity.
      3> else if the previous uplink grant delivered to the HARQ entity for the same HARQ process was a configured uplink grant (i.e. retransmission on configured grant):
         4> deliver the configured uplink grant and the associated HARQ information to the HARQ entity.
   2> else if the cg-SDT-RetransmissionTimer is configured and not running for the corresponding HARQ process; or
   2> if the cg-RRC-RetransmissionTimer is configured and not running for the corresponding HARQ process:
      3> if the configured uplink grant is for the first PUSCH transmission at RACH-less LTM cell switch (i.e., initial new transmission); or
      3> if the configured uplink grant is for the initial transmission of RACH-less handover (i.e., initial new transmission); or
      3> if the configured uplink grant is for the initial transmission for the CG-SDT with CCCH message (i.e., initial new transmission); or
      3> if the configuredGrantTimer is not running or not configured, and PDCCH addressed to the MAC entity's C-RNTI has been received after the initial transmission of the CG-SDT with CCCH message (i.e., subsequent new transmission):
         4> consider the NDI bit to have been toggled;
         4> deliver the configured uplink grant and the associated HARQ information to the HARQ entity.
      3> if PDCCH addressed to the MAC entity's C-RNTI has not been received and if the previous uplink grant delivered to the HARQ entity for the same HARQ process was a configured uplink grant for initial transmission of CG-SDT with CCCH message or for its retransmission (i.e., retransmission for initial CG-SDT transmission); or
      3> if RACH-less handover is not successfully completed and if the previous uplink grant delivered to the HARQ entity for the same HARQ process was a configured uplink grant for initial transmission of RACH-less handover or for its retransmission (i.e., retransmission for initial RACH-less handover transmission); or
      3> if RACH-less LTM cell switch is ongoing and if the previous uplink grant delivered to the HARQ entity for the same HARQ process was a configured uplink grant for first PUSCH transmission at RACH-less LTM cell switch or for its retransmission (i.e., retransmission for initial transmission at RACH-less LTM cell switch):
         4> consider the NDI bit to have not been toggled;
         4> deliver the configured uplink grant and the associated HARQ information to the HARQ entity.

For configured uplink grants that are not part of a multi-PUSCH configured grant and neither configured with harq-ProcID-Offset2 nor with cg-RetransmissionTimer, the HARQ Process ID associated with the first symbol of a UL transmission is derived from the following equation:

HARQ Process ID=[floor(CURRENT_symbol/periodicity)]modulo nrofHARQ-Processes

For configured uplink grants that are not part of a multi-PUSCH configured grant and configured with harq-ProcID-Offset2, the HARQ Process ID associated with the first symbol of a UL transmission is derived from the following equation:

HARQ Process ID=[floor(CURRENT_symbol/periodicity)]modulo nrofHARQ-Processes+harq-ProcID-Offset2

For a multi-PUSCH configured grant (as specified in clause 5.8.2) configured with neither harq-ProcID-Offset2 nor cg-RetransmissionTimer, the HARQ Process ID associated with the first symbol of a UL transmission is derived from the following equation:

HARQ Process ID=[nrofSlotsInCG-Period×floor(CURRENT_symbol/periodicity)+ID_OFFSET]modulo nrofHARQ-Processes

For a multi-PUSCH configured grant configured with harq-ProcID-Offset2, the HARQ Process ID associated with the first symbol of a UL transmission is derived from the following equation:

HARQ Process ID=[nrofSlotsInCG-Period×floor(CURRENT_symbol/periodicity)+ID_OFFSET]modulo nrofHARQ-Processes+harq-ProcID-Offset2

where, if cg-SDT-PeriodicityExt (as defined in TS 38.331 [5]) is not configured,

CURRENT_symbol=(SFN×numberOfSlotsPerFrame×numberOfSymbolsPerSlot+slot number in the frame×numberOfSymbolsPerSlot+symbol number in the slot)

alternatively, if cg-SDT-PeriodicityExt (as defined in TS 38.331 [5]) is configured, periodicity equals to cg-SDT-PeriodicityExt, and

CURRENT_symbol=((H−SFN×numberOfSFNperH-SFN+SFN)×numberOfSlotsPerFrame×numberOfSymbolsPerSlot+slot number in the frame×numberOfSymbolsPerSlot+symbol number in the slot).
numberOfSFNperH-SFN, numberOfSlotsPerFrame and numberOfSymbolsPerSlot above refer to the number of consecutive frames per H-SFN, the number of consecutive slots per frame and the number of consecutive symbols per slot, respectively as specified in TS 38.211 [8].

For a multi-PUSCH configured grant, ID_OFFSET equals 0 for the first configured uplink grant within a periodicity of the configuration and K for the Kth (1≤K<nrofSlotsInCG-Period) valid configured uplink grant after the first configured uplink grant within the same periodicity. A configured uplink grant in a multi-PUSCH configured grant is considered valid if it satisfies the conditions specified in clause 6.1 in TS 38.214 [7].

For configured uplink grants configured with cg-RetransmissionTimer, the UE implementation selects an HARQ Process ID among the HARQ process IDs available for the configured grant configuration. If the MAC entity is configured with intraCG-Prioritization, for HARQ Process ID selection, the UE shall prioritize the HARQ Process ID with the highest priority, where the priority of HARQ process is determined by the highest priority among priorities of the logical channels that are multiplexed (i.e. the MAC PDU to transmit is already stored in the HARQ buffer) or have data available that can be multiplexed (i.e. the MAC PDU to transmit is not stored in the HARQ buffer) in the MAC PDU, according to the mapping restrictions as described in clause 5.4.3.1.2. If the MAC entity is configured with intraCG-Prioritization, for HARQ Process ID selection among initial transmission and retransmission with equal priority, the UE shall prioritize retransmissions before initial transmissions. The priority of a HARQ Process for which no data for logical channels is multiplexed or can be multiplexed in the MAC PDU is lower than the priority of a HARQ Process for which data for any logical channels is multiplexed or can be multiplexed in the MAC PDU. If the MAC entity is not configured with intraCG-Prioritization, for HARQ Process ID selection, the UE shall prioritize retransmissions before initial transmissions. The UE shall toggle the NDI in the CG-UCI for new transmissions and not toggle the NDI in the CG-UCI in retransmissions.
NOTE 1: If a configured uplink grant is associated with a multi-PUSCH configured grant, CURRENT_symbol refers to the symbol index of the first transmission occasion in the first configured uplink grant within the same periodicity. Otherwise, CURRENT_symbol refers to the symbol index of the first transmission occasion of a bundle of configured uplink grant.
NOTE 2: A HARQ process is configured for a configured uplink grant where neither harq-ProcID-Offset nor harq-ProcID-Offset2 is configured, if the configured uplink grant is activated and the associated HARQ process ID is less than nrofHARQ-Processes. A HARQ process is configured for a configured uplink grant where harq-ProcID-Offset2 is configured, if the configured uplink grant is activated and the associated HARQ process ID is greater than or equal to harq-ProcID-Offset2 and less than sum of harq-ProcID-Offset2 and nrofHARQ-Processes for the configured grant configuration.
NOTE 3: If the MAC entity receives a grant in a Random Access Response (i.e. MAC RAR or fallbackRAR), or addressed to Temporary C-RNTI or determines a grant as specified in clause 5.1.2a for MSGA payload and if the MAC entity also receives an overlapping grant for its C-RNTI or CS-RNTI, requiring concurrent transmissions on the SpCell, the MAC entity may choose to continue with either the grant for its RA-RNTI/Temporary C-RNTI/MSGB-RNTI/the MSGA payload transmission or the grant for its C-RNTI or CS-RNTI.
NOTE 4: In case of unaligned SFN across carriers in a cell group, the SFN of the concerned Serving Cell is used to calculate the HARQ Process ID used for configured uplink grants.
NOTE 5: If cg-RetransmissionTimer is not configured, a HARQ process is not shared between different configured grant configurations in the same BWP.

For the MAC entity configured with Ich-basedPrioritization, priority of an uplink grant is determined by the highest priority among priorities of the logical channels that are multiplexed (i.e. the MAC PDU to transmit is already stored in the HARQ buffer) or have data available that can be multiplexed (i.e. the MAC PDU to transmit is not stored in the HARQ buffer) in the MAC PDU, according to the mapping restrictions as described in clause 5.4.3.1.2. The priority of an uplink grant for which no data for logical channels is multiplexed or can be multiplexed in the MAC PDU is lower than either the priority of an uplink grant for which data for any logical channels is multiplexed or can be multiplexed in the MAC PDU or the priority of the logical channel triggering an SR.

For the MAC entity configured with Ich-basedPrioritization, if the corresponding PUSCH transmission of a configured uplink grant is cancelled by CI-RNTI as specified in clause 11.2A of TS 38.213 [6] or cancelled by a high PHY-priority PUCCH transmission as specified in clause 9 of TS 38.213 [6], this configured uplink grant is considered as a de-prioritized uplink grant. If this de-prioritized uplink grant is configured with autonomousTx, the configuredGrantTimer for the corresponding HARQ process of this de-prioritized uplink grant shall be stopped if it is running. If this de-prioritized uplink grant is configured with autonomousTx, the cg-RetransmissionTimer for the corresponding HARQ process of this de-prioritized uplink grant shall be stopped if it is running.

When the MAC entity is configured with Ich-basedPrioritization, for each uplink grant delivered to the HARQ entity and whose associated PUSCH can be transmitted by lower layers, the MAC entity shall:
1> if this uplink grant is received in a Random Access Response (i.e. in a MAC RAR or fallback RAR), or addressed to Temporary C-RNTI, or is determined as specified in clause 5.1.2a for the transmission of the MSGA payload:
   2> consider this uplink grant as a prioritized uplink grant.
1> else if this uplink grant is addressed to CS-RNTI with NDI=1 or C-RNTI:
   2> if there is no overlapping PUSCH duration of a configured uplink grant which was not already de-prioritized, in the same BWP, whose priority is higher than the priority of the uplink grant; and
   2> if there is no overlapping PUCCH resource with an SR transmission which was not already de-prioritized and the simultaneous transmission of the SR and the uplink grant is not allowed by configuration of simultaneousPUCCH-PUSCH or simultaneousPUCCH-PUSCH-SecondaryPUCCHgroup or simultaneousSR-PUSCH-diffPUCCH-Groups or simultaneousPUCCH-PUSCH-SamePriority or simultaneousPUCCH-PUSCH-SamePriority-SecondaryPUCCHgroup, and the priority of the logical channel that triggered the SR is higher than the priority of the uplink grant:
      3> consider this uplink grant as a prioritized uplink grant;
      3> consider the other overlapping uplink grant(s), if any, as a de-prioritized uplink grant(s);
      3> consider the other overlapping SR transmission(s), if any, as a de-prioritized SR transmission(s), except for the SR transmission(s) whose simultaneous transmission is allowed by configuration of simultaneousPUCCH-PUSCH or simultaneousPUCCH-PUSCH-SecondaryPUCCHgroup or simultaneousSR-PUSCH-diffPUCCH-Groups or simultaneousPUCCH-PUSCH-SamePriority or simultaneousPUCCH-PUSCH-SamePriority-SecondaryPUCCHgroup;
      3> if the de-prioritized uplink grant(s) is a configured uplink grant configured with autonomousTx whose PUSCH has already started:
         4> stop the configuredGrantTimer for the corresponding HARQ process of the de-prioritized uplink grant(s);
         4> stop the cg-RetransmissionTimer for the corresponding HARQ process of the de-prioritized uplink grant(s).
1> else if this uplink grant is a configured uplink grant:
   2> if there is no overlapping PUSCH duration of another configured uplink grant which was not already de-prioritized, in the same BWP, whose priority is higher than the priority of the uplink grant; and
   2> if there is no overlapping PUSCH duration of an uplink grant addressed to CS-RNTI with NDI=1 or C-RNTI which was not already de-prioritized, in the same BWP, whose priority is higher than or equal to the priority of the uplink grant; and
   2> if there is no overlapping PUCCH resource with an SR transmission which was not already de-prioritized and the simultaneous transmission of the SR and the uplink grant is not allowed by configuration of simultaneousPUCCH-PUSCH or simultaneousPUCCH-PUSCH-SecondaryPUCCHgroup or simultaneousSR-PUSCH-diffPUCCH-Groups or simultaneousPUCCH-PUSCH-SamePriority or simultaneousPUCCH-PUSCH-SamePriority-SecondaryPUCCHgroup, and the priority of the logical channel that triggered the SR is higher than the priority of the uplink grant:
      3> consider this uplink grant as a prioritized uplink grant;
      3> consider the other overlapping uplink grant(s), if any, as a de-prioritized uplink grant(s);
      3> if the de-prioritized uplink grant(s) is a configured uplink grant configured with autonomousTx whose PUSCH has already started:
         4> stop the configuredGrantTimer for the corresponding HARQ process of the de-prioritized uplink grant(s);
         4> stop the cg-RetransmissionTimer for the corresponding HARQ process of the de-prioritized uplink grant(s).
      3> consider the other overlapping SR transmission(s), if any, as a de-prioritized SR transmission(s), except for the SR transmission(s) whose simultaneous transmission is allowed by configuration of simultaneousPUCCH-PUSCH or simultaneousPUCCH-PUSCH-SecondaryPUCCHgroup or simultaneousSR-PUSCH-diffPUCCH-Groups or simultaneousPUCCH-PUSCH-SamePriority or simultaneousPUCCH-PUSCH-SamePriority-SecondaryPUCCHgroup.
NOTE 6: If the MAC entity is configured with Ich-basedPrioritization and if there is overlapping PUSCH duration of at least two configured uplink grants whose priorities are equal, the prioritized uplink grant is determined by UE implementation.
NOTE 7: If the MAC entity is not configured with Ich-basedPrioritization and if there is overlapping PUSCH duration of at least two configured uplink grants, it is up to UE implementation to choose one of the configured uplink grants.
NOTE 8: If the MAC entity is configured with Ich-basedPrioritization, the MAC entity does not take UCI multiplexing according to the procedure specified in TS 38.213 [6] into account when determining whether the PUSCH duration of an uplink grant overlaps with the PUCCH resource for an SR transmission.

### 5.8.2 Uplink

There are two types of transmission without dynamic grant:
configured grant Type 1 where an uplink grant is provided by RRC, and stored as configured uplink grant;
configured grant Type 2 where an uplink grant is provided by PDCCH, and stored or cleared as configured uplink grant based on L1 signalling indicating configured uplink grant activation or deactivation.

Type 1 and Type 2 are configured by RRC for a Serving Cell per BWP. Multiple configurations can be active simultaneously in the same BWP. For Type 2, activation and deactivation are independent among the Serving Cells. For the same BWP, the MAC entity can be configured with both Type 1 and Type 2.

A multi-PUSCH configured grant has multiple consecutive configured uplink grants within a periodicity. Both Type 1 and Type 2 can be configured for a multi-PUSCH configured grant by RRC.

Only configured grant Type 1 can be configured for CG-SDT or for RACH-less LTM cell switch or for RACH-less handover. CG-SDT can only be configured on initial BWP.

RRC configures the following parameters when the configured grant Type 1 is configured:
cs-RNTI: CS-RNTI for retransmission;
cg-SDT-CS-RNTI: CS-RNTI for CG-SDT retransmission;
cg-SDT-RSRP-ThresholdSSB: an RSRP threshold configured for SSB selection for CG-SDT;
cg-RRC-RSRP-ThresholdSSB: an RSRP threshold configured for SSB selection for RACH-less handover;
periodicity: periodicity of the configured grant Type 1;
timeDomainOffset: Offset of a resource with respect to SFN=timeReferenceSFN in time domain;
timeDomainAllocation: Allocation of configured uplink grant in time domain which contains startSymbolAndLength (i.e. SLIV in TS 38.214 [7]) or startSymbol (i.e. S in TS 38.214 [7]);
nrofHARQ-Processes: the number of HARQ processes for configured grant;
harq-ProcID-Offset: offset of HARQ process for configured grant configured with cg-RetransmissionTimer for operation with shared spectrum channel access;
harq-ProcID-Offset2: offset of HARQ process for configured grant not configured with cg-RetransmissionTimer;
timeReferenceSFN: SFN used for determination of the offset of a resource in time domain. The UE uses the closest SFN with the indicated number preceding the reception of the configured grant configuration;
timeReferenceHyperSFN: H-SFN used for determination of the offset of a resource in time domain. The UE uses the closest H-SFN with the indicated number preceding the reception of the configured grant configuration.

RRC configures the following parameters when the configured grant Type 2 is configured:
cs-RNTI: CS-RNTI for activation, deactivation, and retransmission;
periodicity: periodicity of the configured grant Type 2;
nrofHARQ-Processes: the number of HARQ processes for configured grant;
harq-ProcID-Offset: offset of HARQ process for configured grant configured with cg-RetransmissionTimer for operation with shared spectrum channel access;
harq-ProcID-Offset2: offset of HARQ process for configured grant not configured with cg-RetransmissionTimer.

RRC configures the following parameter when retransmissions on configured uplink grant is configured:
cg-RetransmissionTimer: the duration after a configured grant (re) transmission of a HARQ process when the UE shall not autonomously retransmit that HARQ process;
cg-SDT-RetransmissionTimer: the duration after a configured grant (re) transmission of a HARQ process of the initial CG-SDT transmission with CCCH message when the UE shall not autonomously retransmit the HARQ process;
cg-RRC-RetransmissionTimer: the duration after a configured grant (re) transmission of a HARQ process of the initial transmission of RACH-less handover and RACH-less LTM cell switch when the UE shall not autonomously retransmit the HARQ process.

RRC configures the following parameter when a multi-PUSCH configured grant is configured:
nrofSlotsInCG-Period: the number of configured uplink grants in a periodicity of a multi-PUSCH configured grant.

RRC configures the following parameter when UTO-UCI (as specified in clause 9.3 in TS 38.213 [6]) is configured for a configured grant:
nrofBitsInUTO-UCI: number of bits in a UTO-UCI bitmap.

For a configured uplink grant, the MAC entity shall:
1> if its associated configured grant is configured with UTO-UCI and it has not been indicated to the lower layers as unused for PUSCH transmission; or
1> if its associated configured grant is not configured with UTO-UCI:
   2> if it is associated with a multi-PUSCH configured grant and meets the validity conditions specified in the clause 6.1 in TS 38.214 [7]; or
   2> if it is not associated with a multi-PUSCH configured grant:
      3> consider it available for use.

The MAC entity shall not include the UL-SCH resource of a configured uplink grant not available for use in its procedures (e.g. in clauses 5.4.1 and 5.4.4).

For a configured grant configured with UTO-UCI, the MAC entity determines if a configured uplink grant which is within the subsequent nrofBitsInUTO-UCI valid occasions of its associated configured grant configuration is going to be used for PUSCH transmission by considering at least the amount of buffered data that can be transmitted on the available occasions of the associated configured grant and other available UL-SCH resources. Upon this determination, the MAC entity sends an indication to lower layers, for use in the procedure for reporting UTO-UCI.

Upon configuration of a configured grant Type 1 for a BWP of a Serving Cell by upper layers, the MAC entity shall:
1> store the uplink grant provided by upper layers as a configured uplink grant for the indicated BWP of the Serving Cell;
1> if cg-SDT-PeriodicityExt is configured:
   2> initialise or re-initialise the configured uplink grant to start in the symbol according to timeDomainOffset, timeReferenceHyperSFN, timeReferenceSFN, and S (derived from SLIV or provided by startSymbol as specified in TS 38.214 [7]), and to reoccur with cg-SDT-PeriodicityExt.
1> else:
   2> initialise or re-initialise the configured uplink grant to start in the symbol according to timeDomainOffset, timeReferenceSFN, and S (derived from SLIV or provided by startSymbol as specified in TS 38.214 [7]), and to reoccur with periodicity.

If cg-SDT-PeriodicityExt (as defined in TS 38.331 [5]) is not configured, after an uplink grant is configured for a configured grant Type 1, the MAC entity shall consider sequentially that the configured uplink grant, or the first configured uplink grant in a multi-PUSCH configured grant, in the Nth (N≥0) periodicity occurs in the symbol for which:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity)modulo(1024×numberOfSlotsPerFrame×numberOfSymbolsPerSlot)

If cg-SDT-PeriodicityExt (as defined in TS 38.331 [5]) is configured, after an uplink grant is configured for a configured grant Type 1, the MAC entity shall consider sequentially that the configured uplink grant in the Nth (N≥0) periodicity occurs in the symbol for which:

[(H-SFN×numberOfSFNperH-SFN+SFN)×numberOfSlotsPerFrame×numberOfSymbolsPerSlot+(slot number in the frame×numberOfSymbolsPerSlot)+symbol number in the slot]=((timeReferenceHyperSFN×numberOfSFNperH-SFN+timeReferenceSFN)×numberOfSlotsPerFrame×numberOfSymbolsPerSlot+timeDomainOffset×numberOfSymbolsPerSlot+S+N×cg-SDT-PeriodicityExt)modulo(1024×1024×numberOfSlotsPerFrame×numberOfSymbolsPerSlot)

For a multi-PUSCH configured grant Type 1, the M^{th} (1<M≤nrofSlotsInCG-Period) configured uplink grant within a periodicity occurs (M−1)× numberOfSymbolsPerSlot symbols after the symbol in which the first configured uplink grant in that periodicity occurs.

For an uplink grant configured for configured grant Type 1 for CG-SDT on the selected uplink carrier as in clause 5.27, when CG-SDT is triggered and not terminated, for each configured uplink grant valid according to TS 38.214 [7] for which the above formula is satisfied, the MAC entity shall:
1> if, after initial transmission for CG-SDT with CCCH message has been performed according to clause 5.4.1, PDCCH addressed to the MAC entity's C-RNTI has not been received:
   2> if the SSB corresponding to the configured UL grant has the same SSB index as the SSB selected for initial transmission for CG-SDT with CCCH message (i.e., retransmission of initial transmission of CG-SDT):
      3> select this SSB;
      3> indicate the SSB index corresponding to the configured uplink grant to the lower layer,
      3> consider this configured uplink grant as valid.
1> else if at least one SSB corresponding to the configured uplink grant with SS-RSRP above the cg-SDT-RSRP-ThresholdSSB is available:
   2> if this is the initial transmission of CG-SDT with CCCH message after the CG-SDT procedure is initiated as in clause 5.27 (i.e., initial transmission for CG-SDT):
      3> select an SSB with SS-RSRP above cg-SDT-RSRP-ThresholdSSB amongst the SSB(s) associated with the configured uplink grant.
   2> else if PDCCH addressed to C-RNTI has been received after the initial transmission of CG-SDT with CCCH message (i.e., subsequent new transmission for CG-SDT):
      3> if SS-RSRP of the SSB selected for the previous transmission for CG-SDT is above cg-SDT-RSRP-ThresholdSSB and this SSB is associated with this configured uplink grant:
         4> select this SSB.
      3> else if SS-RSRP of the SSB selected for the previous transmission for CG-SDT is not above cg-SDT-RSRP-ThresholdSSB:
         4> select an SSB with SS-RSRP above cg-SDT-RSRP-ThresholdSSB amongst the SSB(s) associated with the configured uplink grant.
   2> if SSB is selected above:
      3> indicate the SSB index to the lower layer;
      3> consider this configured uplink grant as valid.

The MAC entity shall:
1> if no SSB configured for CG-SDT with SS-RSRP above cg-SDT-RSRP-ThresholdSSB is available:
   2> if PDCCH addressed to C-RNTI after the initial transmission of the CG-SDT with CCCH message has been received:
      3> if there is data available for transmission for at least one RB configured for SDT:
         4> initiate Random Access procedure in clause 5.1.
NOTE 1: Void.

For an uplink grant configured for configured grant Type 1 for RACH-less LTM cell switch, when there is an ongoing RACH-less LTM cell switch procedure, for each configured uplink grant valid according to TS 38.214 [7] for which the above formula is satisfied, the MAC entity shall:
1> if an SSB corresponding to the configured UL grant has the same SSB index as the SSB associated with the TCI state indicated by the UL TCI state ID field, if present, or by the TCI state ID field otherwise, in the LTM Cell Switch Command MAC CE, as specified in clause 21.1 in TS 38.213 [6]:
   2> select the SSB associated with the TCI state indicated by LTM Cell Switch Command MAC CE.
   2> indicate the SSB index to the lower layer;
   2> consider this configured uplink grant as valid.
1> else:
   2> consider this configured uplink grant as not valid.
NOTE 1a: When there is an ongoing RACH-less LTM cell switch, the configured grant Type 1 which is not specifically configured for LTM (see cg-LTM-Configuration in TS 38.331 [5]) is not used.
NOTE 1b: After completion of LTM cell switch, the UE stops using the grant configured for RACH-less LTM cell switch (see cg-LTM-Configuration in TS 38.331 [5]).

For the uplink grant configured for configured grant Type 1 for RACH-less handover, if the configured uplink grant is valid according to TS 38.214 [7] for which the above formula is satisfied and RACH-less handover is not successfully completed, the MAC entity shall:
1> if the initial transmission of RACH-less handover has been performed according to clause 5.4.1 and 5.33:
   2> if the SSB corresponding to the configured UL grant has the same SSB index as the SSB selected for the initial transmission of RACH-less handover (i.e., retransmission of initial transmission of RACH-less handover):
      3> select this SSB;
      3> indicate the SSB index corresponding to the configured uplink grant to the lower layer,
      3> consider this configured uplink grant as valid.
1> else if at least one SSB corresponding to the configured uplink grant with SS-RSRP above cg-RRC-RSRP-ThresholdSSB is available:
   2> select an SSB with SS-RSRP above cg-RRC-RSRP-ThresholdSSB amongst the SSB(s) associated with the configured uplink grant;
   2> indicate the selected SSB index to the lower layer;
   2> consider this configured uplink grant as valid.

The MAC entity shall:
1> if no SSB configured for RACH-less handover with SS-RSRP above cg-RRC-RSRP-ThresholdSSB is available:
   2> initiate Random Access procedure in clause 5.1.
NOTE 1A: When the UE determines if there is an SSB with SS-RSRP above cg-RRC-RSRP-ThresholdSSB or cg-SDT-RSRP-ThresholdSSB, the UE uses the latest unfiltered L1-RSRP measurement.

After an uplink grant is configured for a configured grant Type 2, the MAC entity shall consider sequentially that the configured uplink grant, or the first configured uplink grant in a multi-PUSCH configured grant, in the Nth (N≥0) periodicity occurs in the symbol for which:

[(SFN×numberOfSlotsPerFrame×numberOfSymbolsPerSlot)+(slot number in the frame×numberOfSymbolsPerSlot)+symbol number in the slot]=[(SFN_{start time}×numberOfSlotsPerFrame×numberOfSymbolsPerSlot+slot_{start time}×numberOfSymbolsPerSlot+symbol_{start time})+N×periodicity]modulo(1024×numberOfSlotsPerFrame×numberOfSymbolsPerSlot)

where SFN_{start time}, slot_{start time}, and symbol_{start time} are the SFN, slot, and symbol, respectively, of the first transmission opportunity of PUSCH where the configured uplink grant was (re-)initialised.

For a multi-PUSCH configured grant Type 2, the M^{th} (1<M≤nrofSlotsInCG-Period) configured uplink grant within the same periodicity occurs (M−1)× numberOfSymbolsPerSlot symbols after the symbol in which the first configured uplink grant in that periodicity occurs.

If cg-nrofPUSCH-InSlot or cg-nrofSlots is configured for a configured grant Type 1 or Type 2, the MAC entity shall consider the uplink grants occur in those additional PUSCH allocations as specified in clause 6.1.2.3 of TS 38.214 [7].
NOTE 2: In case of unaligned SFN across carriers in a cell group, the SFN of the concerned Serving Cell is used to calculate the occurrences of configured uplink grants.

When the configured uplink grant is released by upper layers, all the corresponding configurations shall be released and all corresponding uplink grants shall be cleared.

The MAC entity shall:
1> if at least one configured uplink grant confirmation has been triggered and not cancelled; and
1> if the MAC entity has UL resources allocated for new transmission:
   2> if, in this MAC entity, at least one configured uplink grant is configured by configuredGrantConfigToAddModList:
      3> instruct the Multiplexing and Assembly procedure to generate a Multiple Entry Configured Grant Confirmation MAC CE as defined in clause 6.1.3.31.
   2> else:
      3> instruct the Multiplexing and Assembly procedure to generate a Configured Grant Confirmation MAC CE as defined in clause 6.1.3.7.
   2> cancel all triggered configured uplink grant confirmation(s).

For a configured grant Type 2, the MAC entity shall clear the configured uplink grant(s) immediately after first transmission of Configured Grant Confirmation MAC CE or Multiple Entry Configured Grant Confirmation MAC CE which confirms the configured uplink grant deactivation.

### Retransmissions Use:

repetition of configured uplink grants; or
received uplink grants addressed to CS-RNTI; or
configured uplink grants with cg-RetransmissionTimer, cg-RRC-RetransmissionTimer or cg-SDT-RetransmissionTimer configured.

In [6] R2-2502545, the following is provided:
CSI-ReportConfig

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214 [19], clause 5.2.1.

Editor's note: The description of CSI-ReportConfig IE may have further updates.

### CSI-ReportConfig Information Element

-- ASN1START
-- TAG-CSI-REPORTCONFIG-START
CSI-ReportConfig ::= SEQUENCE {

| reportConfigId | CSI-ReportConfigId, | |
|---|---|---|
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {sl5, sl10, sl20, sl40, sl80, sl160, |

sl320},

| | |
|---|---|
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
    }
  },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

OPTIONAL -- Need S
},

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| csi-ReportUE-IBM-r19 | CSI-ReportUE-IBM-r19 |

OPTIONAL -- Need R
]]
}

| | |
|---|---|
| CSI-ReportUE-IBM-r19 ::= | SEQUENCE { |
| eventType-r19 | ENUMERATED {event1, event2, event7}, |
| valueOfQ-r19 | INTEGER (1..8) |

OPTIONAL, -- Need R

| | |
|---|---|
| resourceForSecondChannelOfModeB-r19 | SEQUENCE { |

configuredGrantConfigIndex-r19 ConfiguredGrantConfigIndex-r16
OPTIONAL, -- Need R

| | |
|---|---|
| ul-BWP-Id-r19 | BWP-Id, |
| servCellIndex-r19 | ServCellIndex |

}
OPTIONAL, -- Need R

| firstPUCCHResourceConfig-r19 | SEQUENCE { | |
|---|---|---|
| periodicityAndOffset | CHOICE { | |
| sym2 | NULL, | |
| sym6or7 | NULL, | |
| sl1 | NULL, | -- Recurs in |

every slot

| | |
|---|---|
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19), |
| sl40 | INTEGER (0..39), |
| sl80 | INTEGER (0..79), |
| sl160 | INTEGER (0..159), |
| sl320 | INTEGER (0..319), |
| sl640 | INTEGER (0..639) |

},

| | |
|---|---|
| resource | PUCCH-ResourceId |

}
OPTIONAL -- Need R
}

csi-ReportUE-IBM
Configures parameters used for the UE initiated beam reporting.

CSI-ReportUE-IBM field descriptions

firstPUCCHResourceConfig
Indicates the periodic PUCCH resource for the first step of PUCCH transmission for both mode-A and mode-B UE-
initated beam reporting.
resourceForSecondChannelOfModeB
Indicates Type-1 CG PUSCH resource for the second step of PUSCH transmission in mode-B UE-initiated beam
reporting.
valueOfQ
This field is only included for eventType set to event7.
Editor's note: this may be reflected in ASN.1 (e.g. by embedding valueOfQ in eventType) once the full list of parameters
is provided.

In [7]~[14] ([7] RAN1 116 meeting report; [8] RAN1 116bis meeting report; [9] RAN1 117 meeting report; RAN1 118 meeting report; RAN1 118bis meeting report; RAN1 119 meeting report; RAN1 120 chairman's note; and RAN1 120bis chairman's note), relevant progress is quoted below:

### RAN1 #120bis

### Agreement

Regarding triggering event determination for Event 2, on resetting the counting, the following modification on the agreed Candidate #2 in RAN1 #120 is supported.
Candidate #2: {The measured current beam RS is updated based on} indicated TCI state;
   In such case, the UE needs to reset the counting for all new beams.
   FFS: Further details on the update (if necessary)

### Agreement

On cross-CC beam report measurement for UE-initiated/event-driven beam reporting, regarding Event-2, introduce an RRC parameter to indicate ServCellIndex on which the indicated TCI state used to determine the current beam RS is applied
FFS: Indication of the cell that corresponds to the configured first PUCCH resource in CSI report config including whether it is necessary

### Agreement

On beam report transmission procedure for UE-initiated/event-driven beam reporting, for the case the pre-configured Type-1 CG PUSCH carry the beam report, for the second UL channel in Mode-B, reuse the intra-UE multiplexing/prioritization rules of PUSCH with SP-CSI for Type-1 CG PUSCH with UEI-BR for Mode B

### Agreement

On UE-initiated/event-driven beam reporting, regarding current beam report on Event 1, reuse RRC parameter enabledCurrentBeamReport-r19 to enable/disable the RSRP report of current beam.

### Agreement

On beam report transmission procedure for UE-initiated/event-driven beam reporting, confirming the following working assumption with the following modification.

For Mode-A, the multiple CSI report configurations associated with the same PUCCH resource should be associated with a same CSI-AperiodicTriggerState.

### RAN1 #120

### Agreement

On beam report transmission procedure for UE-initiated/event-driven beam reporting, regarding Mode-B, the value of X symbols for determining available transmission occasion of the second UL channel is configured by RRC (FFS: subject to a corresponding UE capability)

### Agreement

Regarding triggering event determination for Event 2, at least Candidate #2 is supported for resetting the counting.
Candidate #1: RS reconfiguration/update or MAC-CE signaling (if supported) for new beam is received;
   FFS: whether to reset the counting for all new beams.
   FFS: whether to maintain the counting whose new beam is NOT updated.
Candidate #2: [The measured current beam based on] indicated TCI state is updated;
   In such case, the UE need to reset the counting for all new beams.
Candidate #3: UEI beam report is transmitted;
   FFS: Only reset the counting of new beams fulfilling triggering condition and reported by the UEI beam report
Candidate #4: NW response (e.g., DCI in step-2 of Mode-A) is detected.
Candidate #5: The time window expires
Candidate #6: The threshold for event evaluation is re-configured by RRC signaling
(FFS) Candidate #7: The RRC parameter(s) associated with the CSI report configuration for UEI beam report is reconfigured.
FFS: RRC parameter(s)

### Agreement

On UE-initiated/event-driven beam reporting, for Event 1, support Option-2 for RS measurement:
Option-2: RS resource set for new beam is configured in the CSI reporting configuration, and the following implicit manner for enabling one of either scheme-1 or scheme-2 is used:
   If the RS(s) for new beam are CSI-RS configured in a CSI-RS resource set configured with repetition, Scheme-1 is enabled; otherwise, Scheme-2 is enabled.

### Agreement

On beam report transmission procedure for UE-initiated/event-driven beam reporting, one PUCCH resource of first PUCCH can be associated with one or multiple CSI report configurations, regarding Event-2.
Only a single UEI beam report is carried in the second PUSCH.
   Additional indication of one ‘CSI report configuration’ is provided in the report format.
      The CSI report configurations associated with the same PUCCH resource are ordered in ascending order of corresponding CSI-ReportConfigId, the number of bits of the additional indication field is ceil (log ₂ (N_CSIconfig)), where the N_CSIconfig denotes the number of CSI report configurations associated with the same PUCCH resource.
      The payload size of the single UEI beam report is determined according to the max payload size among the associated CSI report configurations.
         Zero-padding can be appended if the payload size of the UEI beam report is less than the max report payload.
      The reported UEI beam report should satisfy the triggering condition.
      If multiple UE initiated beam report procedures occur, down-select one of the following options:
         Option-1: It is up to UE implementation to select one of configuration.
         Option-2: The UEI beam report with highest priority is reported
         Option-3: The report triggered in the latest measurement is reported in PUSCH
      The multiple CSI report configurations associated with the one first PUCCH resource should be configured in the same CC.
      Working Assumption: For Mode-A, the multiple CSI report configurations associated with the same PUCCH resource should be associated with a same CSI-AperiodicTriggerState.
      For Mode-B, the multiple CSI report configurations associated with the same PUCCH resource should be associated with the same second configured PUSCH

### RAN1 #119

### Agreement

On beam report transmission procedure for UE-initiated/event-driven beam reporting, for the case the pre-configured Type-1 CG PUSCH does NOT carry the beam report, for the second UL channel in Mode-B, Option-2 is supported:
Option-2: Type-1 CG PUSCH can NOT be transmitted

### Agreement

On cross-CC beam report transmission procedure for UE-initiated/event-driven beam reporting, regarding Event-2, the following is supported
the first PUCCH and the second PUSCH associated for UE-initiated/event-driven beam reporting are from the same PUCCH group.
(working assumption) the first PUCCH and the second PUSCH associated for UE-initiated/event-driven beam reporting are from different PUCCH groups
   Subject to separate UE capability

### Agreement

On beam report transmission procedure for UE-initiated/event-driven beam reporting, regarding first PUCCH channel configuration, down-select one of Alt-1 and Alt-2 for both mode-A and mode-B.
Alt-1 (dedicated SR): Introduce RRC parameter, e.g., reportResourceRequest-UEIBR/reportNotification-UEIBR, corresponding to the one-bit indication in the first PUCCH channel
   The RRC parameter is associated with the dedicated SchedulingRequestId.
      Note: The detailed signaling is up to RAN2.
   FFS: whether/how to enhance legacy SR to support notification of beam report transmission in Mode-B
Alt-2 (new UCI type): Introduce RRC parameter, e.g., firstPUCCHResourceConfig-UEIBR, for the periodic PUCCH resource configuration.
   Note: The RRC parameter is NOT associated with SchedulingRequestId.
   1-bit to PUCCH resource is encoded by reusing the encoding mechanism of positive/negative SR.
   The dedicated RRC parameter at least comprises the following:
      PUCCH-ResourceID
      periodicityAndOffset
   Above applies at least for the single CC case.
   Reuse multiplexing/dropping rule(s) of SR as baseline
      FFS: overlapping with SR/LRR or PUSCH

Note: Further details on first PUCCH retransmission for mode A and mode B will be separately discussed.

### Agreement

On UE-initiated/event-driven beam reporting, for Event 7, the scheme-1 and scheme-2 for deriving ‘RS for current beam’ on Event-2 is reused with the following further interpretation:
Scheme-1: ‘RS for current beam’ is the QCL RS in the activated TCI state with the Q-th best quality.
Scheme-2: ‘RS for current beam’ is the SSB which is QCLed with the QCL RS in the activated TCI state with the Q-th best quality.
Basic feature of the triggering event determination for Event-7: Once quality of at least one new beam becomes a threshold value better than the RS derived from the activated TCI state with the Q-th best quality, UE initiated beam report occurs

Note: For Event-2, we have the following definition for scheme-1 and scheme-2
Scheme-1: RS for current beam is the QCL RS in the indicated TCI state
Scheme-2: RS for current beam is the SSB which is QCLed with the QCL RS in the indicated TCI state.

### Agreement

On UE-initiated/event-driven beam reporting, for Event 1, down-select at least one among the following options for RS measurement
Option-1: RS resource set for new beam is NOT configured in the CSI reporting configuration, and an explicit RRC selection for scheme-1 and scheme-2 is introduced.
Option-2: RS resource set for new beam is configured in the CSI reporting configuration, and the following implicit manner for enabling one of either scheme-1 or scheme-2 is used:
   If the RS(s) for new beam are CSI-RS configured in a CSI-RS resource set configured with repetition, Scheme-1 is enabled; otherwise, Scheme-2 is enabled.

### Agreement

On beam report transmission procedure for UE-initiated/event-driven beam reporting, regarding first PUCCH channel configuration, Alt-2 is supported for both mode-A and mode-B: the first PUCCH channel is a new UCI type
Alt-2 (new UCI type): Introduce RRC parameter, e.g., firstPUCCHResourceConfig-UEIBR, for the periodic PUCCH resource configuration.
   It is RAN1's understanding that the RRC parameter is NOT associated with SchedulingRequestId.
   1-bit to PUCCH resource is encoded by reusing the encoding mechanism of positive/negative SR.
   The dedicated RRC parameter at least comprises the following:
      periodicityAndOffset.
      PUCCH-ResourceID
Above applies at least for the single CC case.
Reuse multiplexing/dropping rule(s) of SR as baseline.
   FFS: overlapping with SR/LRR or PUSCH

Note: Further details on first PUCCH retransmission (if supported) for mode A and mode B will be continue to be separately discussed in RAN1.

### Agreement

Confirm the following working assumption in RAN1 #117:

On beam report transmission procedure for UE-initiated/event-driven beam reporting
For mode-A, at least support one-bit indication in the first PUCCH channel to request a resource for a second UL channel to carry beam report.
   In such case, a periodic PUCCH resource (with PUCCH format 0/1) is configured by dedicated RRC signaling.
For mode-B, at least support one-bit indication in the first PUCCH channel to notify a second UL channel to carry beam report.
   In such case, a periodic PUCCH resource (with PUCCH format 0/1) is configured by dedicated RRC signaling.
FFS: Whether/how to support multi-bit indication in the first PUCCH for mode-A and mode-B, e.g., when multi-event(s) are approved.
FFS: details on the dedicated RRC signaling
Above applies at least for the single CC case.

### Agreement

On UE-initiated/event-driven beam reporting, at least one of the following is supported as an extension on L1-RSRP report format depending on Event-2.
Option-1: For each of reported CRI/SSBRI, to introduce additional indication of whether the CRI/SSBRI satisfies the condition of Event-2.
   The presence of this field is enabled by RRC with subjective to UE capability.
   The presence of this field is only for the case that N>1 and the time window and M are configured
Option-2: For each of reported CRI/SSBRI, to introduce additional indication of the number of Event-2 instances for the CRI/SSBRI(s) within a time window.
   The presence of this field is enabled by RRC with subjective to UE capability.
   The presence of this field is only for the case that N>1 and the time window and M are configured.
Option-3: No further enhancement.

Note: As agreed in RAN1 #117, at least one of the reported CRI/SSBRI(s) should satisfy the condition of Event-2

### Agreement

On UE-initiated/event-driven beam reporting, regarding trigger events, the following working assumption in RAN1 #118bis is confirmed:

On UE-initiated/event-driven beam reporting, regarding trigger events, besides for Event-2, Event-1 and Event-7 are both supported.
Event-1: Quality of the current beam is worse than a certain threshold.
Event-7: Quality of at least one new beam, such as L1-RSRP, becomes a threshold value better than the RS derived from the activated TCI state with the Q-th best quality.
   Q is RRC configured with subjective to UE capability signalling
      UE may only indicate a single candidate value or not support Event-7.
The additionally supported events will reuse the same design as event 2-unless there is consensus to do otherwise
The additionally supported events will be lower priority compared to event 2.

### Agreement

Regarding for the evaluation periodicity for determining Event-2 instance [at least when DRX is not configured], at least Alt-1 is supported for the single-CC beam reporting (for case that the CSI report configuration and RS for the current beam and new beam(s) are in the same CC).
Alt-1: The periodicity of the current beam RS should be the same as that of the new beam RS(s).
   The evaluation periodicity is the same as the periodicity of the current and new beam RS(s).
      RAN1 #118-bis
      [118b] Agreement

On beam report transmission procedure for UE-initiated/event-driven beam reporting, regarding the triggering procedure in Step-2 of Mode-A
Reuse CSI request field in DCI format 0_1/0_2 to trigger the transmission of the UEI beam report
   If a CSI trigger state associated with UEI beam report configuration(s) is indicated by the CSI request field in DCI format 0_1/0_2, the UE transmits the corresponding UEI beam report(s) in the second PUSCH scheduled by the DCI format 0_1/0_2
   FFS: DCI format 0_3
FFS: Whether a CSI trigger state should be dedicated to UE-initiated/event-driven beam reporting, i.e., not associated with legacy AP-CSI report configuration.
   [118b] Agreement

On beam report transmission procedure for UE-initiated/event-driven beam reporting, resource mapping/configuration between first and second UL channel in Mode-B, at least Option-1 is supported
Option-1 (one-to-one): Only one periodic PUCCH resource for the first channel and only one pre-configured resource for second UL channel can be associated with the CSI report configuration for UE-initiated/event-driven beam reporting.
   Down-select one of the following in RAN1 #118bis
      Option-1A: Same periodicity between first PUCCH resource and pre-configured resource for second UL channel.
      Option-1B: No restriction in terms of periodicity.
         [118b] Agreement

On cross-CC beam report transmission procedure for UE-initiated/event-driven beam reporting, regarding Event-2, for both Mode-A and Mode-B, the first PUCCH and the second PUSCH can be from the same or different CC(s)
FFS: whether the first PUCCH and the second PUSCH should be from the same PUCCH group
The first PUCCH and the second PUSCH should be in the same CG.
   FFS: Different CGs
      [118b] Agreement

On beam report transmission procedure for UE-initiated/event-driven beam reporting, for the case the pre-configured Type-1 CG PUSCH carry the beam report, for the second UL channel in Mode-B, at least option3 is supported:
Option-1: The same Type-1 CG PUSCH can carry UL-SCH, any other UCI, and the beam report.
Option-2: The Type-1 CG PUSCH is a dedicated type-1 CG PUSCH for carrying the beam report
   Note: This PUSCH can NOT carry UL-SCH. This PUSCH can NOT carry any other UCI.
Option-3: The Type-1 CG PUSCH is a type-1 CG PUSCH for carrying the beam report.
   Note: This PUSCH can NOT carry UL-SCH. This PUSCH can carry any other UCI.

FFS: whether Type-1 CG PUSCH can be transmitted if the pre-configured Type-1 CG PUSCH does NOT carry the beam report

[118b] Agreement

On beam report transmission procedure for UE-initiated/event-driven beam reporting, regarding resource mapping/configuration between first and second UL channel associated with a same CSI report configuration in Mode-B,
The UE expects that there is the same periodicity (in ms) between first PUCCH resource and pre-configured resource for second UL channel.
   [118b] Agreement

Regarding RS measurement for the current beam for Event 2, for Option-2a, besides for scheme-1 and scheme-2, there is no RAN1 consensus on the following enhancement for handling the case that only one TRS is configured in the indicated TCI state in RAN1 #118bis
Option-1: Introducing additional scheme: the RS for current beam can be a CSI-RS for beam management derived from the QCL RS in the indicated TCI state;
Option-2: Further support TRS as measurement RS of current beam for determining L1-RSRP
Option-3: Introducing additional scheme: The RS for current beam is explicitly configured by RRC or MAC-CE (Option-2C in RAN1 116b agreement).

Note 3: When only one TRS is configured in the indicated TCI state, either Scheme-1 (working assumption) or Scheme-2 is used where enabling one of either Scheme-1 or Scheme-2 is selected by NW.

When the Scheme-1 is used, the UE assumes that the CSI-RS resource in the indicated TCI state is configured in a CSI-RS resource set configured with repetition.

[118b] Agreement

Regarding RS measurement for the current beam for Event 2, for Option-2a, confirm the following working assumption
Note 3: When only one TRS is configured in the indicated TCI state, either Scheme-1 (working assumption) or Scheme-2 is used where enabling one of either Scheme-1 or Scheme-2 is selected by NW.
   [118b] Agreement

Regarding RS measurement for the current beam for Event 2, for Option-2a, the following working assumption in RAN1 #117 is confirmed with modification:
(Working Assumption) Enabling of either Scheme-1 or Scheme-2 should ensure the same RS type for RS measurement for current beam and new beam.
   Note: In such case, the RS type comprises SSB and CSI-RS configured in a CSI-RS resource set configured with repetition.
      [118b] Agreement

Regarding RS measurement for the current beam for Event 2, for enabling one of either Scheme-1 or Scheme-2 by NW in Option-2a, the following implicit manner is supported:
If the RS(s) for new beam are CSI-RS configured in a CSI-RS resource set configured with repetition, Scheme-1 is enabled; otherwise, Scheme-2 is enabled.
   [118b] Agreement

Regarding the triggering event determination for Event 2, the event instance(s) counting is per new beam. Further study candidate condition(s) of resetting the counting including whether resetting is needed.

[118b] Agreement

On cross-CC beam report transmission procedure for UE-initiated/event-driven beam reporting, regarding Event-2, the following is supported
For new beam measurement, in a CSI report configuration, configure legacy RRC parameter carrier that indicates the CC that the RS resource set associated with the CSI reporting configuration can be found

### RAN1 #118

### Agreement

On beam report transmission procedure for UE-initiated/event-driven beam reporting, for regarding Mode-B, the pre-configured resource(s) for the second channel in Step-2 is at least type 1 CG-PUSCH.

### Agreement

Regarding explicit RS configuration for new beam measurement for Event 2, at least Option-1 is supported
Option-1: The RS(s) for new beam(s) are explicitly configured in one RS resource set associated with an CSI reporting configuration
   If legacy UE capability signaling cannot be reused, introduce a UE capability signaling of indicating the maximum number of the configured RS(s) in the RS resource set.
   FFS: The RS in the RS resource set can be updated by MAC-CE

### Agreement

On UE-initiated/event-driven beam reporting, regarding L1-RSRP report format Option-3 depending on Event-2, the following differential L1-RSRP report format is supported.

CRI or SSBRI #1
CRI or SSBRI #2
. . .
CRI or SSBRI #N
L1-RSRP #1
Differential L1-RSRP #2
. . .
Differential L1-RSRP #N
Differential L1-RSRP for current beam, if report mode
that current beam is always reported is enabled by RRC
Note: Other contents are not precluded

Differential L1-RSRP #2~ #N/current beam is determined based on the difference between measured L1-RSRP corresponding to the CRI/SSBRI #2~ #N/current beam and the measured L1-RSRP corresponding to CRI/SSBRI #1
   L1-RSRP #1 is the largest measured RSRP among reported ones, and an absolute L1-RSRP.

### Agreement

On beam report transmission procedure for UE-initiated/event-driven beam reporting, regarding the triggering procedure in Step-2 of Mode-A, select one of the following options
Option-1: Introduce a new 1-bit field in DCI format 0_1/0_2 to trigger the transmission of the UEI beam report
   FFS: DCI format 0_3
Option-2: Reuse CSI request field in DCI format 0_1/0_2 to trigger the transmission of the UEI beam report
   FFS: DCI format 0_3
FFS: Whether/how to handle the case that multiple CSI report configuration(s) for the UE-initiated/event-driven beam report are associated with the same first PUCCH resource and/or the same scheduled PUSCH

### Agreement

On UE-initiated/event-driven beam reporting, regarding L1-RSRP report format Option-3 depending on Event-2, the candidate value of ‘N’ at least comprises {1, 2, 3, 4}

### Agreement

Regarding RS measurement for the current beam for Event 2, for Option-2a, besides for scheme-1 and scheme-2, further down-select one of the following for handling the case that only one TRS is configured in the indicated TCI state in RAN1 #118bis
Option-1: Introducing additional scheme: the RS for current beam can be a CSI-RS for beam management derived from the QCL RS in the indicated TCI state;
Option-2: Further support TRS as measurement RS of current beam for determining L1-RSRP
Option-3: Introducing additional scheme: The RS for current beam is explicitly configured by RRC or MAC-CE (Option-2C in RAN1 116b agreement).
Option-4: No further enhancement

Note: If there is no consensus in RAN1 on one of Options 1/2/3, Option 4 will be taken.

### Agreement

On beam report transmission procedure for UE-initiated/event-driven beam reporting, for the case the pre-configured Type-1 CG PUSCH carry the beam report, for the second UL channel in Mode-B, at least one or both of the following should be supported:
Option-1: The same Type-1 CG PUSCH can carry UL-SCH and the beam report.
Option-2: The Type-1 CG PUSCH is a dedicated type-1 CG PUSCH for carrying the beam report
   Note: This PUSCH can NOT carry UL-SCH. This PUSCH can NOT carry any other UCI.

### Agreement

On beam report transmission procedure for UE-initiated/event-driven beam reporting, regarding Mode-B, UEI beam report is carried on a first available transmission occasion of the second UL channel X symbols after sending the last symbol of report notification on the first PUCCH channel.

### Agreement

On beam report transmission procedure for UE-initiated/event-driven beam reporting, regarding resource mapping/configuration between first and second channel in Mode-B, for a given CSI report configuration, the following is provided for down-selection.
Option-1 (one-to-one): Only one first PUCCH resource and only one pre-configured resource for second UL channel can be associated with the CSI report configuration for UE-initiated/event-driven beam reporting.
   Option-1A: Same periodicity between first PUCCH resource and pre-configured resource for second UL channel.
   Option-1B: No restriction in terms of periodicity.
Option-2 (one-to-M): Only one first PUCCH resource and one or more pre-configured resource(s) for second UL channel can be associated with CSI report configuration for UE-initiated/event-driven beam reporting.

### Agreement

On beam report transmission procedure for UE-initiated/event-driven beam reporting, regarding Event-2, for at least Mode-B, the beam report should be carried in the second UL channel in the CC where the corresponding CSI report configuration is configured.
Above applies to both cross-CC and same-CC beam report.
Note: Above is applied to the case that second UL channel is PUSCH.
FFS: Whether the first and second channels can be from the same/different CC.

### Working Assumption

On UE-initiated/event-driven beam reporting, regarding trigger events, besides for Event-2, Event-1 and Event-7 are both supported.
Event-1: Quality of the current beam is worse than a certain threshold.
Event-7: Quality of at least one new beam, such as L1-RSRP, becomes a threshold value better than the RS derived from the activated TCI state with the M-th best quality.
   M is RRC configured with subjective to UE capability signalling
      UE may only indicate a single candidate value or not support Event-7.
The additionally supported events will reuse the same design as event 2-unless there is consensus to do otherwise
The additionally supported events will be lower priority compared to event 2.

### Working Assumption

On beam report transmission procedure for UE-initiated/event-driven beam reporting
For mode-A, at least support one-bit indication in the first PUCCH channel to request a resource for a second UL channel to carry beam report.
   In such case, a periodic PUCCH resource (with PUCCH format 0/1) is configured by dedicated RRC signaling.
For mode-B, at least support one-bit indication in the first PUCCH channel to notify a second UL channel to carry beam report.
   In such case, a periodic PUCCH resource (with PUCCH format 0/1) is configured by dedicated RRC signaling.
FFS: Whether/how to support multi-bit indication in the first PUCCH for mode-A and mode-B, e.g., when multi-event(s) are approved.
FFS: details on the dedicated RRC signaling
Above applies at least for the single CC case.

### Agreement

Regarding RS measurement for the current beam for Event 2, for Option-2a, support the both schemes as follows.
Scheme-1: RS for current beam is the QCL RS in the indicated TCI state
   FFS: Whether/How to handle the case if only one TRS is configured in the indicated TCI state.
Scheme-2: the RS for current beam is the SSB which is QCLed with the QCL RS in the indicated TCI state.
Enabling one of either Scheme-1 or Scheme-2 is selected by NW.
   FFS: The above selection is via an explicit RRC parameter or an implicit manner, e.g., if the RS(s) for new beam are CSI-RS, Scheme-1 is enabled; otherwise, Scheme-2 is enabled.
   (Working Assumption) Enabling of either Scheme-1 or Scheme-2 should ensure the same RS type for RS measurement for current beam and new beam.
The above QCL RS is the RS w.r.t. QCL-TypeD, if there are two QCL RSs in the indicated TCI state.

### Agreement

Regarding RS measurement for the new beam for Event 2, at least Option-3a is supported
Option-3a (explicit manner): The RS(s) for new beam(s) are explicitly configured

### Agreement

On beam report transmission procedure for UE-initiated/event-driven beam reporting, regarding Mode-A, the DCI format in Step-2 comprises UL-grant DCI format, and the second channel in Step-3 is at least PUSCH.
The UL-grant DCI format at least comprises DCI format 0_1/0_2.
   FFS: DCI format 0_3

### Agreement

Regarding the triggering event determination for Event 2:
If within a time window (which is configurable), the number of Event-2 instance(s) for at least one same new beam is greater than or equal to a configurable number M, UE initiated beam report occurs.
   Note: Event-2 instance for a new beam is determined if the L1-RSRP of the new beam becomes a threshold value better than the current beam

Above feature is subject to UE capability.
Basic feature: Once the L1-RSRP of the new beam becomes a threshold value better than the current beam, UE initiated beam report occurs

FFS: Whether the above is captured in RAN1 or RAN2 specification.

### Agreement

On UE-initiated/event-driven beam reporting, regarding trigger events, the following Event-1 and 7a/7b, are provided for down-selection or combination in RAN1 #118 (possible outcome is that no new event is supported)
Event-1: Quality of the current beam is worse than a certain threshold.
Event-7a: Quality of at least one new beam, such as L1-RSRP, becomes a threshold value better than the RS derived from the activated TCI state with the worst quality.
Event-7b: Quality of at least one new beam, such as L1-RSRP, becomes a threshold value better than the RS derived from the activated TCI state with the best quality.

### Agreement

Regarding explicit RS configuration for new beam measurement for Event 2, down-select the following options in the RAN1 #118:
Option-1: The RS(s) for new beam(s) are explicitly configured in one RS resource set associated with an CSI reporting configuration;
   FFS: The RS in the RS resource set can be updated by MAC-CE.
Option-2: A list of RS(s) for new beam measurement can be configured by RRC, and a subset can be activated for new beam measurement by MAC-CE.
   FFS: If a list size is small, MAC-CE activation is not needed
Option-3: A list of RS resource-(s) for new beam measurement can be configured by RRC, and a subset of RS resource(s) in the list can be provided for new beam measurement by indicated TCI state.
   RAN1 #116-bis
   [116b] Agreement

On beam report transmission procedure for UE-initiated/event-driven beam reporting, following modes are supported:
Mode A (dynamically scheduling UCI by gNB):
   Step 1: UE transmits a first PUCCH (one-bit/multi-bit) to request a resource for a second UL channel to carry beam report
      FFS: Request format, e.g., SR or a new UCI type.
   Step 2: UE detects the DCI format to indicate a resource for a second UL channel to carry beam report.
   Step 3: Beam report is transmitted in second UL channel.
      FFS: Details on the second UL channel, e.g., whether the second UL channel is PUCCH, PUSCH or both
   This mode is basic UE capability (i.e. all UE supporting UE-initiated/event-driven beam reporting should support this feature).
   No new DCI format is introduced.
Mode B (UCI in pre-configured resource(s) for second UL channel):
   Step 1: UE transmits a first PUCCH (one-bit/multi-bit) notifying a second UL channel to carry beam report
      FFS: Notification format, e.g., SR or a new UCI type.
   Step 2: UE transmits the beam report in the second UL channel.
      FFS: Details on the second UL channel, e.g., whether the second UL channel is PUCCH, PUSCH or both
   The notification in Step1 is in a separate reporting instance from the beam report in Step 2.

FFS: Whether UE receives acknowledge information with response to each step for all modes

For above procedures, cross-CC beam reporting is supported for both modes.
FFS: Details.
   [116b] Agreement

On UE-initiated/event-driven beam reporting, regarding trigger-event detection for beam reporting, at least support

Event-2: Quality of at least one new beam, such as L1-RSRP, becomes a threshold value better than the current beam.
At least L1-RSRP is supported as quality metrics used for Event-2
   FFS: How the L1-RSRP is used to determine the triggering event (e.g. timer, counter, filter coefficient)
   FFS: Whether the network controls how the L1-RSRP is used to determine the triggering event
Regarding RS measurement for the new beam for Event-2, down-select one or more of the following:
   Option-3a (explicit manner): The RS(s) for new beam(s) are explicitly configured by RRC (e.g., reusing legacy configuration of RS measurement or in TCI-State) or MAC-CE
   Option-3b (implicit manner): The RS(s) for new beam(s) are implicitly derived from QCL RS(s) of activated TCI state(s).
   Option-3c (implicit manner): The RS(s) for new beam(s) are implicitly derived from QCL RS(s) of configured TCI state(s).
Note-1: ‘New/current beam’ is for discussion purpose.
Note-2: Other trigger events/quality metrics (e.g., L1-SINR) are not precluded.
Note-3: For above implicit manner(s), if there are two QCL RSs in a TCI state, the measurement RS is derived from RS w.r.t. QCL-TypeD, if applicable.
   [116b] Agreement

On UE-initiated/event-driven beam reporting, regarding Event-2, the threshold value is RRC configured

[116b] Agreement

On UE-initiated/event-driven beam reporting, regarding Event-2, ‘current beam’ is a beam corresponding to the indicated TCI state.
Regarding RS measurement for the current beam for Event-2, Option-2a is supported:
   Option-2a (implicit manner): The RS for current beam is implicitly derived from a QCL RS of indicated TCI state.
      [116b] Agreement

On UE-initiated/event-driven beam reporting, further study the following trigger events:
Event-1: Quality of the current beam is worse than a certain threshold.
Event-3: Quality of a new beam is better than a certain threshold.
Event-4: Quality of the current beam is worse than a threshold 1, and quality of at least one new beam is better than a threshold 2.
Event-5: Absolute value of the difference between the quality of the current beam and the quality of at least one new beam is lower than a threshold.
Event-6: When the current beam is not in the best K>1 beams (out of configured beams for measurement and reporting).
Event-7a: Quality of at least one new beam, such as L1-RSRP, becomes a threshold value better than the RS derived from the activated TCI state with the worst quality.
Event-7b: Quality of at least one new beam, such as L1-RSRP, becomes a threshold value better than the RS derived from the activated TCI state with the best quality.
Event-8: Quality of M>1 new beams, such as L1-RSRP, become a threshold value better than the current beam.
Event-9: Quality of at least one new beam, such as L1-RSRP, becomes a threshold value better than the configured reference RS (can be SSB or CSI-RS).

### RAN1 #116

### Agreement

On UE-initiated/event-driven beam report, at least of following aspects should be included:
Trigger-event detection for beam reporting by UE
   UE monitors RS to assess if a beam-reporting trigger condition has been met
   FFS: Trigger condition for declaring beam-reporting event
Beam-report transmission by UE
   Signaling contents in the beam report
   Down-selection one or more options (strive for one) between the following options as signaling medium/container for beam report transmission
      MAC-CE.
      UCI
      Others are not precluded.

On UE-initiated/event-driven beam report, the following aspects may be included:
UE requesting UL resource(s) for the beam report
UE notifying transmission of beam report
gNB preconfigured resources

### Other Procedure(s) as Required

### Agreement

On UE-initiated/event-driven beam reporting, regarding trigger-event detection for beam reporting, RAN1 further study at least the following aspects: quality metrics, event-definition and threshold.
Further study trigger events, including the following example as a starting point
   Event-1: Quality of the current beam is worse than a certain threshold.
   Event-2: Quality of at least one new beam, such as L1-RSRP, becomes a threshold value better than the current beam.
   Event-3: Quality of a new beam is better than a certain threshold.
   Event-4: Quality of the current beam is worse than a threshold 1, and quality of at least one new beam is better than a threshold 2.
   Others are not precluded.
Note: Companies are encouraged to provide details on procedure (e.g. how it is used) related to their preferred event

### Agreement

On UE-initiated/event-driven beam reporting, at least support L1-RSRP as a measurement quantity on SSB for intra-cell and inter-cell, and periodic CSI-RS for beam management
Notes: measurement results may be contained in the beam report and/or used as quality metric(s) to initiate/trigger the reporting.

### Agreement

On UE-initiated/event-driven beam reporting, regarding signaling content(s), at least support DL RS resource indicator and L1-RSRP

In R1-2501669, the following is provided:

### 5.2.1.5.4 Event-Triggered Reporting

### 5.2.1.5.4.1 Event-Triggered Reporting

For a UE configured with a CSI-ReportConfig with the higher layer parameter eventType-r19 set to ‘event2’, and dl-OrJointTCI-StateList or ul-TCI-StateList for periodic reference signals [with the same periodicity],
if [during the eventDetectionTimeWindow Length-r19, if provided], the L1-RSRP value determined for each transmission occasion of at least one same reference signal of the reference signals configured by the new BeamResourceSet-r19 (in a same CC of CSI-ReportConfig, or provided by carrier in the CSI-ReportConfig) is at least once, or eventInstanceCount-r19 times, if provided, an eventThreshold-r19 greater than the L1-RSRP of
   the reference signal in the indicated TCI state [in a same CC of CSI-ReportConfig, or the CC indicated [by a RRC parameter]] in the CSI-ReportConfig, if newBeamResourceSet-r19 is a NZP-CSI-RS-ResourceSet configured with repetition, else
   the SS/PBCH block which is QCLed with the reference signal in the indicated TCI state [in a same CC of CSI-ReportConfig, or provided [by a RRC parameter]], if new BeamResourceSet-r19 is a CSI-SSB-ResourceSet,
the UE transmits PUCCH format 0 or format 1 in the PUCCH resource configured by firstPUCCHResourceConfig-UEIBR-r19 in the CSI-ReportConfig, and
the UE reports in a single reporting instance nrofReportedRS-UEIBR-r19 CRIs or SSBRIs and their absolute L1-RSRPs or differential L1-RSRPs corresponding to reference signals provided by the newBeamResourceSet-r19 that comprise at least one reference signal that satisfies the event, and, when enabledCurrentBeamReport-r19 is configured, the differential L1-RSRP corresponding to reference signal in the indicated TCI state, or to the SSB which is QCLed with the reference signal in the indicated TCI state:
   on a PUSCH indicated by the DCI format 0_1/0_2 in a PDCCH reception after the end of the PUCCH if reportTransmissionMode-r19 is configured as ‘ModeA’ and the CSI trigger state associated with the CSI-ReportConfig is indicated in the CSI request field in the DCI format 0_1/0_2, or
   on a type 1 CG-PUSCH configured by configuredResourceForSecondChannelOfModeB-r19 in the same CC as the corresponding CSI-ReportConfig which is the first available transmission occasion numOfSymbols-ModeB-r19 symbols after the end of the PUCCH if reportTransmissionMode-r19 is configured as ‘ModeB’, where the periodicity of the PUCCH resource and type 1 CG-PUSCH resource is the same, and the CG-PUSCH does not carry UL-SCH.

The above reference signal in the indicated TCI state is the reference signal w.r.t. QCL-TypeD, if there are two QCL RSs in the indicated TCI state.

The value of event instance counter index e for any of the reference signals configured by the new BeamResourceSet-r19, [running from 0 to eventInstanceCount-r19], is set to zero:
if the indicated TCI state of the measured reference signal is updated.

The UE does not expect that the reference signal in the indicated TCI state is in a different CC from the reference signals configured by new BeamResourceSet-r19.

The UE does not expect that a CSI trigger state associated with CSI report configuration(s) configured with the higher layer parameter eventType-r19 is further associated with other CSI report configurations that are not configured with the higher layer parameter eventType-r19.

For a UE configured with a CSI-ReportConfig with the higher layer parameter eventType-r19 set to ‘event7’, for periodic reference signals [with the same periodicity],
if [during the eventDetectionTimeWindowLength-r19, if provided], the L1-RSRP value determined for each occurrence of any of the reference signals configured by the new BeamResourceSet-r19 (in a same CC of CSI-ReportConfig, or provided by carrier in the CSI-ReportConfig) is at least eventInstanceCount-r19 times an eventThreshold-r19 greater than the L1-RSRP of
   the reference signal with the valueOfQ-r19 highest L1-RSRP out of the activated TCI state reference signals in a same CC of CSI-ReportConfig, or provided by a RRC parameter in the CSI-ReportConfig, if the NZP-CSI-RS-ResourceSet is configured with repetition set to ‘on’, else
   the SS/PBCH block which is QCLed with the reference signal in the indicated TCI state,
the UE transmits PUCCH format 0 or format 1 in the PUCCH resource configured by firstPUCCHResourceConfig-UEIBR-r19 in the CSI-ReportConfig, and
the UE reports nrofReportedRS-UEIBR-r19 CRIs:
   on PUSCH indicated by the DCI format 0_1/0_2 if reportTransmissionMode-r19 is configured as ‘ModeA’ and the CSI trigger state in the CSI request field is indicated in the DCI format 0_1/0_2, or
   on type 1 CG-PUSCH configured by configuredResourceForSecondChannelOfModeB-r19 and X symbols after the end of the PUCCH if reportTransmissionMode-r19 is configured as ‘ModeB’ and as indicated by configuredResourceForSecondChannelOfModeB-r19 and X symbols after sending the PUCCH, and where the periodicity of the PUCCH and CG-PUSCH channels is the same.

For a UE configured with a CSI-ReportConfig with the higher layer parameter eventType-r19 set to ‘event1’, for periodic reference signals [with the same periodicity],
if during the eventDetectionTime Window Length-r19, the L1-RSRP value determined for each occurrence of
   the reference signal indicated by the DCI field tci-PresentInDCI if the NZP-CSI-RS-ResourceSet is configured with repetition set to ‘on’, else
   the SSB which is QCLed with the measured reference signal,
is at least eventInstanceCount-r19 times less than eventThreshold-r19,
the UE transmits PUCCH format 0 or format 1 in the PUCCH resource configured by firstPUCCHResourceConfig-UEIBR-r19 in the CSI-ReportConfig, and
the UE reports nrofReportedRS-UEIBR-r19 CRIs and, when enabledCurrentBeamReport-r19 is configured as ‘yes’, the reference signal indicated by the DCI field tci-PresentInDCI, or the SSB which is QCLed with this reference signal:
   on PUSCH indicated by the DCI format 0_1/0_2 if reportTransmissionMode-r19 is configured as ‘ModeA’ and the CSI trigger state in the CSI request field is indicated in the DCI format 0_1/0_2, or
   on type 1 CG-PUSCH configured by configuredResourceForSecondChannelOfModeB-r19 and X symbols after the end of the PUCCH if reportTransmissionMode-r19 is configured as ‘ModeB’, and where the periodicity of the PUCCH and CG-PUSCH channels is the same.

The above reference signal in the indicated TCI state is the reference signal w.r.t. QCL-TypeD, if there are two QCL RSs in the indicated TCI state.

The following is quoted from R2-2502666:
[symbol] UL multiplexing

Regarding UL skipping, it is specified currently that UL skipping is not applied to UCI multiplexed on the PUSCH. Since UEI BR is transmitted in UCI, the highlighted sentence below already excludes the UEI BR.

TS 38.321 clause 5.7
The MAC entity shall:

| 1> | if the MAC entity is configured with enhancedSkipUplinkTxDynamic with value true and the grant indicated | |
|---|---|---|
| | to the HARQ entity was addressed to a C-RNTI, or if the MAC entity is configured with | |
| | enhancedSkipUplinkTxConfigured with value true and the grant indicated to the HARQ entity is a configured | |
| | uplink grant: | |
| | 2> | if there is no UCI to be multiplexed on this PUSCH transmission as specified in TS 38.213 [6]; and |
| | 2> | if there is no aperiodic CSI requested for this PUSCH transmission as specified in TS 38.212 [9]; and |
| | 2> | if the MAC PDU includes zero MAC SDUs; and |
| | 2> | if the MAC PDU includes only the periodic BSR and there is no data available for any LCG, or the MAC |
| | | PDU includes only the padding BSR: |
| | | 3> not generate a MAC PDU for the HARQ entity. |
| 1> | | else if the MAC entity is configured with skipUplinkTxDynamic with value true and the grant indicated to the |
| | | HARQ entity was addressed to a C-RNTI, or the grant indicated to the HARQ entity is a configured uplink |
| | | grant: |
| | 2> | if there is no aperiodic CSI requested for this PUSCH transmission as specified in TS 38.212 [9]; and |
| | 2> | if the MAC PDU includes zero MAC SDUs; and |
| | 2> | if the MAC PDU includes only the periodic BSR and there is no data available for any LCG, or the MAC |

PDU includes only the padding BSR:
3> not generate a MAC PDU for the HARQ entity.

Proposal 5: The current UL skipping procedure already exclude UEI BR since it is transmitted in UCI, no additional MAC impact.

In addition, based on RAN1 agreement below, the type-1 CG PUSCH for mode-B UEI BR is dedicated for the report which cannot multiplex UL-SCH data or other CSI report. Thus, the type-1 CG allocated for the mode-B UEI BR is transparent to MAC, which should be exclude from MAC UL-SCH transmission procedure.

Agreement
On beam report transmission procedure for UE-initiated/event-driven beam reporting, for the case the pre-
configured Type-1 CG PUSCH carry the beam report, for the second UL channel in Mode-B, at least Option-3 is
supported:

| - | Option-1: The same Type-1 CG PUSCH can carry UL-SCH, any other UCI, and the beam report. | |
|---|---|---|
| - | Option-2: The Type-1 CG PUSCH is a dedicated type-1 CG PUSCH for carrying the beam report | |
| | • | Note: This PUSCH can NOT carry UL-SCH. This PUSCH can NOT carry any other UCI. |
| - | Option-3: The Type-1 CG PUSCH is a type-1 CG PUSCH for carrying the beam report | |
| | • | Note: This PUSCH can NOT carry UL-SCH. This PUSCH can carry any other UCI. |

FFS: whether Type-1 CG PUSCH can be transmitted if the pre-configured Type-1 CG PUSCH does NOT carry
the beam report
Agreement
On beam report transmission procedure for UE-initiated/event-driven beam reporting, for the case the pre-configured
Type-1 CG PUSCH does NOT carry the beam report, for the second UL channel in Mode-B, Option-2 is supported:

| | |
|---|---|
| - | Option-2: Type-1 CG PUSCH can NOT be transmitted |

Proposal 6: The type-1 CG allocated for the mode-B UEI BR is transparent to MAC and excluded from MAC UL-SCH transmission procedure.

The following are quoted from R2-2502393.

Observation 2: According to TS 38.321, for configured uplink grant, if a UCI is to be multiplexed in PUSCH, the MAC entity needs to always generate a MAC PDU. This conflicts with the RAN1 agreement.

To align with the RAN1 agreement, we think that the MAC UE behaviours of the pre-configured CG PUSCH for the UE initiated beam report in Mode-B can be clarified to “not generate a MAC PDU”.

Proposal: RAN2 is kindly requested to confirm the understandings that the pre-configured CG PUSCH for the UE initiated beam report in Mode-B does not carry MAC PDU.

In 3GPP TS 38.321 V18.5.0 (2025-03), the following is quoted:

### 5.4.3 Multiplexing and Assembly

### 5.4.3.1 Logical Channel Prioritization

### 5.4.3.1.2 Selection of Logical Channels

### 5.4.3.1.3 Allocation of Resources

The MAC entity shall:
1> if the MAC entity is configured with enhancedSkipUplinkTxDynamic with value true and the grant indicated to the HARQ entity was addressed to a C-RNTI, or if the MAC entity is configured with enhancedSkipUplinkTxConfigured with value true and the grant indicated to the HARQ entity is a configured uplink grant:
   2> if there is no UCI to be multiplexed on this PUSCH transmission as specified in TS 38.213 [6]; and
   2> if there is no aperiodic CSI requested for this PUSCH transmission as specified in TS 38.212 [9]; and
   2> if the MAC PDU includes zero MAC SDUs; and
   2> if the MAC PDU includes only the periodic BSR and there is no data available for any LCG, or the MAC PDU includes only the padding BSR:
      3> not generate a MAC PDU for the HARQ entity.
1> else if the MAC entity is configured with skipUplinkTxDynamic with value true and the grant indicated to the HARQ entity was addressed to a C-RNTI, or the grant indicated to the HARQ entity is a configured uplink grant:
   2> if there is no aperiodic CSI requested for this PUSCH transmission as specified in TS 38.212 [9]; and
   2> if the MAC PDU includes zero MAC SDUs; and
   2> if the MAC PDU includes only the periodic BSR and there is no data available for any LCG, or the MAC PDU includes only the padding BSR:
      3> not generate a MAC PDU for the HARQ entity.

In New Radio (NR) Rel-19, phase 5 Multiple-Input/Multiple-Output (MIMO) enhancement aims at User Equipment (UE)-initiated (UEI) reports for beam management. According to current Radio Access Network Working Group 1 (RAN1) progress, at least event-1, event-2, and event-7 could be considered. A network node could configure a UE with one or more events via one or more Channel State Information (CSI) report configurations. One serving cell or neighboring cell could be configured with one or more events. That is, in response to a condition of the event-i being satisfied, the UE will trigger to transmit a UE-initiated report and/or the UE will transmit a UE-initiated report. Based on the UE-initiated report received by a network node, the network node will indicate the UE to change an indicated/activated/configured beam (e.g., Transmission Configuration Indicator (TCI) state). The indicated/activated/configured beam corresponds to a current beam. Typically, content of the UE-initiated report comprises a resource indicator associated with a resource (for indicating a candidate/new beam or candidate/new TCI state), and/or matrix/quality associated with the indicated resource, and/or the current beam's quality is worse than a threshold. Depending on a different event-i, a same or different content will be designed.

With introduction of a UEI report, there are two modes for resource allocation for the UEI report. Mode-A corresponds to dynamic scheduling while mode-B corresponds to a (pre-) configured resource for transmitting the UEI report.

For mode-A, three steps are typically included. When a condition of an event is met, the UE transmits a Physical Uplink Control Channel (PUCCH) to a network node (i.e., the first step), wherein the PUCCH is associated with the event. The UE receives a Physical Downlink Control Channel (PDCCH) with a Channel State Information (CSI) request field indicating a trigger state associated with the event and the PDCCH schedules a Physical Uplink Shared Channel (PUSCH)(i.e., the second step). According to an indication of the PDCCH, the UE transmits the UEI beam report associated with the event on the PUSCH (i.e., the third step).

For mode-B, two steps are typically included. When a condition of an event is met, the UE transmits a PUCCH (or a Pre-Notification (PN)) to a network node (i.e., the first step). The UE transmits a UEI beam report on a liked/linked/associated Configured Grant (CG) type-1 PUSCH to the network node (i.e., the second step). The PUCCH (or the PN) is used to notify usage of the liked/linked/associated CG type-1 PUSCH (which could be replaced by a (pre-) configured resource). The UE could be configured with one CSI-ReportConfig indicating one PUCCH resource Identify/Identification (ID) and one CG index for one event. The PUCCH resource according to the PUCCH resource ID is liked/linked/associated with the CG type-1 PUSCH resource according to the one CG index. The PUCCH resource and CG type-1 PUSCH resource could be configured on a same serving cell. The PUCCH resource and CG type-1 PUSCH resource could be configured on a different serving cell. The CG type-1 PUSCH resource is configured on the same serving cell as a new/candidate Reference Signal (RS)(beam). One CSI-ReportConfig could be configured with a set of new/candidate RSs and also with information of which serving cell the set of new/candidate RSs is located. The CG type-1 PUSCH resource for transmitting the UEI beam report could be used to multiplex Uplink Control Information (UCI)(which is other than the UEI beam report e.g., Scheduling Request (SR) and/or Hybrid Automatic Repeat Request (HARQ) and/or CSI) but without comprising Uplink (UL)-Shared Channel (SCH)(e.g., Medium Access Control (MAC) Protocol Data Unit (PDU) or data).

For mode-B, when the UE receives a configuration associated with a CSI-ReportConfig with an event, the CSI-ReportConfig will provide a parameter indicating an index for pointing out which ConfiguredGrantConfig is used to transmit the UEI beam report associated with the CSI-ReportConfig. However, some mandatory parameters in current ConfiguredGrantConfig may cause some issues. For example, nrofHARQ-Processes which indicates that the number of HARQ processes being configured may cause some ambiguities since the UE is not allowed to use this CG type-1 PUSCH resource transmitting data (e.g., MAC Service Data Unit (SDU)). In this sense, such mandatory nrofHARQ-Processes configured in ConfiguredGrantConfig for the UEI beam report may waste HARQ processes, which lose HARQ process utilization efficiency since the number of total HARQ processes (per cell) is limited (e.g., 16 or 32).

### Concepts:

Opt1: UE ignores nrofHARQ-Processes.
If nrofHARQ-Processes is configured on ConfiguredGrantConfig associated with a CSI-ReportConfig for UEI beam report or event.
Text proposal 1—(with changes and edits shown with double curly brackets to show deletions, i.e., {{ . . . }}, and double carets to show additions/insertions, i.e., \hat{ }\hat{ } . . . \hat{ }\hat{ })(LTM=Layer 1/Layer 2 (L1/L2) Triggered Mobility):

nrofHARQ-Processes
The number of HARQ processes configured. It applies for both Type 1 and Type 2. See TS 38.321, clause
5.4.1. If the UE is configured with nrofHARQ-Processes-v1700, the UE shall ignore nrofHARQ-Processes
(without suffix). The network sets the value of this field to 1 when cg-LTM-Configuration is configured.
\hat{ }\hat{ }(Alt1) UE shall ignore this field if it's configured within ConfiguredGrantConfig for UEI CSI report. (Alt2)
UE shall ignore this field when resourceForSecondChannelOfModeB-r19 is configured.\hat{ }\hat{ }

Opt2: Network (node) ignores it for utilizing the HARQ process on efficient dynamic scheduling or on other CG. Preferably in certain embodiments, the dynamic scheduling could be PUSCH scheduled by Downlink Control Information (DCI). Preferably in certain embodiments, the dynamic scheduling does not include PUSCH scheduled by Random Access Response (RAR). Alternatively, the dynamic scheduling includes PUSCH scheduled by RAR. Preferably in certain embodiments, the dynamic scheduling includes PUSCH scheduled by DCI with a CSI request field indicating a trigger state associated with CSI-ReportConfig for the UEI beam report (mode-A's CSI-ReportConfig).
Text proposal 2—(with changes and edits shown with double curly brackets to show deletions, i.e., {{ . . . }}, and double carets to show additions/insertions, i.e., \hat{ }\hat{ } . . . \hat{ }\hat{ }):

nrofHARQ-Processes
The number of HARQ processes configured. It applies for both Type 1 and Type 2. See TS 38.321, clause
5.4.1. If the UE is configured with nrofHARQ-Processes-v1700, the UE shall ignore nrofHARQ-Processes
(without suffix). The network sets the value of this field to 1 when cg-LTM-Configuration is configured.
\hat{ }\hat{ }(Alt1) Network shall ignore this field if it's configured within ConfiguredGrantConfig for UEI CSI report.
(Alt2) Network shall ignore this field when resourceForSecondChannelOfModeB-r19 is configured.\hat{ }\hat{ }

Opt3: Network set an nrofHARQ-Processes-r19 to 0. The nrofHARQ-Processes-r19 is configured within ConfiguredGrantConfig. 1f the UE is configured with nrofHARQ-Processes-r19, the UE shall ignore nrofHARQ-Processes (without suffix). Candidate value of nrofHARQ-Processes-r19 could be 0, 1, 2, . . . , 32. Based on the value of nrofHARQ-Processes-r19, the UE determines whether to determine the HARQ process ID (for one ConfiguredGrantConfig) according to a formula or considers no HARQ process ID associated with one ConfiguredGrantConfig. 1f nrofHARQ-Processes-r19 is with value 0, the UE considers no HARQ process ID associated with one ConfiguredGrantConfig. 1f nrofHARQ-Processes-r19 is a value larger than 0, the UE determines the HARQ process ID (for one ConfiguredGrantConfig) according to the formula in TS 38.321.
Text proposal 3—(with changes and edits shown with double curly brackets to show deletions, i.e., {{ . . . }}, and double carets to show additions/insertions, i.e., \hat{ }\hat{ } . . . \hat{ }\hat{ }):

nrofHARQ-Processes
The number of HARQ processes configured. It applies for both Type 1 and Type 2. See TS 38.321, clause
5.4.1. If the UE is configured with nrofHARQ-Processes-v1700, the UE shall ignore nrofHARQ-Processes
(without suffix). The network sets the value of this field to 1 when cg-LTM-Configuration is configured. \hat{ }\hat{ }If
the UE is configured with nrofHARQ-Processes-r19, the UE shall ignore nrofHARQ-Processes (without
suffix).\hat{ }\hat{ }

Text proposal 4—(with changes and edits shown with double curly brackets to show deletions, i.e., {{ . . . }}, and double carets to show additions/insertions, i.e., \hat{ }\hat{ } . . . \hat{ }\hat{ }):

harq-ProcID-Offset
For operation with shared spectrum channel access configured with cg-RetransmissionTimer-r16, this
configures the range of HARQ process IDs which can be used for this configured grant where the UE can
select a HARQ process ID within [harq-procID-offset, .., (harq-procID-offset + nrofHARQ-Processes − 1)]\hat{ }\hat{ },
if value of nrofHARQ-Processes is larger than 0.\hat{ }\hat{ } harq-ProcID-Offset-v1730 is only applicable for
operation with shared spectrum channel access in FR2-2. If the field harq-ProcID-Offset-v1730 is present,
the UE shall ignore the harq-ProcID-Offset-r16. The network does not configure this field for CG-SDT.

harq-ProcID-Offset2
Indicates the offset used in deriving the HARQ process IDs, see TS 38.321, clause 5.4.1. This field is not
configured together with cg-RetransmissionTimer-r16. If the field harq-ProcID-Offset2-v1700 is present, the
UE shall ignore the harq-ProcID-Offset2-r16. \hat{ }\hat{ }The network shall configure this field with same value for
resourceForSecondChannelOfModeB-r19 associated with same UL BWP.
This field should be set to a specific value (e.g., 0, 1, 16) if it is associated with
resourceForSecondChannelOfModeB-r19.\hat{ }\hat{ }

Text proposal 5—(with changes and edits shown with double curly brackets to show deletions, i.e., {{ . . . }}, and double carets to show additions/insertions, i.e., \hat{ }\hat{ } . . . \hat{ }\hat{ }):

```
For configured uplink grants that are not part of a multi-PUSCH configured grant and neither configured with
harq-ProcID-Offset2 nor with cg-RetransmissionTimer,
\hat{ }\hat{ }If nrofHARQ-Processes is larger than 0:\hat{ }\hat{ }
  the HARQ Process ID associated with the first symbol of a UL transmission is derived from the
  following equation:
    HARQ Process ID = [floor(CURRENT_symbol/periodicity)] modulo nrofHARQ-Processes
\hat{ }\hat{ }else:
  the UE considers no HARQ Process ID associated with the the configured uplink grants.\hat{ }\hat{ }
```

Opt4: Network sets its value to 1 for minimizing the effect of occupying multiple HARQ processes unnecessarily. There is one dedicated HARQ process (ID) for one or more (or at least one) ConfiguredGrantConfig for the UEI beam report. The UE expects the one or more (or at least one) ConfiguredGrantConfig for the UEI beam report are configured with the same harq-ProcID-Offset. The UE does not expect to be configured with a different harq-ProcID-Offset for the one or more (or at least one) ConfiguredGrantConfig for the UEI beam report. Preferably in certain embodiments, the one or more (or at least one) ConfiguredGrantConfig for the UEI beam report is configured on one UL Bandwidth Part (BWP) of a serving cell. Preferably in certain embodiments, per BWP, per serving cell, or per the UE's same value for harq-ProcID-Offset for the one or more (or at least one) ConfiguredGrantConfig for the UEI beam report is proposed. Preferably in certain embodiments, the network node (is limited to) configures the number of HARQ processes as one for ConfiguredGrantConfig for the UEI beam report. Preferably in certain embodiments, the network node (is limited to) configures the same value of the HARQ process ID offset such that the one or more (or at least one) ConfiguredGrantConfig for the UEI beam report could be configured with the same HARQ process (ID). Preferably in certain embodiments, one rationale is to consume one HARQ process (ID) rather than utilizing too many HARQ processes. Preferably in certain embodiments, no matter which one ConfiguredGrantConfig for the UEI beam report with which one (dedicated) HARQ process is used or not, another one ConfiguredGrantConfig for the UEI beam report with the one (dedicated) HARQ process could be used. Preferably in certain embodiments, one rationale is that processing the UEI beam report is based on a CSI processing unit rather than a HARQ process. Preferably in certain embodiments, harq-ProcID-Offset could refer to Information Element (IE) harq-ProcID-Offset or IE harq-ProcID-Offset2. Preferably in certain embodiments, harq-ProcID-Offset may be set to a specific value (e.g., 0, 1, 16) if it is associated with resourceForSecondChannelOfModeB-r19.
Text proposal 6—(with changes and edits shown with double curly brackets to show deletions, i.e., {{ . . . }}, and double carets to show additions/insertions, i.e., \hat{ }\hat{ } . . . \hat{ }\hat{ }):

nrofHARQ-Processes
The number of HARQ processes configured. It applies for both Type 1 and Type 2. See TS 38.321, clause
5.4.1. If the UE is configured with nrofHARQ-Processes-v1700, the UE shall ignore nrofHARQ-Processes
(without suffix). The network sets the value of this field to 1 when cg-LTM-Configuration is configured.
\hat{ }\hat{ }(Alt1) The network shall set the value of this field to 1 if it's configured within ConfiguredGrantConfig for
UEI CSI report. (Alt2) The network shall set the value of this field to 1 when
resourceForSecondChannelOfModeB-r19 is configured.\hat{ }\hat{ }

Text proposal 7—(with changes and edits shown with double curly brackets to show deletions, i.e., {{ . . . }}, and double carets to show additions/insertions, i.e., \hat{ }\hat{ } . . . \hat{ }\hat{ }):

harq-ProcID-Offset
For operation with shared spectrum channel access configured with cg-RetransmissionTimer-r16, this
configures the range of HARQ process IDs which can be used for this configured grant where the UE can
select a HARQ process ID within [harq-procID-offset, .., (harq-procID-offset + nrofHARQ-Processes − 1)].
harq-ProcID-Offset-v1730 is only applicable for operation with shared spectrum channel access in FR2-2. If
the field harq-ProcID-Offset-v1730 is present, the UE shall ignore the harq-ProcID-Offset-r16. The network
does not configure this field for CG-SDT. \hat{ }\hat{ }The network shall or is allowed to configure this field with same
value for resourceForSecondChannelOfModeB-r19 associated with same UL BWP .
This field should be set to a specific value (e.g., 0, 1, 16) if it is associated with
resourceForSecondChannelOfModeB-r19.\hat{ }\hat{ }

harq-ProcID-Offset2
Indicates the offset used in deriving the HARQ process IDs, see TS 38.321, clause 5.4.1. This field is not configured
together with cg-RetransmissionTimer-r16. If the field harq-ProcID-Offset2-v1700 is present, the UE shall ignore the
harq-ProcID-Offset2-r16. \hat{ }\hat{ }The network shall or is allowed to configure this field with same value for
resourceForSecondChannelOfModeB-r19 associated with same UL BWP .
This field should be set to a specific value (e.g., 0, 1, 16) if ti is associated with
resourceForSecondChannelOfModeB-r19.\hat{ }\hat{ }

Opt5: Type-1 CG PUSCH resource for UL-SCH excludes Type-1 CG PUSCH for the UEI beam report.

Preferably in certain embodiments, preventing a MAC layer from detecting Type-1 CG PUSCH for the UEI beam report is proposed.

Preferably in certain embodiments, the UE does not determine or consider Type-1 CG PUSCH for the UEI beam report as an uplink grant (or as a configured uplink grant).

Preferably in certain embodiments, UE does not determine or consider Type-1 CG PUSCH for the UEI beam report as an available (/valid) uplink grant (or as an available (/valid) configured uplink grant). Preferably in certain embodiments, if a type-1 CG is configured for the UEI beam report, the UE determines or considers it as unavailable or not a valid uplink grant (in MAC layer). Preferably in certain embodiments, if a type-1 CG is configured for the UEI beam report, the UE does not include UL-SCH on the type-1 CG. Preferably in certain embodiments, the UE does not include UL-SCH on a resource according to an unavailable or not valid uplink grant. Preferably in certain embodiments, the UE could include the UEI beam report (which is L1 signal or UCI) on an unavailable or not valid uplink grant.
Text proposal 8—(with changes and edits shown with double curly brackets to show deletions, i.e., {{ . . . }}, and double carets to show additions/insertions, i.e., \hat{ }\hat{ } . . . \hat{ }\hat{ })(SFN=System Frame Number):

```
If cg-SDT-PeriodicityExt (as defined in TS 38.331) is not configured, after an uplink grant is configured
for a configured grant Type 1 \hat{ }\hat{ }except configured for UEI beam report\hat{ }\hat{ }, the MAC entity shall
consider sequentially that the configured uplink grant, or the first configured uplink grant in a multi-
PUSCH configured grant, in the N^{th} (N ≥ 0) periodicity occurs in the symbol for which:
        [(SFN × numberOfSlotsPerFrame × numberOfSymbolsPerSlot)
  + (slot number in the frame × numberOfSymbolsPerSlot) + symbol number in the slot] =
    (timeReferenceSFN × numberOfSlotsPerFrame × numberOfSymbolsPerSlot
      + timeDomainOffset × numberOfSymbolsPerSlot + S + N × periodicity)
      modulo (1024 × numberOfSlotsPerFrame × numberOfSymbolsPerSlot)
```

Text proposal 9—(with changes and edits shown with double curly brackets to show deletions, i.e., {{ . . . }}, and double carets to show additions/insertions, i.e., \hat{ }\hat{ } . . . \hat{ }\hat{ }):

For each Serving Cell and each configured uplink grant\hat{ }\hat{ }, except configured for UEI beam report\hat{ }\hat{ }, if
configured and activated and available for use as specified in clause 5.8.2, the MAC entity shall:

| | |
|---|---|
| 1> | if the MAC entity is configured with lch-basedPrioritization, and the PUSCH duration of the |
| | configured uplink grant does not overlap with the PUSCH duration of an uplink grant received in |
| | a Random Access Response or with the PUSCH duration of an uplink grant addressed to |
| | Temporary C-RNTI or the PUSCH duration of a MSGA payload for this Serving Cell; or |
| 1> | if the MAC entity is not configured with lch-basedPrioritization, and the PUSCH duration of the |
| | configured uplink grant does not overlap with the PUSCH duration of an uplink grant received |
| | on the PDCCH or in a Random Access Response or the PUSCH duration of a MSGA payload |
| | for this Serving Cell: |
| | 2> set the HARQ Process ID to the HARQ Process ID associated with this PUSCH duration; |

...
For configured uplink grants\hat{ }\hat{ }, except configured for UEI beam report,\hat{ }\hat{ } that are not part of a multi-
PUSCH configured grant and neither configured with harq-ProcID-Offset2 nor with cg-
RetransmissionTimer, the HARQ Process ID associated with the first symbol of a UL transmission is
derived from the following equation:

HARQ Process ID = [floor(CURRENT_symbol/periodicity)] modulo nrofHARQ-Processes

Opt6: Not reusing ConfiguredGrantConfig (or type-1 CG) as the step-2 resource for mode-B. For type-1 configured grant configuration (e.g., ConfiguredGrantConfig), it could be separated into two different types or kinds. Preferably in certain embodiments, a first kind or type corresponds to UEI related (or NOT allowed to include UL-SCH or MAC PDU). Preferably in certain embodiments, a second kind or type corresponds to non-UEI related (or could include UL-SCH or MAC PDU). Preferably in certain embodiments, the first kind or type corresponds to ConfiguredGrantConfigUEI. Preferably in certain embodiments, the second kind or type corresponds to ConfiguredGrantConfig. Preferably in certain embodiments, the first kind or type does not include a first parameter (e.g., nrofHARQ-Processes). Preferably in certain embodiments, the second kind or type shall include a parameter related to nrofHARQ-Processes. Preferably in certain embodiments, the first kind or type and the second kind or type could be configured under one list of ConfiguredGrantConfig. Alternatively and/or preferably in certain embodiments, the first kind or type and the second kind or type could be configured under a separate list of ConfiguredGrantConfig, respectively.
Text proposal 10—(with changes and edits shown with double curly brackets to show deletions, i.e., {{ . . . }}, and double carets to show additions/insertions, i.e., \hat{ }\hat{ } . . . \hat{ }\hat{ }):

| | |
|---|---|
| CSI-ReportUE-IBM-r19 ::= | SEQUENCE { |
| eventType-r19 | ENUMERATED {event1, event2, event7}, |
| valueOfQ-r19 | INTEGER (1..8) |

OPTIONAL, -- Need R

| | |
|---|---|
| resourceForSecondChannelOfModeB-r19 | SEQUENCE { |

configuredGrantConfigIndex-r19 \hat{ }\hat{ }ConfiguredGrantConfigUEIIndex\hat{ }\hat{ }
OPTIONAL, -- Need R

| | |
|---|---|
| ul-BWP-Id-r19 | BWP-Id, |
| servCellIndex-r19 | ServCellIndex |

}
OPTIONAL, -- Need R

| | |
|---|---|
| firstPUCCHResourceConfig-r19 | SEQUENCE { |
| periodicityAndOffset | CHOICE { |
| sym2 | NULL, |
| sym6or7 | NULL, |

...

| | |
|---|---|
| sl640 | INTEGER (0..639) |

},

| | |
|---|---|
| resource | PUCCH-ResourceId |

```
    }
OPTIONAL -- Need R
  }
...
(Alt1:)
BWP-UplinkDedicated ::= SEQUENCE {
...
```

| | |
|---|---|
| configuredGrantConfigToAddModList-r16 | ConfiguredGrantConfigToAddModList-r16 |

OPTIONAL, -- Need N

| | |
|---|---|
| configuredGrantConfigToReleaseList-r16 | ConfiguredGrantConfigToReleaseList-r16 |

OPTIONAL, -- Need N
configuredGrantConfigType2DeactivationStateList-r16
ConfiguredGrantConfigType2DeactivationStateList-r16 OPTIONAL -- Need R

| | |
|---|---|
| \hat{ }\hat{ }configuredGrantConfigUEIToAddModList | ConfiguredGrantConfigUEIToAddModList |

OPTIONAL, -- Need N

| | |
|---|---|
| configuredGrantConfigUEIToReleaseList | ConfiguredGrantConfigUEIToReleaseList |

OPTIONAL, -- Need N\hat{ }\hat{ }
...
ConfiguredGrantConfigToAddModList-r16 ::= SEQUENCE (SIZE (1..maxNrofConfiguredGrantConfig-

r16)) OF ConfiguredGrantConfig

```
  ConfiguredGrantConfigToReleaseList-r16 ::= SEQUENCE (SIZE (1..maxNrofConfiguredGrantConfig-
r16)) OF ConfiguredGrantConfigIndex-r16
  ...
  \hat{ }\hat{ }ConfiguredGrantConfigUEIToAddModList ::= SEQUENCE (SIZE
(1..maxNrofConfiguredGrantConfigUEI)) OF ConfiguredGrantConfigUEI
  ConfiguredGrantConfigUEIToReleaseList ::= SEQUENCE (SIZE (1..maxNrofConfiguredGrantConfigUEI))
OF ConfiguredGrantConfigUEIIndex
ConfiguredGrantConfigUEI could reuse RRC structure of ConfiguredGrantConfig with skipping one or more
mandatory parameters. ConfiguredGrantConfigUEI could at least reuse RRC structure of rrc-
ConfiguredUplinkGrant. Maximum number of ConfiguredGrantConfigUEIIndex could be up to UE capability.\hat{ }\hat{ }
(Alt2:)
BWP-UplinkDedicated ::= SEQUENCE {
...
  configuredGrantConfigToAddModList-r16 ConfiguredGrantConfigToAddModList-r16
OPTIONAL, -- Need N
  configuredGrantConfigToReleaseList-r16 ConfiguredGrantConfigToReleaseList-r16
OPTIONAL, -- Need N
  configuredGrantConfigType2DeactivationStateList-r16
ConfiguredGrantConfigType2DeactivationStateList-r16 OPTIONAL -- Need R
...
  ConfiguredGrantConfigToAddModList-r16 ::= SEQUENCE (SIZE (1..maxNrofConfiguredGrantConfig-
\hat{ }\hat{ }r19\hat{ }\hat{ })) OF \hat{ }\hat{ }Choice: {\hat{ }\hat{ }ConfiguredGrantConfig\hat{ }\hat{ }, ConfiguredGrantConfigUEI}\hat{ }\hat{ }
  ConfiguredGrantConfigToReleaseList-r16 ::= SEQUENCE (SIZE (1..maxNrofConfiguredGrantConfig-
\hat{ }\hat{ }r19\hat{ }\hat{ })) OF ConfiguredGrantConfigIndex\hat{ }\hat{ }-r19\hat{ }\hat{ }
  ...
\hat{ }\hat{ }ConfiguredGrantConfigUEI could reuse RRC structure of ConfiguredGrantConfig with skipping one or more
mandatory parameters. ConfiguredGrantConfigUEI could at least reuse RRC structure of rrc-
ConfiguredUplinkGrant. One or more parameters in ConfiguredGrantConfig could be not included or not
configured in ConfiguredGrantConfigUEI. A mandatory parameter in ConfiguredGrantConfig could be not
included or not configureed in ConfiguredGrantConfigUEI. HARQ process related parameter could be absent
or not configured in ConfiguredGrantConfigUEI. Maximum number of ConfiguredGrantConfigIndex-r19 could
be up to UE capability.\hat{ }\hat{ }
```

Text proposal 11—(with changes and edits shown with double curly brackets to show deletions, i.e., {{ . . . }}, and double carets to show additions/insertions, i.e., \hat{ }\hat{ } . . . \hat{ }\hat{ }):

harq-ProcID-Offset
For operation with shared spectrum channel access configured with cg-RetransmissionTimer-r16, this
configures the range of HARQ process IDs which can be used for this configured grant where the UE can
select a HARQ process ID within [harq-procID-offset, .., (harq-procID-offset + nrofHARQ-Processes − 1)].
harq-ProcID-Offset-v1730 is only applicable for operation with shared spectrum channel access in FR2-2. If
the field harq-ProcID-Offset-v1730 is present, the UE shall ignore the harq-ProcID-Offset-r16. The network
does not configure this field for CG-SDT. \hat{ }\hat{ }The network does not configure this field for
resourceForSecondChannelOfModeB-r19.\hat{ }\hat{ }

Text proposal 12—(with changes and edits shown with double curly brackets to show deletions, i.e., {{ . . . }}, and double carets to show additions/insertions, i.e., \hat{ }\hat{ } . . . \hat{ }\hat{ }):

### 5.4.1 UL Grant Reception

Uplink grant is either received dynamically on the PDCCH, in a Random Access Response, configured semi-persistently by RRC or determined to be associated with the PUSCH resource of MSGA as specified in clause 5.1.2a. The MAC entity shall have an uplink grant to transmit on the UL-SCH. To perform the requested transmissions, the MAC layer receives HARQ information from lower layers. An uplink grant addressed to CS-RNTI with NDI=0 is considered as a configured uplink grant. An uplink grant addressed to CS-RNTI with NDI=1 is considered as a dynamic uplink grant.
\hat{ }\hat{ } For each Serving Cell and each configured uplink grant used for UEI beam report or associated with (any) resourceForSecondChannelOfModeB, if configured and activated and available for use as specified in clause 5.8.2, the MAC entity shall: (Option 1)
1> instruct the physical layer to generate a transmission for UEI beam report if trigger of UEI beam report is pending or upon transmission of PUCCH for UEI beam report; \hat{ }\hat{ }

For each Serving Cell and each configured uplink grant \hat{ }\hat{ } other than configured uplink grant used for UEI beam report,\hat{ }\hat{ } if configured and activated and available for use as specified in clause 5.8.2, the MAC entity shall: \hat{ }\hat{ } (Option 2) \hat{ }\hat{ }

For each Serving Cell and each configured uplink grant \hat{ }\hat{ } not associated with (any) resourceForSecondChannelOfModeB,\hat{ }\hat{ } if configured and activated and available for use as specified in clause 5.8.2, the MAC entity shall: \hat{ }\hat{ } (Option 3) \hat{ }\hat{ }
2> set the HARQ Process ID to the HARQ Process ID associated with this PUSCH duration \hat{ }\hat{ } if the configured uplink grant is not used for UEI beam report or not associated with (any) resourceForSecondChannelOfModeB\hat{ }\hat{ }; \hat{ }\hat{ } (Option 4) \hat{ }\hat{ }
   4> deliver the configured uplink grant and the associated HARQ information to the HARQ entity.

Note: \hat{ }\hat{ } transmission of PUCCH for UEI beam report refers to PUCCH transmission associated with mode-B (not for mode-A). \hat{ }\hat{ }

Note: \hat{ }\hat{ } transmission of PUCCH for UEI beam report refers to PUCCH transmission associated with same CSI-ReportConfig for UEI beam report (i.e., PUCCH resource ID and configured uplink grant index associated with same CSI-ReportConfig).\hat{ }\hat{ }
Text proposal 13—(with changes and edits shown with double curly brackets to show deletions, i.e., {{ . . . }}, and double carets to show additions/insertions, i.e., \hat{ }\hat{ } . . . \hat{ }\hat{ }):

### 5.4.2.1 HARQ Entity

The MAC entity includes a HARQ entity for each Serving Cell with configured uplink (including the case when it is configured with supplementary Uplink), which maintains a number of parallel HARQ processes.
\hat{ }\hat{ } For each configured uplink grant used for UEI beam report or associated with (any) resourceForSecondChannelOfModeB, the HARQ entity shall:
   1> instruct the physical layer to generate a transmission for UEI beam report if trigger of UEI beam report is pending or upon transmission of PUCCH for UEI beam report.\hat{ }\hat{ }

For each uplink grant \hat{ }\hat{ } other than configured uplink grant used for UEI beam report or not associated with (any) resourceForSecondChannelOfModeB\hat{ }\hat{ }, the HARQ entity shall:
1> identify the HARQ process associated with this grant, and for each identified HARQ process:
   5> obtain the MAC PDU to transmit from the Multiplexing and assembly entity.
   4> obtain the MAC PDU to transmit from the Multiplexing and assembly entity, if any;

Note: \hat{ }\hat{ } transmission of PUCCH for UEI beam report refers to PUCCH transmission associated with mode-B (not for mode-A).\hat{ }\hat{ }

Note: \hat{ }\hat{ } transmission of PUCCH for UEI beam report refers to PUCCH transmission assocaited with same CSI-ReportConfig for UEI beam report (i.e., PUCCH resource ID and configured uplink grant index associated with same CSI-ReportConfig).\hat{ }\hat{ }
Text proposal 14—(with changes and edits shown with double curly brackets to show deletions, i.e., {{ . . . }}, and double carets to show additions/insertions, i.e., \hat{ }\hat{ } . . . \hat{ }\hat{ }):

### 5.4.3 Multiplexing and Assembly

### 5.4.3.1 Logical Channel Prioritization

### 5.4.3.1.2 Selection of Logical Channels

### 5.4.3.1.3 Allocation of Resources

The MAC entity shall:
1> if the grant indicated to the HARQ entity is a configured uplink grant \hat{ }\hat{ } (type 1) used for UEI beam report or associated with (any) resourceForSecondChannelOfModeB\hat{ }\hat{ }:\hat{ }\hat{ }(Option 1)\hat{ }\hat{ }
   2> not generate a MAC PDU for the HARQ entity;
   2> instruct the physical layer to generate a transmission for UEI beam report \hat{ }\hat{ } if trigger of UEI beam report is pending or upon transmission of PUCCH for UEI beam report\hat{ }\hat{ }; and
1> if the MAC entity is configured with enhancedSkipUplinkTxDynamic with value true and the grant indicated to the HARQ entity was addressed to a C-RNTI, or if the MAC entity is configured with enhancedSkipUplinkTxConfigured with value true and the grant indicated to the HARQ entity is a configured uplink grant:
   2> if there is no UCI to be multiplexed on this PUSCH transmission as specified in TS 38.213; and
   2> if there is no aperiodic CSI requested for this PUSCH transmission as specified in TS 38.212; and
   2> if the MAC PDU includes zero MAC SDUs; and
   2> if the MAC PDU includes only the periodic BSR and there is no data available for any LCG, or the MAC PDU includes only the padding BSR:
      3> not generate a MAC PDU for the HARQ entity.
1> else if the MAC entity is configured with skipUplinkTxDynamic with value true and the grant indicated to the HARQ entity was addressed to a C-RNTI, or the grant indicated to the HARQ entity is a configured uplink grant:
   2> if there is no aperiodic CSI requested for this PUSCH transmission as specified in TS 38.212; and
   2> if the MAC PDU includes zero MAC SDUs; and
   2> if the MAC PDU includes only the periodic BSR and there is no data available for any LCG, or the MAC PDU includes only the padding BSR:
      3> not generate a MAC PDU for the HARQ entity.
1> else if the grant indicated to the HARQ entity is a configured uplink grant \hat{ }\hat{ } (type 1) used for UEI beam report or associated with (any) resourceForSecondChannelOfModeB\hat{ }\hat{ }:\hat{ }\hat{ }(Option 2)\hat{ }\hat{ }2> not generate a MAC PDU for the HARQ entity;
   2> instruct the physical layer to generate a transmission for UEI beam report \hat{ }\hat{ } if trigger of UEI beam report is pending or upon transmission of PUCCH for UEI beam report\hat{ }\hat{ };

Note: \hat{ }\hat{ } transmission of PUCCH for UEI beam report refers to PUCCH transmission assocaited with mode-B (not for mode-A).\hat{ }\hat{ }

Note: \hat{ }\hat{ } transmission of PUCCH for UEI beam report refers to PUCCH transmission assocaited with same CSI-ReportConfig for UEI beam report (i.e., PUCCH resource ID and configured uplink grant index associated with same CSI-ReportConfig).\hat{ }\hat{ }

### Methods:

A network node configures a UE with a first ConfiguredGrantConfig. The network node or the UE ignores one parameter configured on the first ConfiguredGrantConfig when the first ConfiguredGrantConfig is configured for the UEI beam report (e.g., under or associated with or via resourceForSecondChannelOfModeB-r19). Preferably in certain embodiments, if a second ConfiguredGrantConfig is not configured for the UEI beam report, the one parameter in the second ConfiguredGrantConfig should be applied by the UE (and the network node). Preferably in certain embodiments, the one parameter corresponds to nrofHARQ-Processes. Preferably in certain embodiments, the first ConfiguredGrantConfig does not provide a configuration associated with a second parameter associated with a HARQ process. Preferably in certain embodiments, the second ConfiguredGrantConfig does not provide configuration associated with a second parameter associated with the HARQ process. Preferably in certain embodiments, the second parameter corresponds to nrofHARQ-Processes-v1700.

Preferably in certain embodiments, no matter the value of the one parameter in the first ConfiguredGrantConfig or no matter if a set of HARQ process IDs is associated with the first ConfiguredGrantConfig, the network node could configure or schedule PUSCH (other than ConfiguredGrantConfig for the UEI beam report) with the HARQ process ID overlapping the set of HARQ process IDs. The network ignores the HARQ process restriction of a ConfiguredGrantConfig if the ConfiguredGrantConfig is for the UEI beam report.

Preferably in certain embodiments, the configuration of type-1 CG (e.g., included in ConfiguredGrantConfig) allocated for the mode-B UEI beam report is configured in Radio Resource Control (RRC) and a MAC entity shall consider sequentially that the configured uplink grant in the Nth (N≥0) periodicity occurs in the symbol for which:

[(SFN×numberOfSlotsPerFrame×numberOfSymbolsPerSlot)+(slot number in the frame×numberOfSymbolsPerSlot)+symbol number in the slot]=(timeReferenceSFN×numberOfSlotsPerFrame×numberOfSymbolsPerSlot+timeDomainOffset×numberOfSymbolsPerSlot+S+N×periodicity)modulo(1024×numberOfSlotsPerFrame×numberOfSymbolsPerSlot)

Preferably in certain embodiments, the MAC entity may store the uplink grant provided by upper layers as a configured uplink grant and may initialize or re-initialize the configured uplink grant to start in the symbol according to timeDomainOffset, timeReferenceSFN, and S (derived from Start and Length Indicator Value (SLIV) or provided by startSymbol as specified in 3GPP TS 38.214), and to reoccur with periodicity.

Preferably in certain embodiments, in a UL Grant reception procedure of the MAC entity, the MAC entity may not set the HARQ Process ID to the HARQ Process ID associated with the PUSCH duration of the configured uplink grant if the configured uplink grant is used for the UEI beam report.

Preferably in certain embodiments, in the UL Grant reception procedure of the MAC entity, the MAC entity may still deliver the configured uplink grant and the associated HARQ information to the HARQ entity. However, the HARQ entity may not obtain the MAC PDU to transmit from the Multiplexing and assembly entity if the configured uplink grant is used for the UEI beam report.

Preferably in certain embodiments, given that the UL skipping operation is configured (i.e., if the MAC entity is configured with enhancedSkipUplinkTxConfigured with a value true or if the grant indicated to the HARQ entity is a configured uplink grant) and there is available data (e.g., more than one MAC SDU or MAC CE) for transmission, the MAC entity or UE would not generate a MAC PDU if the configured uplink grant is used for the UEI beam report and may or is allowed to generate a MAC PDU if the configured uplink grant is not used for the UEI beam report.

Preferably in certain embodiments, in Multiplexing and assembly entity or in the procedure of allocation of resources, the MAC entity shall generate a MAC PDU for the HARQ entity upon or in response to performing the action of obtaining the MAC PDU to transmit from the Multiplexing and assembly entity.

Preferably in certain embodiments, the MAC entity or HARQ entity instruct the physical layer to generate a transmission for the UEI beam report without generation of a MAC PDU.

Preferably in certain embodiments, the first ConfiguredGrantConfig could further provide a third parameter. Preferably in certain embodiments, the value of the third parameter includes any integer of 0, 1, . . . , 32. Preferably in certain embodiments, if the third parameter is configured, the first parameter is ignored. Preferably in certain embodiments, based on the value of the third parameter, the UE determines whether to consider one ConfiguredGrantConfig is associated with the HARQ process (ID).

Preferably in certain embodiments, the network node shall set or configure the first parameter in the first ConfiguredGrantConfig to a specific value (if/when the first ConfiguredGrantConfig is for the UEI beam report (e.g., under or associated with or via resourceForSecondChannelOfModeB-r19)). Preferably in certain embodiments, the specific value is 1. Preferably in certain embodiments, the network node is not allowed to set or configure the first parameter in the first ConfiguredGrantConfig rather than the specific value (if/when the first ConfiguredGrantConfig is for the UEI beam report (e.g., under or associated with or via resourceForSecondChannelOfModeB-r19)).

Preferably in certain embodiments, the network node shall set or configure a fourth parameter with a same value in a set of ConfiguredGrantConfig. Preferably in certain embodiments, the fourth parameter corresponds to harq-ProcID-Offset. Preferably in certain embodiments, based on the set of ConfiguredGrantConfig being configured for the UEI beam report and/or being with a same characteristic, the network node shall set or configure the fourth parameter in each ConfiguredGrantConfig in the set of ConfiguredGrantConfig with the same value. Preferably in certain embodiments, the value could be a different or another/other ConfiguredGrantConfig (if the another/other ConfiguredGrantConfig is not used for the UEI beam report or if the another/other ConfiguredGrantConfig is not in the set of ConfiguredGrantConfig or if the another/other ConfiguredGrantConfig is in another set of ConfiguredGrantConfig). Preferably in certain embodiments, a same characteristic corresponds to a same UE, same serving cell, same UL BWP, and/or same event type. Preferably in certain embodiments, a same characteristic corresponds to a same PUCCH resource for PN.

Preferably in certain embodiments, if the first ConfiguredGrantConfig is configured or used for the UEI beam report, the UE does not consider or determine the first ConfiguredGrantConfig as a configured uplink grant. Preferably in certain embodiments, when determining whether a ConfiguredGrantConfig is a configured uplink grant or not, the UE excludes the first ConfiguredGrantConfig if the first ConfiguredGrantConfig is configured or used for the UEI beam report. Alternatively and/or preferably in certain embodiments, if the first ConfiguredGrantConfig is configured or used for the UEI beam report, the UE does not consider or determine the first ConfiguredGrantConfig as an available or valid configured uplink grant (from MAC layer). Preferably in certain embodiments, the UE does not determine or generate a MAC PDU or Transport Block (TB) for an unavailable or non-valid configured uplink grant. Preferably in certain embodiments, the UE could determine or generate the UEI beam report and/or UCI on PUSCH according to the first ConfiguredGrantConfig if the first ConfiguredGrantConfig is determined or considered as an unavailable or non-valid configured uplink grant.

Preferably in certain embodiments, when determining the HARQ process ID for each (periodic) transmission occasion according to one ConfiguredGrantConfig, the UE excludes ConfiguredGrantConfig used for or configured for the UEI beam report. Alternatively, when determining the HARQ process ID for each (periodic) transmission occasion according to one ConfiguredGrantConfig, no matter whether the one ConfiguredGrantConfig is configured or used for the UEI beam report, the UE determines the HARQ process ID for each (periodic) transmission occasion according to one ConfiguredGrantConfig. Preferably in certain embodiments, the UEI beam report corresponds to one kind of UCI. Preferably in certain embodiments, the UEI beam report is different than CSI, SR, HARQ. Preferably in certain embodiments, the UEI beam report corresponds to one kind of CSI report.

Which mode to be used could be per event or per CSI-ReportConfig or per UE or per serving cell.

The UEI beam report could be replaced by a UEI CSI report.

One CSI-ReportConfig could be configured with one event.

One ConfiguredGrantConfig could comprise a parameter other than the first parameter, the second parameter, and/or the third parameter.

Various examples and embodiments of the present invention are described below. For the methods, alternatives, concepts, examples, and embodiments detailed above and herein, the following aspects and embodiments are possible.

Note that any of the above and herein disclosed methods, alternatives, concepts, examples, and/or embodiments may be combined or applied simultaneously, in whole or in part.

Referring to FIG. 6, with this and other concepts, systems, and methods of the present invention, a method 1000 for a UE in a wireless communication system comprises receiving one or more CSI report configurations (e.g., CSI-ReportConfig), wherein at least one CSI report configuration is used for a UEI beam report (step 1002), receiving one or more ConfiguredGrantConfig comprising a first ConfiguredGrantConfig (step 1004), and ignoring a first parameter in the first ConfiguredGrantConfig if the first ConfiguredGrantConfig is associated with or configured as a UL resource for transmitting the UEI beam report (step 1006).

Preferably in certain embodiments, the at least one CSI report configuration provides one index associated with the first ConfiguredGrantConfig, and/or the one index configured in the at least one CSI report configuration is used to configure the UL resource for transmitting the UEI beam report, and/or the first ConfiguredGrantConfig is configured with an event (and related configuration/setting).

Preferably in certain embodiments, the UE applies the first parameter in a second ConfiguredGrantConfig if the second ConfiguredGrantConfig is not associated with or not configured as the UL resource for transmitting the UEI beam report.

Preferably in certain embodiments, the first parameter corresponds to nrofHARQ-Processes.

Preferably in certain embodiments, the first ConfiguredGrantConfig does not include or comprise a parameter related to a number of HARQ processes other than the first parameter.

Preferably in certain embodiments, a HARQ process ID associated with the first parameter is not consumed for the first ConfiguredGrantConfig.

Preferably in certain embodiments, the UE receives a DCI indicating PUSCH with a HARQ process ID associated with the first parameter (during a time interval associated with a periodicity of the first ConfiguredGrantConfig).

Preferably in certain embodiments, the UE receives a DCI indicating PUSCH with a HARQ process ID associated with the first parameter during a time interval where a timer is running, and/or the timer corresponds to a configured grant timer (associated with the first ConfiguredGrantConfig).

Preferably in certain embodiments, the UE receives a DCI indicating PUSCH with a HARQ process ID associated with the first parameter, wherein the DCI comprises a CSI request field associated with or indicative of a CSI Report configuration associated with the UEI beam report (mode-A).

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more CSI report configurations (e.g., CSI-ReportConfig), wherein at least one CSI report configuration is used for a UEI beam report; (ii) receive one or more ConfiguredGrantConfig comprising a first ConfiguredGrantConfig; and (iii) ignore a first parameter in the first ConfiguredGrantConfig if the first ConfiguredGrantConfig is associated with or configured as a UL resource for transmitting the UEI beam report. Moreover, the CPU 308 can execute the program code 312 to perform all of the described actions, steps, and methods described above, below, or otherwise herein.

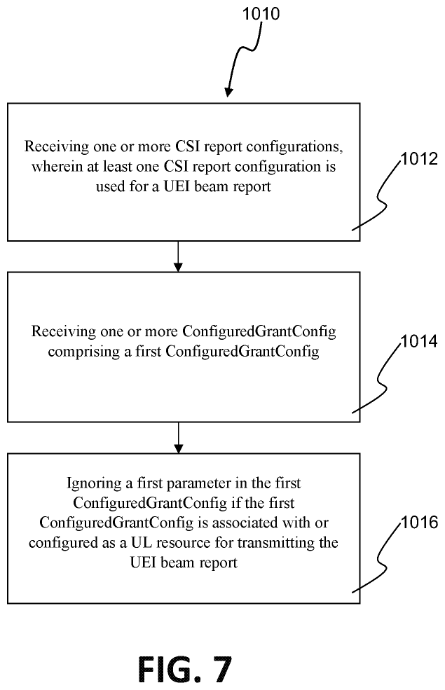

Referring to FIG. 7, with this and other concepts, systems, and methods of the present invention, a method 1010 for a network node in a wireless communication system comprises receiving one or more CSI report configurations, wherein at least one CSI report configuration is used for a UEI beam report (step 1012), receiving one or more ConfiguredGrantConfig comprising a first ConfiguredGrantConfig (step 1014), and ignoring a first parameter in the first ConfiguredGrantConfig if the first ConfiguredGrantConfig is associated with or configured as a UL resource for transmitting the UEI beam report (step 1016).

Preferably in certain embodiments, the at least one CSI report configuration provides one index associated with the first ConfiguredGrantConfig, and/or the one index configured in the at least one CSI report configuration is used to configure the UL resource for transmitting the UEI beam report, and/or the first ConfiguredGrantConfig is configured with an event (and related configuration/setting).

Preferably in certain embodiments, a HARQ process is determined based on at least the first parameter in a second ConfiguredGrantConfig if the second ConfiguredGrantConfig is not associated with or not configured as the UL resource for transmitting the UEI beam report.

Preferably in certain embodiments, the first parameter corresponds to nrofHARQ-Processes.

Preferably in certain embodiments, the first ConfiguredGrantConfig does not include or comprise a parameter related to a number of HARQ processes other than the first parameter.

Preferably in certain embodiments, a HARQ process ID associated with the first parameter is not consumed for the first ConfiguredGrantConfig.

Preferably in certain embodiments, the network node transmits a DCI indicating PUSCH with a HARQ process ID associated with the first parameter (during a time interval associated with a periodicity of the first ConfiguredGrantConfig).

Preferably in certain embodiments, the network node transmits a DCI indicating PUSCH with a HARQ process ID associated with the first parameter during time interval where a timer is running, and/or the timer corresponds to a configured grant timer (associated with the first ConfiguredGrantConfig).

Preferably in certain embodiments, the network node transmits a DCI indicating PUSCH with a HARQ process ID associated with the first parameter, wherein the DCI comprises a CSI request field associated with or indicative of a CSI Report configuration associated with the UEI beam report (mode-A).

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) receive one or more CSI report configurations, wherein at least one CSI report configuration is used for a UEI beam report; (ii) receive one or more ConfiguredGrantConfig comprising a first ConfiguredGrantConfig; and (iii) ignore a first parameter in the first ConfiguredGrantConfig if the first ConfiguredGrantConfig is associated with or configured as a UL resource for transmitting the UEI beam report. Moreover, the CPU 308 can execute the program code 312 to perform all of the described actions, steps, and methods described above, below, or otherwise herein.

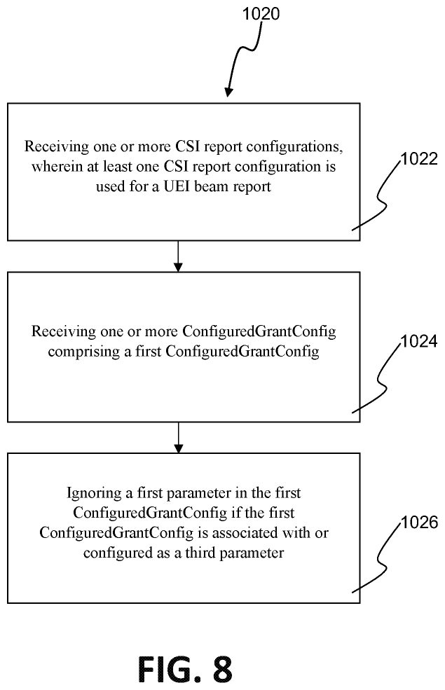

Referring to FIG. 8, with this and other concepts, systems, and methods of the present invention, a method 1020 for a UE in a wireless communication system comprises receiving one or more CSI report configurations, wherein at least one CSI report configuration is used for a UEI beam report (step 1022), receiving one or more ConfiguredGrantConfig comprising a first ConfiguredGrantConfig (step 1024), and ignoring a first parameter in the first ConfiguredGrantConfig if the first ConfiguredGrantConfig is associated with or configured as a third parameter (step 1026).

Preferably in certain embodiments, one candidate value of the third parameter is zero, and/or a candidate value of the third value is 0, 1, 2~32, and/or the third parameter indicates a value of zero.

Preferably in certain embodiments, the UE applies the third parameter to determine a HARQ process ID (if the value of the third parameter is larger than zero).

Preferably in certain embodiments, a HARQ process ID is determined based on at least the third parameter (if value of the third parameter is larger than zero).

Preferably in certain embodiments, if the third parameter indicates a value of zero, the UE considers or determines no HARQ process (ID) for the first ConfiguredGrantConfig.

Preferably in certain embodiments, if the first ConfiguredGrantConfig is configured for transmitting UEI beam reporting, the UE does not expect the third parameter is not configured in the first ConfiguredGrantConfig, and/or the UE expects that the third parameter indicates a value of zero.

Preferably in certain embodiments, a second parameter could be configured in a second ConfiguredGrantConfig, wherein candidate values of the second parameter could be 1, 2, ~32.

Preferably in certain embodiments, when the third parameter is configured, the UE determines or considers not to apply the first parameter in the first ConfiguredGrantConfig, and/or the UE does not determine a HARQ process ID.

Preferably in certain embodiments, the UE does not expect means a restriction or limitation of a network node.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more CSI report configurations, wherein at least one CSI report configuration is used for a UEI beam report; (ii) receive one or more ConfiguredGrantConfig comprising a first ConfiguredGrantConfig; and (iii) ignore a first parameter in the first ConfiguredGrantConfig if the first ConfiguredGrantConfig is associated with or configured as a third parameter. Moreover, the CPU 308 can execute the program code 312 to perform all of the described actions, steps, and methods described above, below, or otherwise herein.

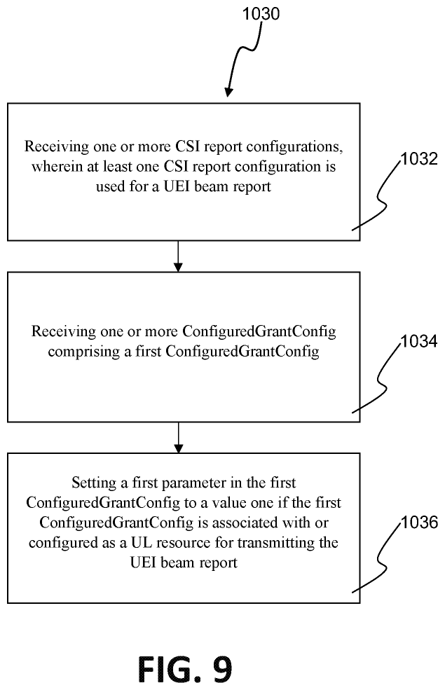

Referring to FIG. 9, with this and other concepts, systems, and methods of the present invention, a method 1030 for a network node in a wireless communication system comprises receiving one or more CSI report configurations, wherein at least one CSI report configuration is used for a UEI beam report (step 1032), receiving one or more ConfiguredGrantConfig comprising a first ConfiguredGrantConfig (step 1034), and setting a first parameter in the first ConfiguredGrantConfig to a value one if the first ConfiguredGrantConfig is associated with or configured as a UL resource for transmitting the UEI beam report (step 1036).

Preferably in certain embodiments, the network node is not allowed to set the first parameter other than the value one if the first ConfiguredGrantConfig is associated with or configured as the UL resource for transmitting the UEI beam report.

Preferably in certain embodiments, the network node sets the first parameter in a second ConfiguredGrantConfig if the second ConfiguredGrantConfig is NOT associated with or NOT configured as the UL resource for transmitting the UEI beam report, wherein the second ConfiguredGrantConfig is not associated with or NOT configured as a UL resource for Random Access Channel (RACH)-less LTM.

Preferably in certain embodiments, the network node configures the UE with a set of ConfiguredGrantConfig from the one or more ConfiguredGrantConfig, wherein the network node sets a fourth parameter in each ConfiguredGrantConfig with a same value if the set of ConfiguredGrantConfig is configured or used for transmitting the UEI beam report and with a same characteristic (e.g., the set of ConfiguredGrantConfig corresponds to the same UE, same serving cell, and/or same UL BWP).

Preferably in certain embodiments, a HARQ process ID is determined based on at least the first parameter.

Preferably in certain embodiments, the network node could configure a first value of the fourth parameter for a first set of ConfiguredGrantConfig, and/or the network node could configure a second value of the fourth parameter for a second set of ConfiguredGrantConfig, and/or the first set of ConfiguredGrantConfig and the second set of ConfiguredGrantConfig are configured on a different serving cell, and/or the first set of ConfiguredGrantConfig and the second set of ConfiguredGrantConfig are configured on a different UL BWP, and/or the first value could be different or the same as the second value, and/or the network node shall set a same first value of the fourth parameter for the first set of ConfiguredGrantConfig, and/or the network node shall set a same second value of the fourth parameter for the second set of ConfiguredGrantConfig.

Referring back to FIGS. 3 and 4, in one or more embodiments from the perspective of a network node in a wireless communication system, the device 300 includes a program code 312 stored in memory 310 of the transmitter. The CPU 308 could execute program code 312 to: (i) receive one or more CSI report configurations, wherein at least one CSI report configuration is used for a UEI beam report; (ii) receive one or more ConfiguredGrantConfig comprising a first ConfiguredGrantConfig; and (iii) set a first parameter in the first ConfiguredGrantConfig to a value one if the first ConfiguredGrantConfig is associated with or configured as a UL resource for transmitting the UEI beam report. Moreover, the CPU 308 can execute the program code 312 to perform all of the described actions, steps, and methods described above, below, or otherwise herein.

Various examples and embodiments of the present invention are described below. For the methods, alternatives, concepts, examples, and embodiments detailed above and herein, the following aspects and embodiments are possible.

Note that any of the above and herein disclosed methods, alternatives, concepts, examples, and/or embodiments may be combined or applied simultaneously, in whole or in part.

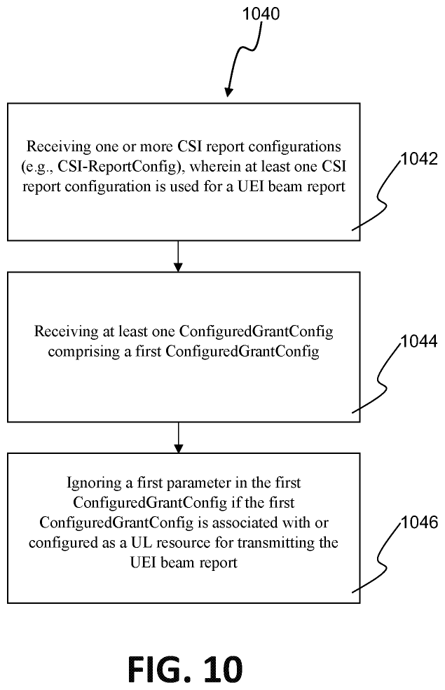

Referring to FIG. 10, with this and other concepts, systems, and methods of the present invention, a method 1040 for a UE in a wireless communication system comprises receiving one or more CSI report configurations (e.g., CSI-ReportConfig), wherein at least one CSI report configuration is used for a UEI beam report (step 1042), receiving at least one ConfiguredGrantConfig comprising a first ConfiguredGrantConfig (step 1044), and ignoring a first parameter in the first ConfiguredGrantConfig if the first ConfiguredGrantConfig is associated with or configured as a UL resource for transmitting the UEI beam report (step 1046).

In various embodiments, ignoring the first parameter in the first ConfiguredGrantConfig corresponds to a mandatory step that the UE shall ignore the first parameter in the first ConfiguredGrantConfig if the first ConfiguredGrantConfig is associated with or configured as a UL resource for transmitting the UEI beam report.

In various embodiments, the at least one CSI report configuration provides one index associated with the first ConfiguredGrantConfig, and/or one index configured in the at least one CSI report configuration is used to configure the UL resource for transmitting the UEI beam report, and/or the at least one CSI report configuration is configured with an event (and related configuration/setting), and/or the at least one CSI report configuration is configured as mode-B.

In various embodiments, the UE applies the first parameter in a second ConfiguredGrantConfig if the second ConfiguredGrantConfig is not associated with or not configured as a second UL resource for transmitting a second UEI beam report, and/or the second ConfiguredGrantConfig is associated with or configured as a second UL resource for transmission comprising MAC PDU, CG-UCI, UTO-UCI, or HARQ information.

In various embodiments, the first parameter corresponds to nrofHARQ-Processes.

In various embodiments, the first ConfiguredGrantConfig does not include or comprise a second parameter related to a number of HARQ processes other than the first parameter.

In various embodiments, the second parameter corresponds to nrofHARQ-Processes with suffix and/or the second parameter is used to configure a number of HARQ processes in addition to the first parameter.

In various embodiments, a HARQ process ID associated with the first parameter is not consumed for the first ConfiguredGrantConfig.

In various embodiments, the UE receives a DCI indicating PUSCH with a HARQ process ID associated with the first parameter (during time interval associated with periodicity of the first ConfiguredGrantConfig).

In various embodiments, the UE receives a DCI indicating PUSCH with a HARQ process ID associated with the first parameter during a time interval where a timer is running, and/or the timer corresponds to a configured grant timer (associated with the first ConfiguredGrantConfig).

In various embodiments, the UE receives a DCI indicating PUSCH with a HARQ process ID associated with the first parameter that could be a DCI with a CSI request field associated with a second CSI Report configuration associated with a second UEI beam report (mode-A), and/or the second CSI report configuration is configured as mode-A.

In various embodiments, the UE is configured with a single list of ConfiguredGrantConfig in an UL BWP or in a serving cell. The single list of ConfiguredGrantConfig comprises the at least one ConfiguredGrantConfig. The single list of ConfiguredGrantConfig comprises different type of ConfiguredGrantConfig. The single list of ConfiguredGrantConfig comprises a ConfiguredGrantConfig which is associated with or configured as an UL resource for transmitting UEI beam report and another ConfiguredGrantConfig which is used for transmission comprising Medium Access Control Protocol Data Unit (MAC PDU), Configured Grant (CG)-Uplink Control Information (UCI), Unused Transmission Occasion (UTO)-UCI, or Hybrid Automatic Repeat Request (HARQ) information. The single list of ConfiguredGrantConfig comprises the first ConfiguredGrantConfig. The single list of ConfiguredGrantConfig comprises the second ConfiguredGrantConfig.

In various embodiments, the first ConfiguredGrantConfig corresponds to a type-1 UL configured grant. The second ConfiguredGrantConfig corresponds to a type-1 UL configured grant or type-2 UL configured grant.

In various embodiments, a beam report means or corresponds a report comprising Layer-1 Reference Signal Received Power (L1-RSRP) and/or beam ID/index (or reference signal ID/index).

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more CSI report configurations (e.g., CSI-ReportConfig), wherein at least one CSI report configuration is used for a UEI beam report; (ii) receive at least one ConfiguredGrantConfig comprising a first ConfiguredGrantConfig; and (iii) ignore a first parameter in the first ConfiguredGrantConfig if the first ConfiguredGrantConfig is associated with or configured as a UL resource for transmitting the UEI beam report. Moreover, the CPU 308 can execute the program code 312 to perform all of the described actions, steps, and methods described above, below, or otherwise herein.

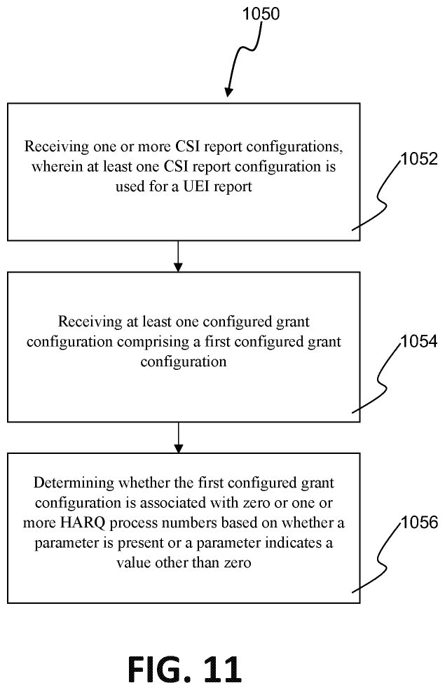

Referring to FIG. 11, with this and other concepts, systems, and methods of the present invention, a method 1050 for a UE in a wireless communication system comprises receiving one or more CSI report configurations, wherein at least one CSI report configuration is used for a UEI report (step 1052), receiving at least one configured grant configuration comprising a first configured grant configuration (step 1054), and determining whether the first configured grant configuration is associated with zero or one or more HARQ process numbers based on whether a parameter is present or a parameter indicates a value other than zero (step 1056).

In various embodiments, one candidate value of the parameter is zero, one candidate value of the parameter is 0, 1, or 2 to 32, and/or the parameter indicates a value of zero.

In various embodiments, the at least one CSI report configuration configures association to the first configured grant configuration.

In various embodiments, the UE applies the parameter to determine a HARQ process ID (if value of the parameter is larger than zero).

In various embodiments, a HARQ process ID is determined based on at least the parameter (if value of the parameter is larger than zero).

In various embodiments, a HARQ process ID is determined as a reserved or a special value if value of the parameter is zero or set to a specific value.

In various embodiments, if the parameter indicates a value of zero, the UE considers or determines no HARQ process (ID) for the first configured grant configuration.

In various embodiments, if the first configured grant configuration is configured for transmitting the UEI report, the UE does not expect the parameter is not configured in the first configured grant configuration and/or the UE expects that the parameter indicates a value of zero.

In various embodiments, if the first configured grant configuration is configured for transmitting Layer-1 (L1) or Layer-2 (L2) UCI only, the UE does not expect the parameter is configured in the first configured grant configuration or the UE expects that the parameter indicates a value of zero.

In various embodiments, the UE is configured with a single list of configured grant configuration in an UL BWP or in a serving cell. The single list of configured grant configuration comprises the at least one configured grant configuration. The single list of configured grant configuration comprises different type of configured grant configuration. The single list of configured grant configuration comprises a configured grant configuration which is associated with or configured as an UL resource for transmitting UEI report and another configured grant configuration which is used for transmission comprising Medium Access Control Protocol Data Unit (MAC PDU), Configured Grant (CG)-Uplink Control Information (UCI), Unused Transmission Occasion (UTO)-UCI, or Hybrid Automatic Repeat Request (HARQ) information. The single list of configured grant configuration comprises the first configured grant configuration. The single list of configured grant configuration comprises the second configured grant configuration.

In various embodiments, the first configured grant configuration corresponds to a type-1 UL configured grant. The second configured grant configuration corresponds to a type-1 UL configured grant or type-2 UL configured grant.

In various embodiments, the UE is configured with a first list of configured grant configuration in an UL BWP or in a serving cell and the UE is configured with a second list of configured grant configuration in the UL BWP or in the serving cell. The first list of configured grant configuration comprises a configured grant configuration which is associated with or configured as an UL resource for transmitting UEI report. The second list of configured grant configuration comprises a configured grant configuration which is used for transmission comprising Medium Access Control Protocol Data Unit (MAC PDU), Configured Grant (CG)-Uplink Control Information (UCI), Unused Transmission Occasion (UTO)-UCI, or Hybrid Automatic Repeat Request (HARQ) information. A configured grant configuration in the second list of configured grant configuration is not associated with or configured as an UL resource for transmitting UEI report. A configured grant configuration in the first list of configured grant configuration is not associated with or configured as an UL resource for transmitting Medium Access Control Protocol Data Unit (MAC PDU).

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive one or more CSI report configurations, wherein at least one CSI report configuration is used for a UEI report; (ii) receive at least one configured grant configuration comprising a first configured grant configuration; and (iii) determine whether the first configured grant configuration is associated with zero or one or more HARQ process numbers based on whether a parameter is present or a parameter indicates a value other than zero. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method of a User Equipment (UE), comprising:
receiving one or more Channel State Information (CSI) report configurations, wherein at least one CSI report configuration is used for a UE-Initiated (UEI) beam report;
receiving at least one ConfiguredGrantConfig comprising a first ConfiguredGrantConfig; and
ignoring a first parameter in the first ConfiguredGrantConfig if the first ConfiguredGrantConfig is associated with or configured as an Uplink (UL) resource for transmitting the UEI beam report.

2. The method of claim 1, wherein the at least one CSI report configuration provides one index associated with the first ConfiguredGrantConfig, and/or one index configured in the at least one CSI report configuration is used to configure the UL resource for transmitting the UEI beam report, and/or the at least one CSI report configuration is configured with an event, and/or the at least one CSI report configuration is configured as mode-B.

3. The method of claim 1, wherein the UE applies the first parameter in a second ConfiguredGrantConfig if the second ConfiguredGrantConfig is not associated with or not configured as a second UL resource for transmitting a second UEI beam report, and/or the second ConfiguredGrantConfig is associated with or configured as a second UL resource for transmission comprising Medium Access Control Protocol Data Unit (MAC PDU), Configured Grant (CG)-Uplink Control Information (UCI), Unused Transmission Occasion (UTO)-UCI, or Hybrid Automatic Repeat Request (HARQ) information.

4. The method of claim 1, wherein the first parameter corresponds to nrofHARQ-Processes.

5. The method of claim 1, wherein the first ConfiguredGrantConfig does not include or comprise a second parameter related to a number of HARQ processes other than the first parameter, and/or the second parameter corresponds to nrofHARQ-Processes with suffix and/or the second parameter is used to configure a number of HARQ processes in addition to the first parameter.

6. The method of claim 1, wherein a HARQ process Identity (ID) associated with the first parameter is not consumed for the first ConfiguredGrantConfig.

7. The method of claim 1, wherein the UE receives a Downlink Control Information (DCI) indicating Physical Uplink Shared Channel (PUSCH) with a HARQ process ID associated with the first parameter.

8. The method of claim 1, wherein the UE receives a DCI indicating PUSCH with a HARQ process ID associated with the first parameter during a time interval where a timer is running, and/or the timer corresponds to a configured grant timer.

9. The method of claim 1, wherein the UE receives a DCI indicating PUSCH with a HARQ process ID associated with the first parameter, wherein the DCI comprises a CSI request field associated with or indicative of a second CSI Report configuration associated with a second UEI beam report, and/or the second CSI report configuration is configured as mode-A.

10. A method of a User Equipment (UE), comprising:
receiving one or more Channel State Information (CSI) report configurations, wherein at least one CSI report configuration is used for a User Equipment-Initiated (UEI) report;
receiving at least one configured grant configuration comprising a first configured grant configuration; and
determining whether the first configured grant configuration is associated with zero or one or more Hybrid Automatic Repeat Request (HARQ) process numbers based on whether a parameter is present or a parameter indicates a value other than zero.

11. The method of claim 10, wherein one candidate value of the parameter is zero, one candidate value of the parameter is 0, 1, or 2 to 32, and/or the parameter indicates a value of zero.

12. The method of claim 10, wherein the at least one CSI report configuration configures association to the first configured grant configuration.

13. The method of claim 10, wherein the UE applies the parameter to determine a HARQ process Identity (ID) and/or a HARQ process ID is determined based on at least the parameter.

14. The method of claim 10, wherein if the parameter indicates a value of zero, the UE considers or determines no HARQ process for the first configured grant configuration.

15. The method of claim 10, wherein if the first configured grant configuration is configured for transmitting the UEI report, the UE does not expect the parameter is not configured in the first configured grant configuration and/or the UE expects that the parameter indicates a value of zero.

16. The method of claim 10, wherein if the first configured grant configuration is configured for transmitting Uplink Control Information (UCI) only, the UE does not expect the parameter is configured in the first configured grant configuration or the UE expects that the parameter indicates a value of zero.

17. A User Equipment (UE), comprising:
a memory; and
a processor operatively coupled with the memory, wherein the processor is configured to execute a program code to:
receive one or more Channel State Information (CSI) report configurations, wherein at least one CSI report configuration is used for a UE-Initiated (UEI) beam report;
receive at least one ConfiguredGrantConfig comprising a first ConfiguredGrantConfig; and
ignore a first parameter in the first ConfiguredGrantConfig if the first ConfiguredGrantConfig is associated with or configured as an Uplink (UL) resource for transmitting the UEI beam report.

18. The UE of claim 17, wherein the at least one CSI report configuration provides one index associated with the first ConfiguredGrantConfig, and/or one index configured in the at least one CSI report configuration is used to configure the UL resource for transmitting the UEI beam report, and/or the at least one CSI report configuration is configured with an event, and/or the at least one CSI report configuration is configured as mode-B.

19. The UE of claim 17, wherein the UE applies the first parameter in a second ConfiguredGrantConfig if the second ConfiguredGrantConfig is not associated with or not configured as a second UL resource for transmitting a second UEI beam report, and/or the second ConfiguredGrantConfig is associated with or configured as a second UL resource for transmission comprising Medium Access Control Protocol Data Unit (MAC PDU), Configured Grant (CG)-Uplink Control Information (UCI), Unused Transmission Occasion (UTO)-UCI, or Hybrid Automatic Repeat Request (HARQ) information.

20. The UE of claim 17, wherein the first parameter corresponds to nrofHARQ-Processes.
